(19) United States
(12) Patent Application Publication
(10) Pub. No.: US 2005/0266582 A1
(43) Pub. Date: Dec. 1, 2005

(54) Microfluidic system with integrated permeable membrane

(76) Inventors: Douglas N. Modlin, Palo Alto, CA (US); David Chazan, Palo Alto, CA (US)

Correspondence Address: KOLISCH HARTWELL, P.C., 520 S.W. YAMHILL STREET, SUITE 200, PORTLAND, OR, 97204, US

(21) Appl. No.: 11/107,983

(22) Filed: Apr. 14, 2005

Related U.S. Application Data
(63) Continuation-in-part of application No. PCT/US03/40107, filed on Dec. 16, 2003.
(60) Provisional application No. 60/462,957, filed on Apr. 14, 2003.
(60) Provisional application No. 60/434,286, filed on Dec. 16, 2002.
(60) Provisional application No. 60/453,766, filed on Mar. 10, 2003.
(60) Provisional application No. 60/562,594, filed on Apr. 14, 2004.

(51) Int. Cl. G01N 21/00

(52) U.S. Cl. 436/164; 422/100

(57) ABSTRACT

A microfluidic system for performing chemical reactions or biochemical, biological, or chemical assays utilizing a microfabricated device or “chip.” The system may include, among others, an integrated membrane fabricated from a chemically inert material whose permeability for gases, liquids, cells, and specific molecules, etc. can be selected for optimum results in a desired application.

### CROSS REFERENCES TO RELATED APPLICATIONS

This application is a continuation-in-part of PCT Patent Application Serial No. PCT/U.S.2003/40107, filed Dec. 16, 2003, which in turn is partially based upon and claims the benefit under 35 U.S.C. § 119(e) of the following U.S. provisional patent applications: Ser. No. 60/462,957, filed Apr. 14, 2003; Ser. No. 60/434,286, filed Dec. 16, 2002; and Ser. No. 60/453,766, filed Mar. 10, 2003. This application also is partially based upon and claims the benefit under 35 U.S.C. § 119(e) of U.S. Provisional Patent Application Ser. No. 60/562,594, filed Apr. 14, 2004. These U.S. provisional and PCT patent applications each are incorporated herein by reference in their entirety for all purposes.

### FIELD OF THE INVENTION

The present teachings relates generally to microfluidic devices and systems and methods for their use. More particularly, the present teachings relate to microfluidic devices and systems for performing chemical, biochemical, and cellular assays.

### INTRODUCTION

Reactions and/or assays are often carried out in reaction vessels such as cuvettes, flow cells, microscope slides, or micro well plates or microplates. Macro-fluidic behavior is dominant in these types of vessels. More recently, high density micro well plates, micro arrays, and microfluidic chips have been employed when it is desired to miniaturize the reaction or assay volume. These microfluidic chips and arrays generally have been constructed from materials such as glass, plastic, or other polymers in which features controlled down to the micron level and consistent with microfluidic device operation can be readily created. One common property of these materials is that they are relatively impermeable to gases such as oxygen, nitrogen, and carbon dioxide.

Microfluidic devices have been fabricated out of poly(dimethylsiloxane) “PDMS” or silicone rubber which is highly pas permeable and can facilitate gas exchange between the interior and exterior of the chip. However, it is generally known that PDMS is highly ad/absorbent to certain hydrophobic compounds and other small molecule organic compounds such as peptides, lipids, fluorescent and non-fluorescent labels or dyes and the combinatorial and other library compounds that are often used in drug discovery assays. Adsorption and absorption of the above substances can cause undesirable levels of contamination, carry-over artifacts, depletion of compounds from solutions delivered to assay sites in biochemical and cell based assays, and background fluorescence or other signals due to absorption of fluorescent and non-fluorescent biological assays reporter groups in the PDMS. Additionally, molecules absorbed into PDMS can change their fluorescence properties such as excitation and emission spectra, fluorescence lifetime, and fluorescence intensity, due to their interactions with the molecular structure of the PDMS interior. This can cause significant problems if it is desired to measure the fluorescence intensity or lifetime of a fluorophore within a microfluidic channel and use the information in the determination of the result of a biological or biochemical assay.

Various microfluidic chip assemblies are known in the prior art. For example, FIG. 1 shows a cross section of a prior art microfluidic chip assembly 10 having a laminating adhesive layer 26. Microfluidic chip assembly 10 is fabricated from substrate material 12. Substrate 12 can be a polymer or glass. Outer layer 22 is generally a polymer but can be a thin glass layer. Adhesive layer 26 bonds substrate 12 to outer layer 22. Channel 18 is fabricated by physically removing material from adhesive layer 26 prior to assembly. Fluid 14 flows into inlet 16, through the fluid channel 18 where it passes between the substrate channel floor area 20 and surface of outer layer 22 and then exits 14 through outlet 24.

A limitation of this prior art embodiment is that it is difficult or expensive to fabricate, in practice, thin channels (<about 25 microns) and narrow channels (<about 100 microns) due to the inherent limitations of physical material removal such as physical material excision and laser cutting processes as well as the difficulties associated with alignment and lamination of structures with small feature sizes. Plastic molding and stamping techniques can be employed to fabricate adhesive layer 26 but high tooling costs and long tool fabrication times can limit the utility of this method. Smaller feature sizes than what can be practically fabricated in the prior art example shown in FIG. 1 are often desirable or required in the present teachings in certain embodiments. These smaller features provide the ability to control diffusion and flow rates in fluids in the channels as well as a shorter path length for diffusion of liquids or gasses in the channels or gasses in the membrane.

Another prior art chip assembly is shown in FIG. 2. This microfluidic chip assembly 30 is fabricated from an impermeable support substrate material 42 thermally bonded to a hard top material 32. Fluid 34 flows into inlet 36, through the fluid channel 38 where it passes between the hard top material 32 channel floor 40 and the surface of hard support substrate 42 and then exits at 34 through outlet 44. Due to the extremely low gas permeability of the hard substrate gas exchange between the fluid and the exterior environment of the chip is negligible. Bubbles formed in the channel during priming with fluid or in operation can not readily escape other than in the initial priming process. Additionally, a dead-end channel can not be purged of gas and filled from one inlet port.

Another prior art assembly is shown in FIG. 3. This microfluidic chip assembly 50 is fabricated from a hard support substrate material 60 and a soft or elastomeric material 52 into which are fabricated exemplary inlet port 504, outlet ports 67, and fluid channels 56. Fluid 54 flows into inlet 504, through the fluid channel 56 where it passes between the elastomeric material channel floor 58 and the surface of hard support substrate 60 and then exits 54 through outlet 62. Due to the high gas permeability of the elastomer and the thin channel, exchange of gas 64 occurs readily between the fluid and the exterior environment of the chip. One of the characteristics of this embodiment of the prior art is that the relatively high gas permeability of substrate material 52 enables dead-end channels to be purged of gas and filled with fluid by application of pressure to a fluid-filled an inlet port connected to the dead-end channel.

FIG. 4 is a top view of another prior art microfluidic chip assembly 70 having a concentration gradient generator 80 connected to a microfluidic channel 82. As taught by an embodiment of the prior art, a microfluidic chip assembly 70 is fabricated from a hard support substrate material 72 and a soft or elastomeric material (PDMS) 74. Microfluidic chip assembly 70 is fabricated from a hard support substrate material or coverslip 72 and a soft or elastomeric material 74 into which are fabricated inlet ports 76, outlet port 84, and fluid channel 82.

Reagents 75 flow from inlets 76, through the “gradient generator” 80 and into fluid channel 82 and then exit through outlet 84. Between the time the fluids enter at gradient generator inlets 76 or cell inlet 78, the fluid passes between the elastomeric material channel wall 98 and the surface of coverslip 72 as seen in FIG. 5. However, small molecules such as those commonly used as test reagents in drug screening assays are readily and rapidly adsorbed to the surface and absorbed into the volume of the PDMS material from which the channels are fabricated. This effect is dramatically exacerbated by the high surface to volume ratio in the microfluidic channels of the gradient generator 80 and channel 82. The net effect is that test compounds are absorbed into the PDMS in an unpredictable way. This is highly undesirable for screening assays both since test compound may not be predictably delivered to its destination and there may be undesirable carry-over if the fluid is switched from one test compound to another.

Another problem with chip assembly 70, as taught by the prior art is that the large size of the gradient generator makes the device impractical to “scale-up” to provide large numbers of assays as is routinely required for drug screening assays, i.e., preferably to hundreds or even many thousands of assays per day. Moreover, the prior art does not teach a method for doing a screening assay with a test compound but only a method for inducing chemotaxis in a gradient of chemoattractant formed in a channel with neurtophils attached therein. Last, the device taught by the prior art provides only a one dimensional chemoattractant concentration gradients to be formed in the channel thus limiting the amount of information available to be obtained.

FIG. 5 is a partial cut-away perspective view 88 of the microfluidic chip assembly of FIG. 4 demonstrating neutrophil 96 chemotaxis in a microfluidic channel 82 as taught by the prior art. A gradient of chemoattractant is created in fluid channel 82 by gradient generator 80, for example, using the so-called “split and combine” method. Neutrophils 96 disposed in channel 82 and attached to coverslip 72 exhibit chemotaxis in response to the concentration gradient transverse to the direction of the flow and migrate in the direction of increasing concentration of the chemoattractant.

As described above, integrated valves have been implemented using hard structures made from silicon or silicon dioxide and soft materials like PDMS. Valves made from hard materials (i.e., elastic modulus>10¹¹ Pa) must be large to obtain the deflection needed to open and close with practical actuators and to control realistic solution volumes. Unfortunately, the use of hard materials leads to sensitivity to leakage due to trapping of particulate matter. Valves made with soft materials like PDMS (i.e., elastic modulus<10⁶ Pa) structures are easy to actuate, small in size, and are relatively insensitive to leakage due to trapping of particulate. However, these materials, particularly PDMS have a high affinity for ab/adsorption of solvents and other small molecules as described previously above and since PDMS is highly gas permeable, bubbles can form in microfluidic channels that are in close proximity to the valve. Finally PDMS has extremely high permeability to water vapor, particularly when one side of the PDMS is in contact with liquid water. This high water permeability leads to rapid evaporation from microfluidic channels which must somehow be managed in order for microfluidic devices made from DMS to be successfully used in applications which require extended residence times of water in the channels.

To facilitate low-cost and high-quality chemical, biochemical, and cellular assays including chemotaxis, there is a need for microfluidic devices or systems that are inert to materials contained therein particularly library test compounds, DMSO, tracers and other common reagents used in biochemical and biological assays, that resist bubble formation, that reduce or compensate for evaporation of water from the channels within the chip, that minimize the amount of test compounds, reagents, cells and chemoattractant required, provide for increased cell respiration and cell viability, and that evenly distribute test compound and other common reagents while providing for generation of a range of chemoattractant concentrations and gradients (to accommodate for normal biological operating range) and means to compensate for variations in flow rate from any cause that can affect the generated chemoattractant concentrations and gradients so as to insure that accurate measurements of chemotaxis can be made in screening applications where many separate measurements are made, for example, 96, 384, 1536, and 3456 or more measurements per microplate and each measurement is compared to a set of positive negative and positive controls. Therefore, there is a need for microfluidic devices or systems that provide for increased cell respiration and cell viability, that are inert to materials contained therein, that resist bubble formation during valve actuation and channel priming, and that reduce or control the relative rate of evaporation of water from the channels within the chip and that provide the capability to perform chemical, biochemical, and cellular assays in the presence of reagent concentration gradients.

### SUMMARY

The present teachings provide microfluidic systems, including components and uses thereof, for performing chemical reactions and/or biochemical, biological, or chemical assays utilizing a microfabricated device or “chip.” The systems may include, among others, an integrated membrane fabricated from a relatively chemically inert material whose permeability for gases, liquids, cells, and specific molecules, etc. can be selected for optimum results in a desired application.

### BRIEF DESCRIPTION OF THE FIGURES

FIG. 1 shows a cross section of a microfluidic chip assembly having a laminating adhesive layer.

FIG. 2 shows a chip cross section of a microfluidic chip assembly having a impermeable support substrate and top cap.

FIG. 3 shows a cross section of a microfluidic chip assembly having a hard support substrate and microfabricated elastomeric body.

FIG. 4 is a top view of a microfluidic chip assembly having a concentration gradient generator connected to a microfluidic channel.

FIG. 5 is a partial cut-away perspective view of the microfluidic chip assembly of FIG. 4 demonstrating neutrophil chemotaxis in a microfluidic channel.

FIG. 6 shows a cross section of a microfluidic chip assembly according to aspects of the present teachings.

FIG. 7 is a cross section of an exemplary microfluidic chip assembly comprising an exemplary dead-end channel.

FIG. 8 is a cross section of a microfluidic chip assembly with an exemplary gas manifold FIG. 9 is a cross section of a microfluidic chip assembly with a mechanical valve actuator in the open position.

FIG. 10 is a cross section of a microfluidic chip assembly with a mechanical valve actuator in the closed position.

FIG. 11 is a top view of microfluidic chip assembly showing the location of a valve along a channel.

FIG. 12 is a top view of a fixture comprising an array of mechanical valve actuation posts and means for mechanical alignment to a chip.

FIG. 13 is a side view of the fixture of FIG. 12.

FIG. 14 is a top view of an alternate embodiment for actuating a plurality of valves according to aspects of the present teachings.

FIG. 15 is a side view of the valve structure shown in FIG. 14, wherein the valve actuation ports are disposed in a layer opposite to the fluid access ports.

FIG. 16 is a side view of the valve structure shown in FIG. 14, wherein the valve actuation ports are disposed in the same layer as the fluid access ports.

FIG. 17 is an exemplary process flow chart for the fabrication of a chip according to aspects of the present teachings.

FIG. 18 is a cross sectional view of a starting glass substrate.

FIG. 19 shows the application of a layer of masking material to the substrate.

FIG. 20 shows the application of photoresist to the masking material.

FIG. 21 shows a process step to expose and develop the photoresist leaving areas of exposed masking material.

FIG. 22 shows a process step to etch the exposed masking material to form a patterned etch mask.

FIG. 23 shows a process step to etch the glass exposed by the patterned etch mask.

FIG. 24 shows a process step to strip the patterned etch mask.

FIG. 25 shows the application of a sand blast mask.

FIG. 26 shows a process step to fabricate holes by sand blasting areas exposed by a sand blast mask.

FIG. 27 shows a process step to remove a sand blast mask.

FIG. 28 is a cross sectional view of a starting membrane.

FIG. 29 shows a process step to apply a bonding layer to a membrane.

FIG. 30 shows a process step to bond a membrane and bonding layer to a substrate.

FIG. 31 shows an alternative process step in which bonding monolayers are applied to a substrate and a membrane.

FIG. 32 shows a process step to bond a substrate to a membrane, through applied bonding monolayers.

FIG. 33 shows a perspective view of an exemplary industry standard 96 well micro titer plate.

FIG. 34 shows a cross sectional perspective view of a microfluidic well assembly comprising an assembled chip mounted in a 96 well microplate compatible well frame.

FIG. 35 shows a partial cut away perspective view of the microfluidic well assembly of FIG. 34.

FIG. 36 shows a partial cut away top view of a microplate chip package having conical wells.

FIG. 37 shows a partial cross section of the microplate chip package of FIG. 36.

FIG. 38 is a cross section of a chip to be laminated.

FIG. 39 is a cross section of a well frame to be laminated.

FIG. 40 shows a process step to apply an adhesive to the well frame of FIG. 39.

FIG. 41 shows a process step to laminate the chip of FIG. 39 to the well frame of FIG. 40.

FIG. 42 is a perspective view of a re-usable well frame assembly for sealably mounting and operating a chip according to aspects of the present teachings.

FIG. 43 shows an architectural block diagram for a system to operate a microfluidic chip according to aspects of the present teachings.

FIG. 44 is an architectural block diagram for a system to operate a microfluidic chip according to aspects of the present teachings in a robotically automated laboratory environment.

FIG. 45 is a plan view of a microscope slide sized substrate having an array of access ports in standardized locations on the substrate.

FIG. 46 illustrates a cut-away plan view of exemplary 2 and 4 port standard unit cells having standardized access port locations as shown in FIG. 45.

FIG. 47 is a plan view of an exemplary standard unit cell placed to optimally utilize the standard array of access ports shown in FIG. 45.

FIG. 48 is an expanded view of a 3-1 combiner standard unit cell layout utilizing the standardized access port locations shown in FIG. 45.

FIG. 49 shows an exemplary array of 96 standard unit cells with each unit cell having up to 4 access ports disposed in a standard 384 well format.

FIG. 50 illustrates exemplary 4 and 8 port standard unit cells each with alternative channel network configurations, any of which being suitable for placement into a standard microplate format such the one shown in FIG. 49.

FIG. 51 illustrates a unit cell array in a standard 96 well format, the array comprising 24 repetitions of 4 port standard cells, each unit cell comprising a 3-1 combiner structure.

FIG. 52 illustrates a unit cell array in a standard 384 well format, the array comprising 96 repetitions of 4 port standard cells, each unit cell comprising a 3-1 combiner structure.

FIG. 53 illustrates a unit cell array in a standard 1536 well format, the array comprising 96 repetitions of 4 port standard cells, each unit cell comprising a 3-1 combiner structure.

FIG. 54 illustrates exemplary routing networks distributing two common reagents to each site in the exemplary array of 96 standard unit cells described in FIG. 49.

FIG. 55 is a partial view of an exemplary network of channels for routing two common reagents to exemplary standard unit cells with 3-1 combiner structures suitable for substitution into the standard unit cell array of FIG. 54.

FIG. 56 illustrates a ring routing network for distribution of a common reagent within an 8 port standard unit cell.

FIG. 57 shows a linear channel network within an 8 port standard unit cell.

FIG. 58 illustrates an 8 port standard unit cell in a microplate format with a ring channel network.

FIG. 59 shows a 4 port standard unit cell in a microplate format with a ring channel network.

FIG. 60 illustrates a 4 port unit cell in a microplate format with an H channel network.

FIG. 61 shows a star channel network for distribution of a common reagent within a multiple port standard unit cell.

FIG. 62 illustrates a linear channel network within a multiple port standard unit cell equivalent to the star channel network of FIG. 61.

FIG. 63 shows a multiple port standard unit cell in a microplate format with a star channel network.

FIG. 64 illustrates an exemplary serial channel network for distributing a common reagent to a plurality of unit cells within an 8 port standard unit cell with isolation valves in the open position.

FIG. 65 shows the standard unit cell of FIG. 64 with the isolation valves in the closed position and the common reagent distributed to and trapped within the assay region of each unit cell in the plurality of unit cells.

FIG. 66 illustrates an exemplary serial channel network for distributing a common reagent to multiple 2-1 channel unit cells within an 8 port standard unit cell with isolation valves in the open position.

FIG. 67 shows the standard unit cell of FIG. 66 with the isolation valves in the closed position and the common reagent distributed to and trapped within the assay region of each 2-1 channel unit cell.

FIG. 68 illustrates an exemplary embodiment of three H equivalent structures with an integrated parallel network for distributing a common reagent to the assay region of three unit cells within an 8 port standard unit cell.

FIG. 69 shows an exemplary 3-1 structure wherein each of the three channels carries a common reagent and merges into a single main channel.

FIG. 70 shows the 3-1 structure of FIG. 69, wherein each of three channels carries a common first reagent, in which a second reagent is added to the outer channels causing a standing concentration gradient to form in the main channel.

FIG. 71 illustrates the concentration of a first and second reagent in the structure of FIG. 69 at an upstream location in the main channel relative to the merge point.

FIG. 72 illustrates the concentration of a first and second reagent in the structure of FIG. 69 at a downstream location in the main channel relative to the merge point.

FIG. 73 shows a 3-1 combiner structure similar to that of FIG. 69 wherein each of the three channels is carrying a common reagent and cells have been loaded into an assay region in the main channel.

FIG. 74 shows the 3-1 combiner structure of FIG. 73 wherein a second reagent has been added to the outer channels causing the cells to migrate in response to the concentration gradient of the second reagent formed along the main channel.

FIG. 75 illustrates an exemplary method for loading cells into the main channel from the center channel of the structure similar to FIG. 69.

FIG. 76 shows the 3-1 combiner structure of FIG. 75 wherein a second reagent has been added to the outer channels.

FIG. 77 illustrates an exemplary method for loading cells into the main channel of an H structure from one of the side branch channels.

FIG. 78 shows the 3-1 combiner structure of FIG. 79 wherein a second reagent has been added to one of the branch channels of the structure of FIG. 79.

FIG. 79 shows a plan view of an exemplary chamber shaped to efficiently purge an assay region in a microfluidic perfusion chamber.

FIG. 80 illustrates an exemplary dead-end channel along a main channel running between two access ports which is inefficiently purged by the flow in the main channel.

FIG. 81 shows an exemplary valve covering the center region of an exemplary H structure.

FIG. 82 shows an exemplary method of loading cells into an H structure from a side branch, the H structure having a valve in a central region to trap cells.

FIG. 83 shows the structure of FIG. 84 with the valve closed and the cells trapped in the two dead-end channels created by the closed valve.

FIG. 84 shows the structure of FIG. 85 after flow has been allowed to continue and wash away the cells not trapped in the dead-end channels.

FIG. 85 shows the structure of FIG. 86 after performing an assay, wherein a second reagent is added.

FIG. 86 shows an embodiment of a two compartment device wherein cells are loaded into a first compartment through a first channel.

FIG. 87 shows the two compartment device of FIG. 88 after the introduction of a reagent that induces cell migration from the first compartment into the second compartment.

FIG. 88 provides an illustrative example of bell shaped and saturating dose-response curves.

FIG. 89 shows overlapping standing gradients of a first and a second reagent in the main channel of a 3-1 structure wherein the first and second reagents are fed from the left and right channels, respectively.

FIG. 90 shows an exemplary method wherein multiple cell types are loaded into the main channel of a 3-1 combiner structure.

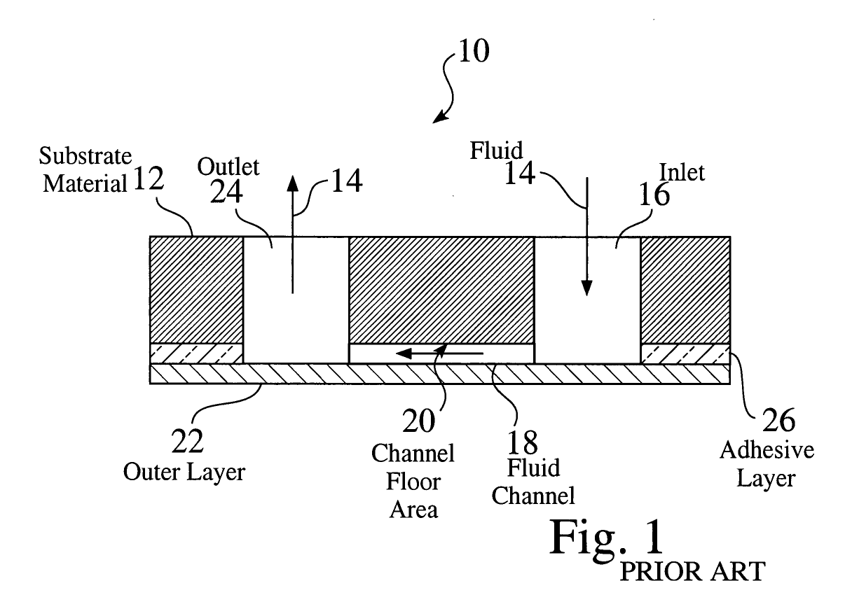

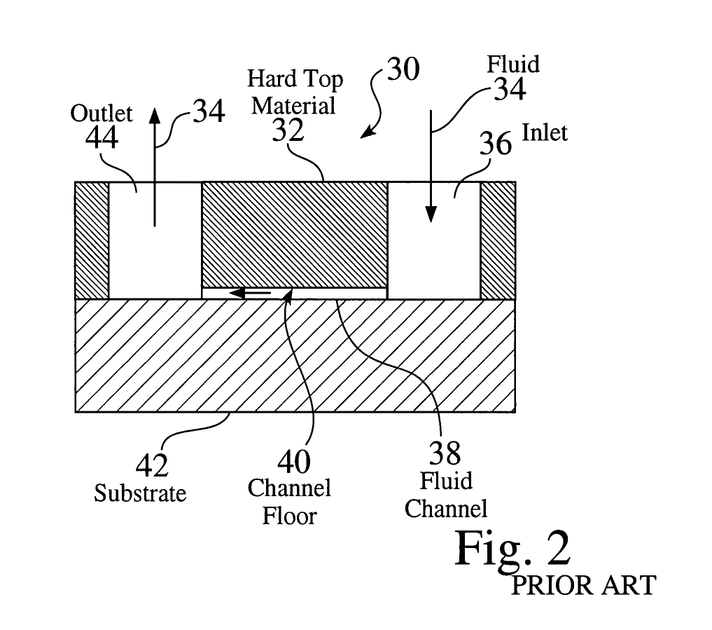

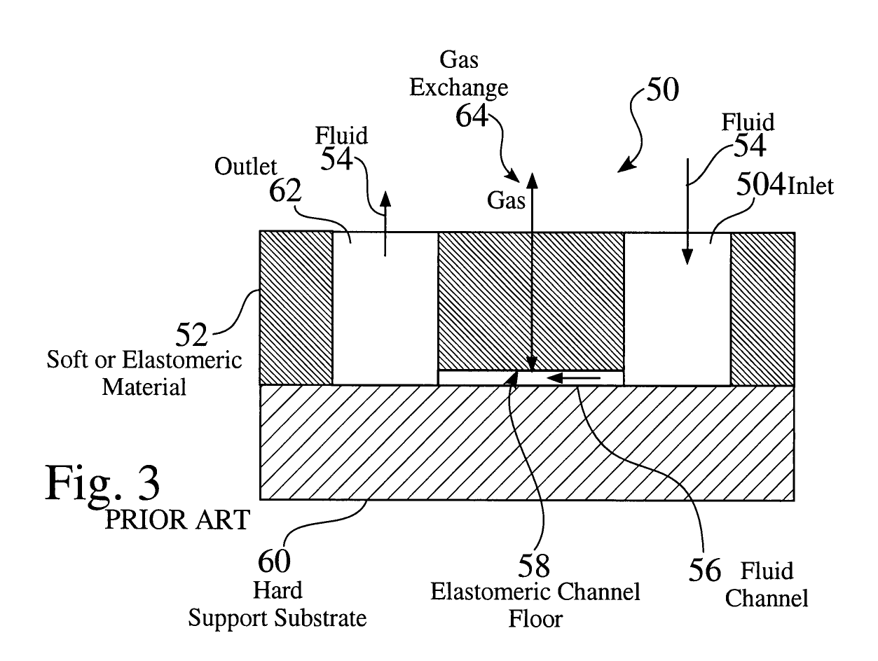

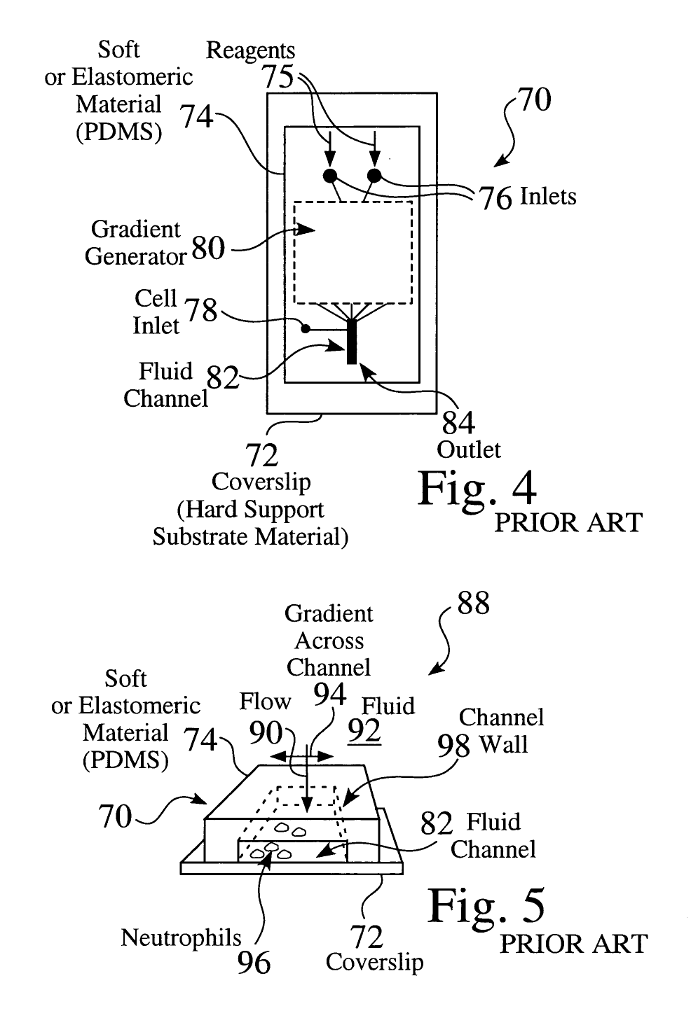

### DETAILED DESCRIPTION

The present teachings provide a microfluidic system for performing chemical reactions or chemical, biochemical, biological, or cellular assays utilizing a microfabricated device or “chip” and methods for generation of concentrations and concentration gradients of assay reagents while compensating for variations in flow rates, concentrations and concentration gradients due to intrinsic and extrinsic factors such as described in the background section above. The present teachings also include a method for pre-loading, storing, and/or freezing cells and other reagents in chips which can be stored either at the manufacturer or at the point of use until needed for uses including but not limited to assays, reference standards, archival samples, sensors, monitors, diagnostics, and instrumentation systems. The present teachings facilitate low-cost and high-quality cellular assays, is inert to materials contained therein particularly library test compounds, DMSO, tracers and other common reagents used in biological assays, resists bubble formation, reduces and compensates for evaporation of water from the channels within the chip, minimizes the amount of test compounds, reagents, cells and expensive chemoattractant or other biomolecules required, provides for increased cell respiration and cell viability, and evenly distributes test compound and other common reagents while providing for generation of a range of assay reagent concentrations and gradients. The present invention includes means to accommodate normal biological operating ranges and means to compensate for variations in flow rate from any cause that can affect the generated chemoattractant or other assay reagent concentrations and gradients so as to insure that accurate measurements of cell migration or other biochemical or cellular assay readouts can be made in screening applications where many separate measurements are made, for example, 96, 384, 1536, and 3456 or more measurements per microplate and each measurement is compared to a set of positive negative and positive controls.

In some embodiments, cells are flowed into a microfluidic channel either under externally applied pressure, by the pressure generated by pipetting a column of fluid into an input well, or by capillary action. Once the cells have entered the channel and flowed to the cell perfusion or assay region, flow is stopped either by switching off the external pressure with a valve, neutralizing the external or internal pressure with an opposing pressure, by equalizing the applied pressure to all relevant fluidic nodes of the assay device, or by encountering a barrier to capillary flow. In the simplest case a fluid column equal in height to input well is pipetted into an output well causing flow to stop or at least slow down to the point where the cells will settle on the chip surface. Depending on the orientation of the microfabricated device, cells will either settle on the membrane or the substrate side. After the cells have settled, attached and stabilized, the assay can begin. In some embodiments, one or more tracer is added to the flow stream, each in adjacent laminar flow regions. The tracer particles can be detected optically, mechanically, thermally, or electrically. Examples of tracer molecules are small molecular weight dyes, labeled peptides, labeled carbohydrates, labeled beads etc. For example, visible particles could be chosen as could fluorescent dye molecules. Since the rate of diffusion of a tracer molecule into an adjacent flow stream is governed by both its diffusion coefficient and the flow velocity, the flow velocity can be determined using an optical measurement of the tracer diffusion into an adjacent flow stream or by the ratio of the inter-diffusion of multiple tracers in adjacent flow streams. Once the flow rate is known, the concentration and concentration gradient can be calculated. In addition, the concentration and concentration gradient can be determined from a measurement of the level of tracer present across the channel. By measuring concentration and concentration gradient in each channel and designing the system to provide a range of concentrations and concentration gradients, the position in the channel with the proper concentration and concentration gradient can be retrospectively determined and the position along the channel with the desired concentration and concentration gradient can be selected for comparison to assay points in other channels.

In other embodiments, the tracer could be identified by fluorescence intensity or fluorescence lifetime. Tracers could be non fluorescent absorbing dyes, optically visible reflective, refractive, or absorptive particles, quantum dots, chemical indicator molecules which measure surrogate gradients designed to mimic the chemoattractant gradient. For example a surrogate gradient could be formed using a dissolved gas and the gradient could be sensed with a gas sensing indicator molecules, the primary requirement is that the diffusion coefficient of the tracer system is in the same range as that of the chemoattractant. Another important requirement is that interference from the material in the channel does not degrade the quality of the measurement of the concentration gradient. For example, library test compounds are sometimes fluorescent as are certain assay reporters. The tracer used to normalize the chemoattractant concentration and gradient should be selected to be resistant to the type of interference expected to be encountered. Tracers with long fluorescence lifetimes or long wavelengths can sometimes be less susceptible to the effects of compound fluorescence; however, the effects of static and dynamic quenching can be problematic for long lived fluorescent tracers. Lastly, since the dimensions of microfluidic channels are so small, there are generally not many molecules present at physiological concentrations. This would hold true for both the interferers and the tracers. The type and amount of tracer used should be optimized for each situation.

In other embodiments, the tracer could be free molecules in solution or it could be chemically attached to the chemoattractant in such a way that it does not interfere with its ability to bind to its target chemotactic receptor site. By monitoring the tracer on the chemoattractant, it should be possible to determine the concentration and gradient at any point along the channel. Additionally, by attaching larger size molecules to the chemoattractant without compromising its bioactivity, it would be possible to lower its diffusion coefficient and thereby allow desired concentration gradients to be generated at lower flow rates.

To assist in the determination of the exact spatial position of the concentration and gradients of the chemoattractant, the present teachings include a series of calibrated reference (or fiducial) marks along the channels which can be used as a reference by the imaging optical system. Use of such marks will allow the determination of the location of a desired concentration and concentration gradient despite the face that the position of the desired concentration and concentration gradient may vary from one assay site to the next.

In another embodiment, cells are flowed into the chip, the flow is stopped, the cells attach, are allowed to grow, the media may then be changed, and the cells are frozen. In an alternative embodiment, the cells are flowed into the chip, the flow is stopped and the cells are frozen prior to attachment. Freezing protocols can be optimized for the best result and generally involve freezing and thawing processes that are optimized for a given chip and cell type. In an alternate embodiment, the cells may not be frozen but held at a lower temperature that would cause the cells to enter into a state of lowered metabolic activity or stasis. Chips containing frozen cells or cells in stasis can be suitably packaged so as to be archived at the factory or transported to their final users and where they can be stored and eventually thawed and used for assays without the need to load cells into the chip. Frozen chips can be used for sample archival and ultimately for screening, life science research, personalized medicine including therapy optimization, genotyping, and gene expression, and other medical diagnostics applications.

The accompanying drawings, which are incorporated in and form a part of this specification, illustrate embodiments of the teachings and, together with the description, serve to explain pertinent principles.

I. The Device

A. Overview

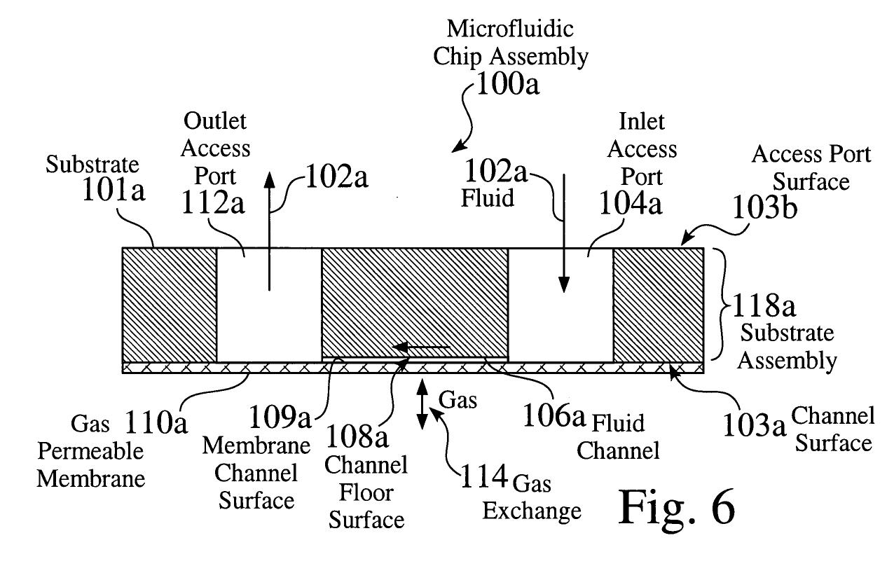

FIG. 6 is a cross sectional view of a microfluidic chip assembly 100a according to aspects of the present teachings. Substrate assembly 118a, i.e. a fabricated substrate is fabricated from substrate material 101a. Fabricated substrate 118a comprises an inlet access port 104a and an outlet access port 112a extending between a channel surface 103a and an access port surface 103b. A fluid channel 106a is located on channel surface 103a of substrate 101a, extending between inlet access port 104a and outlet access port 112a defining a channel floor surface 108a. A gas permeable membrane 110a is sealably attached to channel surface 103a of fabricated substrate 118a defining a membrane surface 108a within fluid channel 106a. Fluid 102a flows into inlet 104a, through fluid channel 106a where it passes between the channel floor 108a and membrane surface 109a and then exits through outlet 112a. Due to the relatively high gas permeability of the membrane and thin channel depth, exchange of gas 114 occurs between the fluid and the exterior environment of the chip. Bubbles formed in the channel during priming with fluid or in operation can escape through the membrane.

B. Substrate

Suitable substrate materials are generally selected based upon their compatibility with the conditions present in the particular operation to be performed by the device. Such conditions can include a range of or extremes of pH, temperature, ionic concentration, solvent tolerance and application of electric fields. Additionally, substrate materials are also selected for their inertness to critical components of an analysis to be carried out by the system. Useful substrate materials include, e.g., glass, quartz, ceramics, and silicon, as well as polymeric substances, e.g., plastics. In some embodiments, quartz or glass is used as the substrate material 101. In other embodiments silicon or another inert material of similar physical qualities can be used. For other embodiments, polymers or plastics may be used as the substrate material. Certain materials such as polymers, plastics or inorganic materials such as silicon or ceramics can be used to implement features with high aspect ratios. Polymers, plastics, and ceramics can be molded or cast and materials with crystal structure such silicon can be anisotropically etched to provide high aspect ratio features.

In the case of polymeric substrates, the substrate materials may be rigid, semi-rigid, or non-rigid, opaque, semi-opaque, or transparent, depending upon the use for which they are intended. For example, systems which include an optical or visual detection element are generally fabricated, at least in part, from optically transparent materials to allow, or at least, facilitate that detection. Alternatively, optically transparent windows of glass or quartz, e.g., may be incorporated into the device for these types of detection. Optically transparent means that the material allows light of wavelengths ranging from 180 to 1500 nm, usually from 220 to 800 nm, more usually from 250 to 800 nm, to have low transmission losses. Such light transmissive polymeric materials can be characterized by low crystallinity and include polycarbonate, polyethylene terepthalate, polystyrene, polymethylpentene, fluorocarbon copolymers, polyacrylates (including polymethacrylates, and more particularly polymethylmethacrylate (PMMA), and the like. Additionally, the polymeric materials may have linear or branched backbones, and may be crosslinked or non-crosslinked. Examples of alternative polymeric materials include, e.g., polydimethylsiloxanes (PDMS), polyurethane, polyvinylchloride (PVC), polystyrene, polysulfone, polycarbonate, polymethylmethacrylate (PMMA), polypropylene, and the like. Fluorosilicones and other fluoropolymers, and fluoropolymer coated polymer materials are also potentially desirable substrate materials due to the ability to fabricate high aspect ratio structures that resist ad/absorption of molecules from solutions in contact with the material. High aspect ratio structures are those with channel depth/width greater than about 0.3. High aspect ratio structures can be fabricated by embossing, molding, casting, or soft lithography with polymeric materials.

In some embodiments, the materials used to fabricate the microfluidic devices are selected for resistance to ad/absorption by aggressive organic solvents, certain acids and bases, biomolecules such as nucleotides, peptides, proteins, lipids, natural product screening libraries etc. as well as and small molecule combinatorial compound libraries which have a tendency to absorb into conventional materials. Resistance to ad/absorption of organic solvents and combinatorial library compounds minimizes undesirable levels of contamination, carry-over artifacts, depletion of compounds from solutions delivered to assay sites in biochemical and cell based assays, and background fluorescence due to absorption of fluorescent and non-fluorescent biological assays reporter groups in the substrate material. Resistance to organic solvents, acids, and basis enables the use of microfluidics with combinatorial, synthetic organic and other chemistries. The ability to select materials with desired surface characteristics may also be important in certain chromatography applications.

In some embodiments, the substrate comprises an optically clear material with low background fluorescence and birefringence, allowing optical interrogation of the assay region within a channel or chamber.

C. Surface Modifications

It may be desirable to modify the surface of the device to reduce or enhance the various driving forces (e.g., electroosmotic, electrokinetic, electrophoretic, and the like) through the channel and the like, to reduce or enhance analyte adsorption. It may be desirable to modify the surface of the device to reduce or enhance the ability or rate which cells attach to channels or chambers within the device. The channel floor surface 108a can be functionalized; the membrane channel surface 109a can be functionalized; or the surfaces of both can be functionalized. In the latter case, the surface of the membrane channel can be modified in the same manner or in a different manner from the functionalization of the channel floor surface.

The use of different surface modifications may serve to increase the sensitivity of the device to particular species of interest. For example, the device can be readily modified by reducing or enhancing analyte adsorption to the walls of a channel, chamber, access port, well, or reservoir to allow for the probing of many different molecular interactions. Methods of silane surface chemistry developed in the past twenty years can be applied to the substrate or the conduit, allowing hundreds of different molecules to be grafted onto the device's surface. The surface can be modified with a coating by using thin-film technology based, for example, on physical vapor deposition, thermal processing, or plasma-enhanced chemical vapor deposition. Alternatively, plasma exposure can be used to directly activate or alter the surface and create a coating. For instance, plasma etch procedures can be used to oxidize a polymeric surface (i.e., a polystyrene or polyethylene to expose polar functionalities such as hydroxyls, carboxylic acids, aldehydes, or other reactive moieties).

The coating may comprise an organic thin film. Methods for the formation of organic thin films include in situ growth from the surface, deposition by physisorption, spin-coating, chemisorption, self-assembly and plasma-initiated polymerization from gas phase. For example, a material such as dextran can serve as a suitable organic thin film. Other thin films include lipid bilayers; monolayers of polyarginine or polylysine, fibronectin, collagens of various types, surface adhesion molecules such as integrins; self-assembled monolayers; and the like. The coating may cover the whole surface of the device or only parts of it, e.g., including channels, conduits, chambers, access ports, wells, reservoirs, etc. A variety of techniques for generating patterns of coatings on the surface of a support are well known in the art and include, without limitation, microfluidics printing, microstamping, and microcontact printing.

Additional references describing methods for surface modification include U.S. Pat. No. 4,680,201; U.S. Pat. No. 5,433,898; U.S. Pat. No. 6,056,860; EP 665,430, EP 452,055; and Encyclopedia of Polymer Science and Engineering “Adhesion and Bonding”, Vol. 1, pp. 476 et seq (Wiley Interscience, 1985), each of which is incorporated herein by reference.

D. Membrane

The microfluidic chip assembly comprises a gas permeable, chemically inert membrane 110a that overlays the substrate assembly 118a to sealably enclose the various channels, chambers, and the like. The integrated permeable membrane 110a confers the ability to control the transport of liquids or gases into and out of the solutions contained within a microfluidic environment. The gas permeable membrane is selected to provide an appropriate level of gas transport to support each particular application, For example, in some embodiments, the gas permeable membrane is selected to provide sufficient gas permeability to provide adequate gas exchange for environmental control (e.g., of the medium pH) and respiration for cells living within the fluid channel of the device. In an alternate embodiment, a design criterion for selecting membrane physical properties could be the estimated time required to fill a one cm dead-end channel. For embodiments including certain chemical, biochemical, and cellular assays and assuming a channel fill time of <5 minutes, the membrane is preferably selected from the group including but not limited to relatively chemically inert materials with an oxygen permeability greater than 10 Barrer units and water permeability less than 5 times the oxygen permeability. Exemplary materials which meet these criteria include polyolefins such as poly methyl pentene and amorphous fluorinated polymers such as Teflon AF or CYTOP. Elastomeric materials such as silicones may be used in applications where the low elastic modulus of silicone is desired and its tendencies toward molecular ad and absorption can be accommodated.

The CGS unit of measurement for gas permeability in general use for membranes and other thin films is the Barrer. Permeability is defined to be the gas flow rate multiplied by the thickness of the material divided by the area and by the pressure difference across the material. The Barrer is the permeability represented by a flow rate of 10⁻¹⁰ cubic centimeters per second times 1 centimeter of thickness, per square centimeter of area and centimeter of mercury difference in pressure (volume at standard temperature and pressure, 0° C. and 1 atmosphere), 1 Barrer=10⁻¹⁰ cm²·s⁻¹·cm·Hg⁻¹, or, in SI units, 7.5005×10⁻¹⁸ m²·s⁻¹·Pa⁻¹.

Table 1 below shows relevant permeabilities for several candidate polymeric membrane materials. For the materials listed in Table 1, the gas permeability of the candidate membrane materials to nitrogen, oxygen, and carbon dioxide is within the range of about 0.1 to about 10.000 Barrer units. Membrane materials with appropriate permeabilities for specific gasses or combinations thereof can be chosen based on the needs of a particular application. The other membrane materials with appropriate gas permeabilities and other desired properties may be substituted for those in Table 1.

| | | | Carbon | | Water/ |
|---|---|---|---|---|---|
| Membrane materials | Nitrogen | Oxygen | Dioxide | Water | Oxygen |
| LDPE | 0.969 | 2.88 | 12.6 | 90 | 31 |
| (Low Density | | | | | |
| Polyethylene) | | | | | |
| HDPE | 0.143 | 0.4 | 0.36 | 12 | 30 |
| (High Density | | | | | |
| Polyethylene) | | | | | |
| Poly(methylpentene) | 7.83 | 32 | 92.6 | 60 | 1.9 |
| PP (Polypropylene) | 0.44 | 2.3 | 9.2 | 51 | 22 |
| Silicon rubber 10% | 227 | 489 | 3240 | 43000 | 8.8 |
| filler | | | | | |
| Polystyrene | 0.8 | 2.63 | 10.5 | 1200 | 461 |
| Teflon AF 2400 | 490 | 990 | 2800 | 4026 | 4 |

Membranes used in embodiments containing low dead-volume valves and relatively small physical size having the ability to control and mix reagents in a microfluidic environment are preferably comprised of chemically inert materials with elastic modulus of between 1⁶ Pa and 1⁹ Pa and may be fabricated with a thickness in the range of 10 to 100 microns or alternatively in the range of 1-50 microns. In other embodiments, candidate membranes may be fabricated with virtually any thickness that provides the desired permeability or other optical and mechanical properties for a particular application. For example, candidate membranes could be fabricated from pours organic or inorganic materials or hybrid materials comprising combinations of inorganic and organic materials. Porous organic materials include but are not limited to porous polymers such as porous PET/PE, PET/PET, PP/PET, and HDPE/PET available from Porex Corporation, 500 Bohannon Road, Fairburn, Ga., PORON® porous polyurethanes available from Rogers Corporation, One Technology Drive, PO Box 188, Rogers, Conn. 06263-0188, or other porous membrane materials including those fabricated utilizing nano-technology or self assembling chemical structures. Porous inorganic include but are not limited to materials such as porous glass, sol gel, single crystalline or polycrystalline silicon, or metals such as copper, gold, nickel, stainless steel, titanium, aluminum including those fabricated utilizing nano-technology or self assembling chemical structures. Hybrid membrane materials may comprise one or more type of organic or inorganic material and may contain one or more layers of combinations of organic and inorganic materials.

For example, the Teflon fluoropolymer series from DuPont Chemical (e.g., PTFE, FEP Teflon AF, etc.) are good choices for the integrated membranes since they are highly resistant to the chemical compounds listed above and are readily bondable to the substrate as are or other halogenated polymer materials or polymer coatings from other sources and can also can be selected if they can provide the desired level of gas permeability. Teflon can be bonded or laminated to substrates such as glass or Kapton by a combination of heat treatments and the use of adhesives or silanizing agents. Numerous Teflon applications notes available from DuPont Corporation. For example, DuPont provides recipes and specifications for laminating Teflon FEP to various substrates including glass and Kapton (polyimide) and is shown below for reference.

Teflon AF has desirable properties for use as a gas permeable membrane in embodiments of the present teachings since it exhibits low mechanical creep, displays high optical clarity, and has very gas permeability (comparable to silicone rubber). DuPont also provides guidance for processing Teflon AF which is included for reference. DuPont reports that Teflon AF can be bonded to glass substrates with a fluorinated silane (ref) Teflon® AF is easier to process than other fluoropolymers. It is mechanically stiff over a broad temperature range and has a low cold flow. Because Teflon® AF has limited solubility in perfluorocarbon solvents, it can be cast into thin-film, pinhole-free coatings, with no sintering, and only low heat needed to drive off residual solvent. It also can be applied using spin, spray, brush, or dipping techniques. Teflon® AF can be molded at relatively low temperatures by extrusion, pressing, or injection molding, in typical fluoropolymer molding equipment. In addition, it can be dissolved in selected perfluorinated solvents for the production of highly uniform thin films and coatings through spin coating and other techniques. Another property of Teflon AF is that its index of refraction is around 1.3 which is lower than that of water at 1.33. A microfluidic channel, coated on all sides with Teflon AF would function as a waveguide with an NA of about 0.28. This embodiment could be used to collect light generated within the waveguide by a fluorescent label or reporter group as part of an assay or sensor and direct it toward a photodetector located at the end of the waveguide. For example, fluorescent indicators for substances such as carbon dioxide, oxygen, pH, calcium, etc. are readily available from companies like Molecular Probes, Inc. 29851 Willow Creek Road, Eugene, Oreg. 97402.

An alternative perfluorinated fluoropolymer with similar properties to Teflon AF is CYTOP, which is available from: Bellex International Corp., Wilmington, Del. CYTOP has an optical transmittance of >95% from 200 nm; a refractive index of 1.34 (D-line); and a dielectric constant of 2.1.

Alternatively, the membrane may be formed from polydimethylsiloxane (i.e., silicone rubber) or even gas permeable contact lens material. Many formulations of silicone rubber are commercially available, some having properties optimized for compatibility with certain process chemicals, biocompatibility, and the like. Other formulations are available for injection molding and yet still other formulations are available with fluorinated structural elements conferring high resistance to specific process chemicals or biomolecules. One of the big differences between silicone rubber and materials like Teflon AF is that the water permeability of silicone is 60 times higher for water than for oxygen whereas with Teflon AF, the water permeability is only 4 to 5 times higher than for oxygen. The higher water permeability of silicone can make a significant difference in certain applications.

In certain applications the effective permeability can be reduced by either backing the membrane with a second impermeable material or by reducing the concentration gradient of the diffusion species by bringing a substance in contact with the back side of the membrane that drives diffusion in the opposite direction so as to cancel out the permeability of the membrane. For example, if it was desired to allow atmospheric gases to diffuse in and out of the chip, but evaporation of water was to be minimized, the exterior surface of the membrane would be kept in contact with a layer of water of sufficient thickness to allow gas diffusion while sourcing the water molecules required to prevent evaporation from the inside of the chip.

Additionally, the membrane surfaces can be derivatized to allow coupling molecules such long chain hydrocarbons or antibodies for chromatography or fibronectin for growing cells as discussed below.

II. Other Assembly Embodiments

A. Assembly with Dead-End Channel

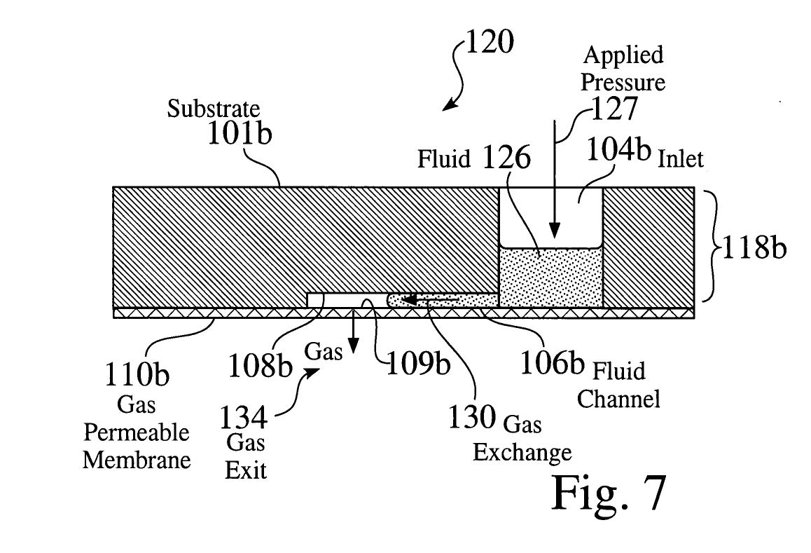

FIG. 7 is a cross section of an exemplary microfluidic chip assembly 120 comprising an exemplary dead-end channel 106b. In an alternate embodiment of the present teachings, microfluidic chip assembly 120 is fabricated with a dead end channel 106b and inlet port 104b. Substrate assembly 118b is fabricated from substrate material 101b. Fluid 126 flows into inlet port 104b, through fluid channel 106b where it passes between channel floor 108b and surface 109b of gas permeable membrane 110b until fluid fills the entire channel 106b. Due to the relatively high gas permeability of the membrane and the thin channel depth, gas exchange 130 between the external environment and the fluid in the channel is relatively rapid. Additionally, gas 134 trapped in the channel exits through the area of the membrane covering the channel and not filled with fluid.

B. Assembly with Gas Manifold

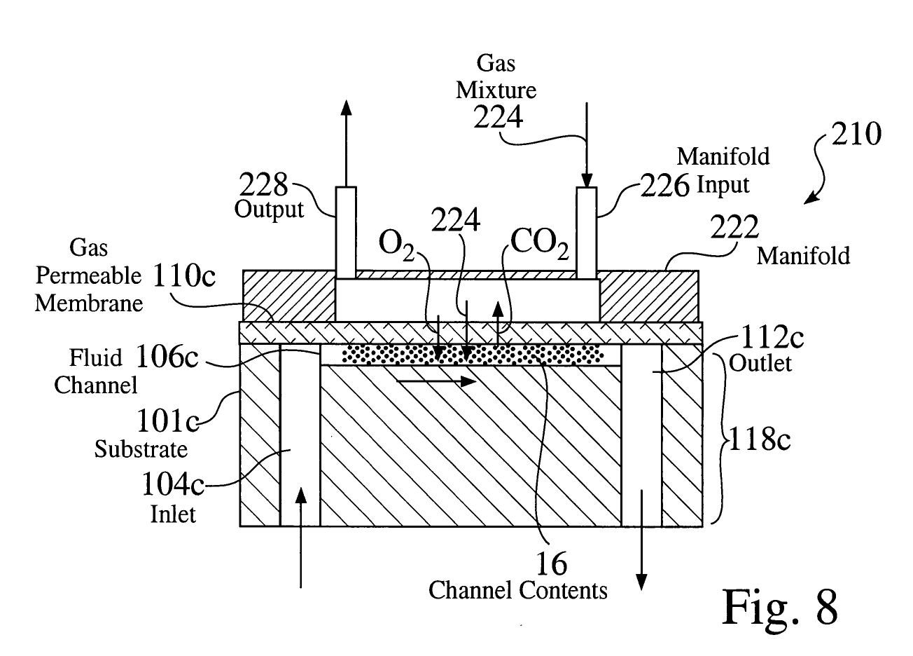

FIG. 8 is a cross section of a microfluidic chip assembly 210 including an exemplary gas manifold 222. Assembly 210 is an embodiment of the present teachings designed to bring a gas or a mixture of gasses 224 into diffusive communication with the contents of a microfluidic channel 106c and hence in contact with the contents 16 of channel 106c. Assembly 210 is comprised of optional gas manifold 222 affixed to membrane 110c. Fluid flows into inlet 104c and then through channel 106c where it passes between the surface of substrate 101c and gas permeable membrane 110c where it encounters the contents of the channel 16 and then exits from the outlet 112c.

During operation of the device, a gas mixture 224 enters the manifold input 226, passes over the membrane 110c and then exits from the manifold through output 228. Due to the relatively high gas permeability of the membrane and the thin channel depth, exchange of oxygen and carbon dioxide is rapid compared to what is required to insure that the gas is in diffusive communication with the contents of the channel.

The gas is delivered to the contents of the channel to carry out assays to study the effects of various gasses on the contents of the channel. In alternate embodiments, the contents of the channel could be living cells, assay reagents, sensing molecules, particles, or beads. For example, in cellular or biochemical assays, gases that inhibit respiration or metabolism, i.e., toxins can be studied along with other gaseous forms of cell signaling agents. Many different types of gases could be used including pure gasses atmospheric gas, as well as other combinations or types of gasses.

The configuration in the figure above serves to demonstrate a single illustrative embodiment of the present teachings. Alternative embodiments may include alternate manifold designs for bringing gasses into diffusive communication with the membrane surface and/or arrays of sensors such as on a standard microplate pitch, for example, to simultaneously sense the gasses contained within the wells of a microplate.

C. Assembly with Mechanically Actuated Valve

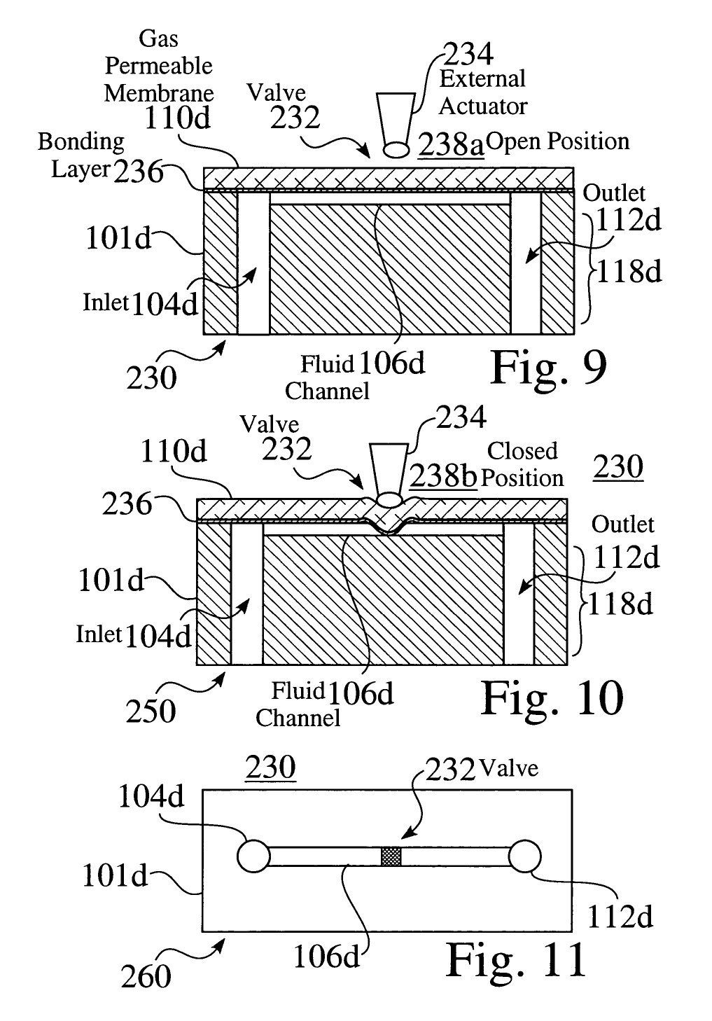

In some embodiments, the present teachings further comprise integrated fluidic valves using the membrane material. For example, FIGS. 9-11 illustrate the operation of a mechanically actuated valve according to aspects of the present teachings. FIGS. 9 and 10 show cross sectional views of a microfluidic device 230 with an integrated valve at location 232. Fluid flows into inlet 104d of substrate assembly 118d through channel 106d covered by membrane 110d and exits at outlet 112d. The open position of valve 232 is indicated by 238a in FIG. 9.

FIG. 10 is a cross sectional view 250 showing the valve in the closed position 238b. Valve 232 is actuated through a vertically force mechanically applied to the membrane by external actuator 234.

FIG. 11 is a top view 260 showing the relative location of valve 232 along channel 106d of substrate assembly 112d. Valve 232 is closed when gas permeable membrane 110d and optional bonding layer 236 are physically depressed by actuator 234 into channel 106d at position 232 stopping both fluid flow and chemical diffusion. The Channel depth Dc is chosen so that the membrane 110d and optional bonding layer 236, can be depressed with an appropriate force so as to sealably contact the bottom of the channel. If the bonding layer is optionally fabricated with a tacky substance such as a silicone adhesive, the valve will remain closed even after the actuation force is removed by sticking permanently to the bottom of the channel after it is actuated. If a reversible valve is desired, the bottom surface must release spontaneously from the bottom of the channel once the actuation pressure is removed or else be bonded to the actuator and be opened when the actuator is retracted.

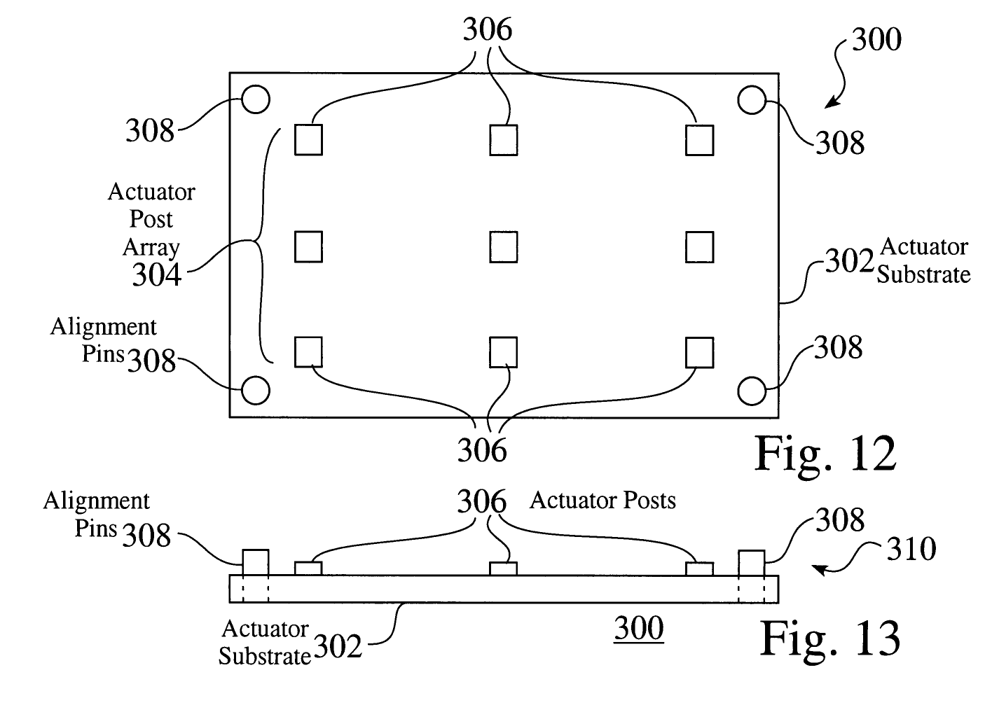

FIG. 12 shows a top view 300 of a substrate 308 which contains an actuator post array 304 comprised of a plurality of raised actuator posts 306. Application of assembly 300 with the proper force to a suitably designed chip according to aspects of the present teachings will cause simultaneous closure of all of the valves contacted by the actuator posts 306. Each individual valve in the array operates separately as is shown in FIGS. 9-11 and when actuated by assembly 300, the individual vales are actuated as an array. Alignment pins 308 or other equivalent mechanical or optical means are provided to insure that the actuator posts 306 are physically aligned to the chip whose valves are to be actuated with the precision required to insure that the actuator posts make contact with their intended valve areas.

In some embodiments, the actuator post array 304 is fabricated by etching a transparent glass substrate 302 everywhere but at the actuator post locations 306. Fabricating of actuator substrate 302 from an optically transparent material enables optical observation of the chip to occur simultaneously with valve actuation.

FIG. 13 is a side view showing the profiles of the actuator posts. The actuator posts must be tall enough to insure that the valves will be completely closed when the substrate and valve array microfluidic device are compressed together with the appropriate force. If the bonding layer has an adhesive surface, the valves will stay closed even after actuator is separated from the microfluidic device.

FIGS. 14-16 illustrate alternate embodiments for actuating a plurality of valves according to aspects of the present teachings. In these embodiments, an externally applied pressure is distributed to exemplary valves 330 and 332a-d via a pressure distribution manifold comprised of exemplary pressure access ports 342 and 344 and exemplary channels 324 and 326 disposed in a second microfabricated substrate 321.

FIG. 14 shows a top view of a chip 320 to which exemplary externally controlled fluidic pressures, (e.g. pneumatic or hydraulic) P1 and P8 are applied to access ports 342 and 326 and distributed by channels 324 and 326 to valves 330 and 332a-d disposed at specifically designated valve locations on fluid channel 334 thus providing an actuation force at each designated valve location.

Sources for externally controlled pressures P1 and P2 may be pneumatic or hydraulic and may be coupled to the pressure distribution manifold by sealably connecting the external controlled pressure to access ports 342 and 344 in second substrate 321. There exist many ways to form a sealed connection to the exemplary access ports of FIGS. 14-16 including the use of compressible gasket materials, compressible o'rings, or by fabricating substrate 321 from a compressible material, all of which sealable means provide for removable or reusable sealed connections. Compressible materials include but are not limited to rubbers, elastomers, fluoropolymers, and the like. In some embodiments, it may be preferable to provide a permanent seal chosen from various means available to achieve permanent seals such means including curable adhesives, pressure sensitive adhesive layers, solvent bonding, ultrasonic bonding, or other means of forming chemical or physical bonds.

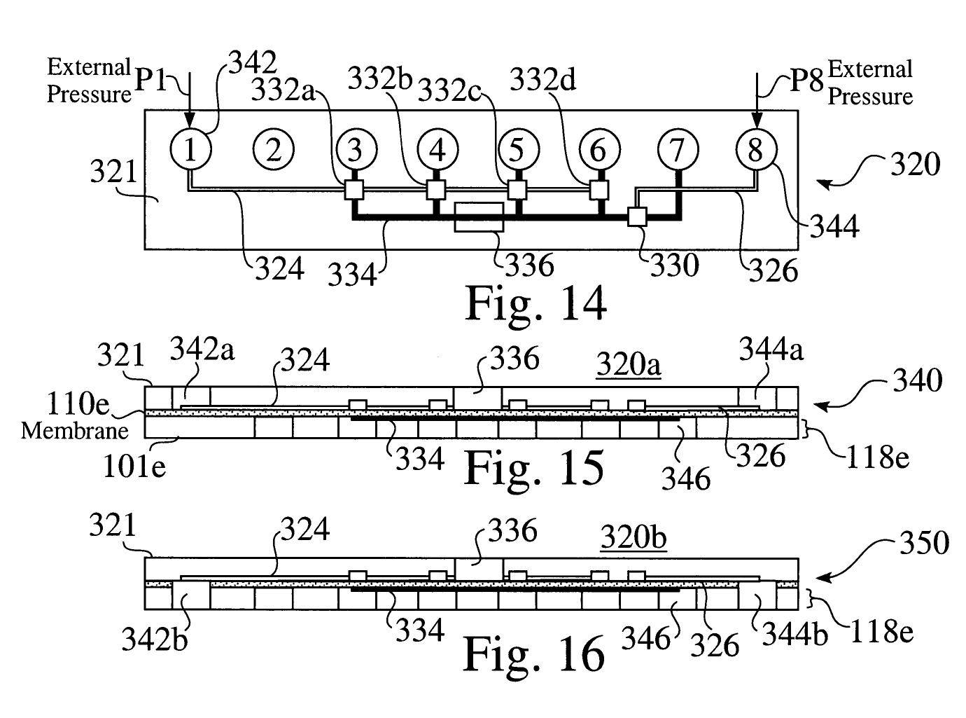

FIG. 15 shows a side view 340 of a structure comprising a first assembled substrate 118e fabricated from substrate material 101e, an exemplary fluid channel 334, exemplary access ports 346 (similar to access ports 102a and 104a of FIG. 6), and attached permeable membrane 110e. The assembly comprising first assembled substrate 118e, channel 334, exemplary access ports 346, and permeable membrane 110e is laminated to a second substrate 321. Exemplary rectangular access port 336 is included to show that access to the permeable membrane can be provided via the same process steps used to fabricate round access ports 342 and 344.

FIG. 15 illustrates an embodiment 340 wherein the valve actuation access ports 342a and 344a are located on the side of chip opposite the exemplary fluid access port 346.

FIG. 16 illustrates an embodiment 350 wherein the valve actuation access ports 342b and 344b are located on the same side of chip as the exemplary fluid access port 356.

In the embodiments shown in FIGS. 14-16, it is possible for the pressure distribution channels to cross over fluid channels without collapsing them when pressure is applied, i.e., activating a parasitic valve, since the area of the valve as designed is much larger than the cross over area of exemplary pressure distribution channel 326 and exemplary fluid channel 334. This means that whereas the force applied to a designated valve is sufficient to cause the valve to close; this is not the case for a cross over where the force is not sufficient to cause a parasitic valve to close. An important aspect of the design and implementation of practical and useful valves is that the membrane is deflectable with a reasonable applied pressure. Parameters which affect the deflection pressure are the valve area, channel width and depth, membrane thickness, and membrane elastic modulus. The present teachings provide sufficient flexibility with regard to these design parameters to enable useful and practical valves to be designed and implemented, particularly using microfabrication methods.

Another important feature of these exemplary embodiments is that a single exemplary pressure distribution channel such as 324 may be used to actuate a plurality of exemplary valves such as 332a-d. This is because the force applied to every valve in steady state is solely a function of the area of the valve and not the number of valves. Another feature of these embodiments is that the locations of exemplary access ports 1-8 may be disposed with a port to port spacing matching that of a standard microplate well pitch so as to optimize compatibility with standard microplate laboratory instruments and automation.

III. Assembly Fabrication

Manufactuing of the assemblies of the present teachings may be carried out by any number of microfabrication techniques that are well known in the art. For example, lithographic techniques may be employed in fabricating glass, quartz or silicon substrates, for example, with methods well known in the semiconductor manufacturing industries. Photolithographic masking, plasma or wet etching and other semiconductor processing technologies define microscale elements in and on substrate surfaces. Alternatively, micromachining methods, such as laser drilling, micromilling and the like, may be employed. Similarly, for polymeric substrates, well known manufacturing techniques may also be used. These techniques include injection molding techniques or embossing or stamp molding methods where large numbers of substrates may be produced using, e.g., rolling stamps to produce large sheets of microscale substrates, or polymer microcasting techniques where the substrate is polymerized within a microfabricated mold. Two exemplary methods of fabricating the present teachings are provided herein. It is to be understood that the present teachings are not limited to fabrication by one or the other of these methods. Rather, other suitable methods of fabricating the present devices, including modifying the present methods, are also contemplated.

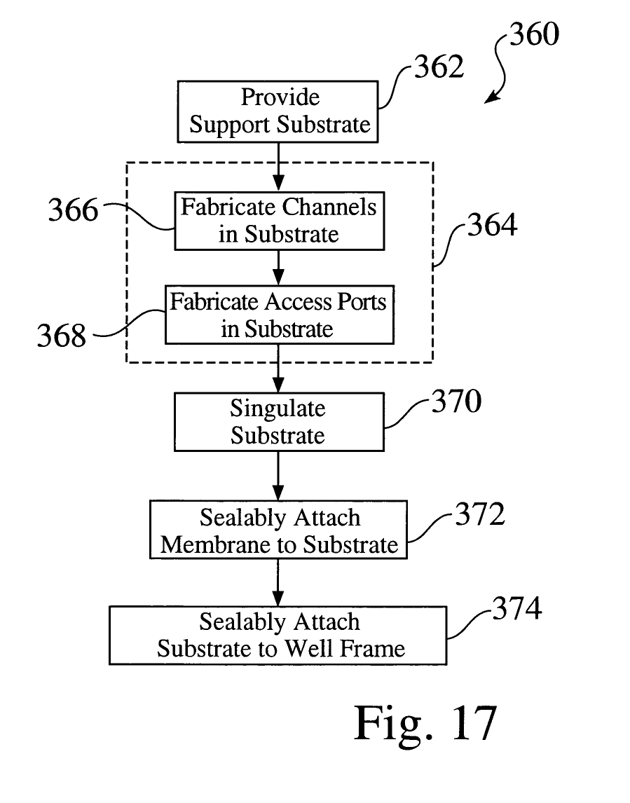

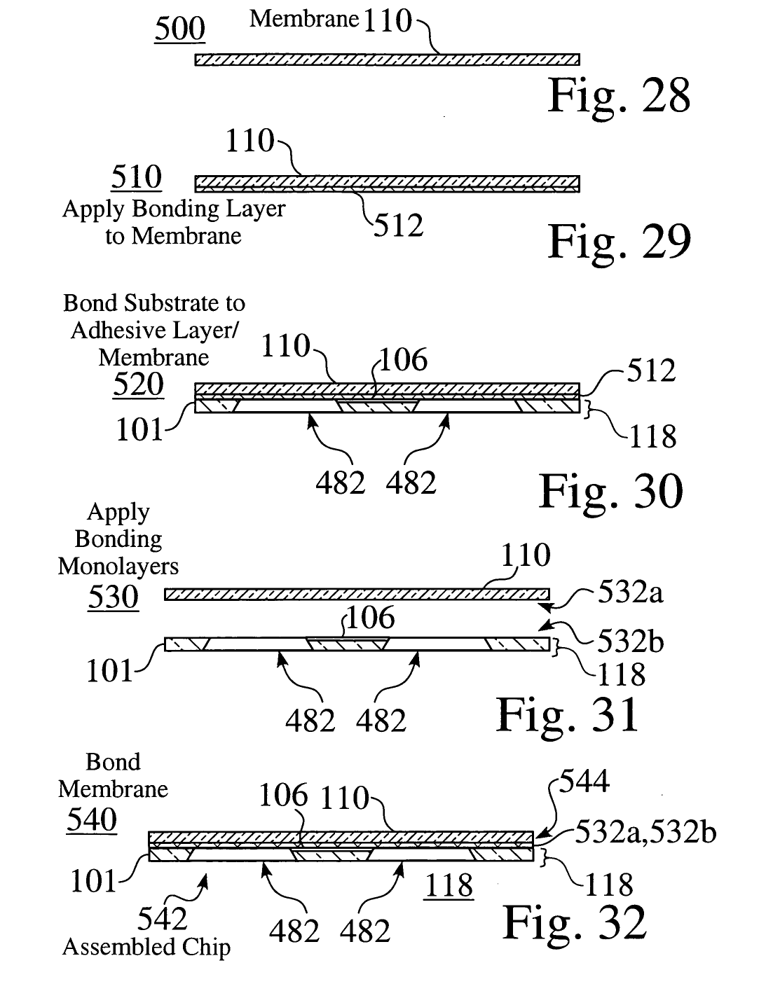

More specifically, fabrication and assembly of substrate assembly 118e and permeable membrane 110e are as taught in FIGS. 17-32. Second substrate 321 is preferably microfabricated from an optically transparent material and laminated to permeable membrane 110e as taught by FIGS. 28-32 or as otherwise known. Second substrate 231 may be fabricated from a hard material such as glass or plastic or from an elastomeric material such as silicone rubber. If the second substrate is fabricated from a hard material which is not gas permeable, access ports such as 336 can be provided to allow gas exchange between the interior of the channel and the external environment. Alternatively, gas exchange can be provided at a desired region by providing a venting channel and access port in second substrate 321 with a connection to the external environment.

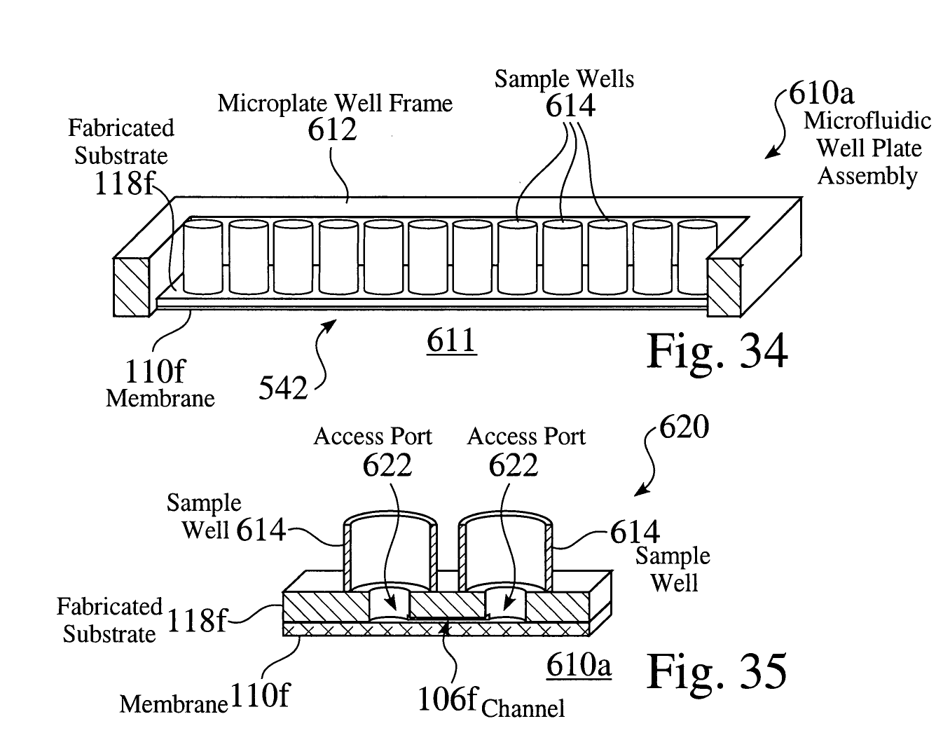

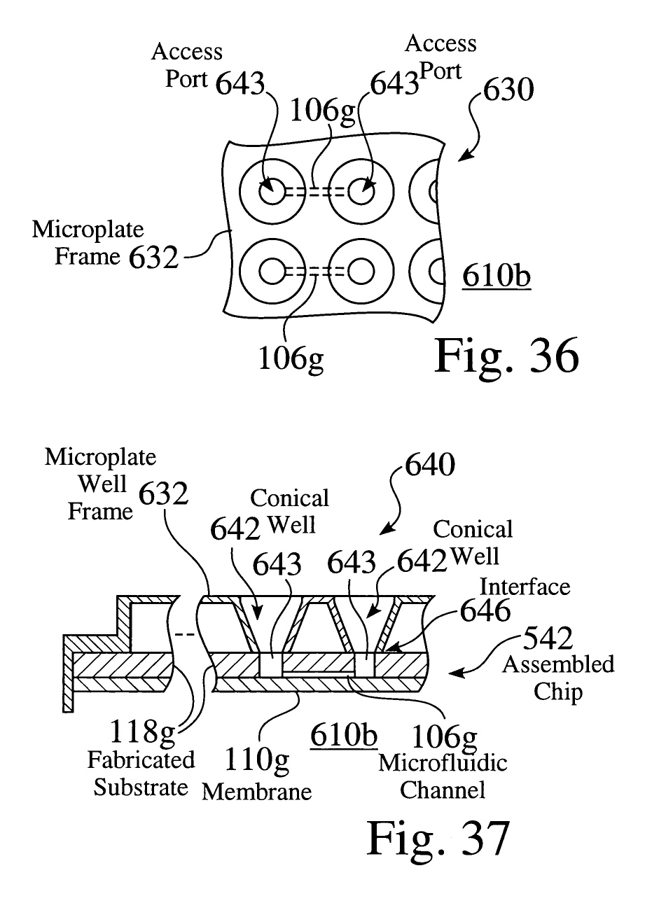

FIG. 17 illustrates an exemplary process flow chart 360 for the fabrication of a microfluidic well plate assembly 610 such as 610a (FIG. 34, FIG. 35), 610b (FIG. 36, FIG. 37). A substrate 101 is provided in process 362 upon which a microfluidic structure is fabricated in process 364, which comprises a fabrication process 366 of channels 106 on a channel surface 103a of a substrate 101 as well as a fabrication process 368 of access ports 104, 112 between channel surface 103a and an access port surface 103b opposite the channel surface 103a, e.g. 106a, 103a, 103b, 101a, 104a, 112a (FIG. 6). The fabricated substrate 118, e.g. 118a (FIG. 6) is then singulated in process 370. The channel surface 103a of the singulated substrate 118 is then sealably attached in process 372 to a membrane 110, e.g, 110a (FIG. 6). The access port surface 103b of the fabricated substrate 118 is then sealably attached in process 374 to well frame 612.

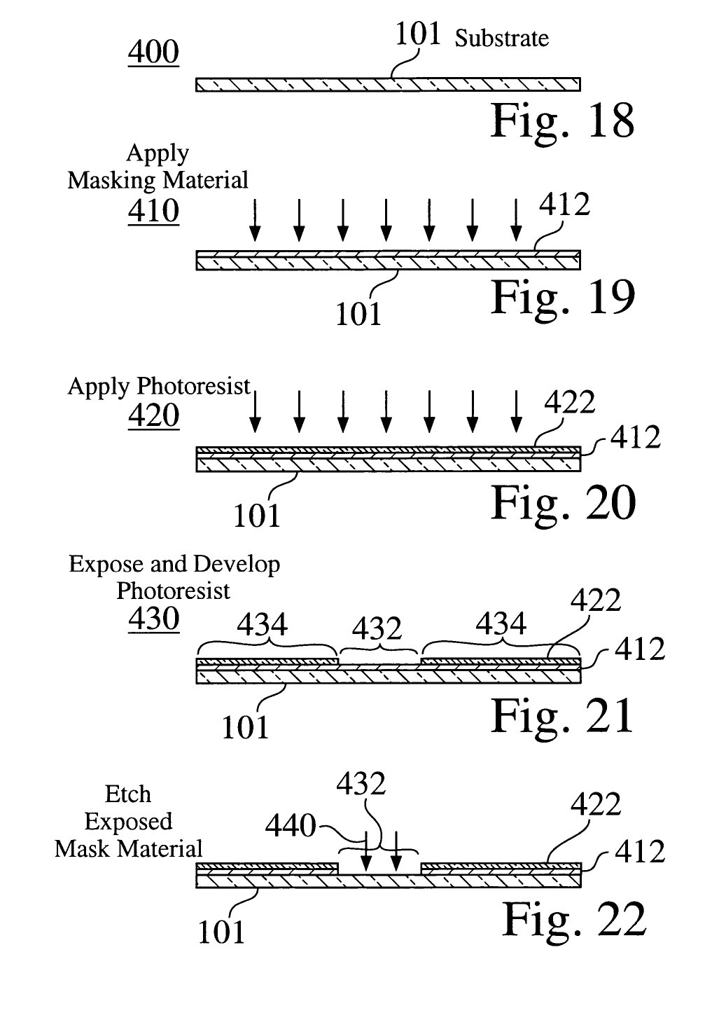

FIG. 18 is a cross sectional view 400 of a starting glass substrate 101 for use in process 362. Process 364 of FIG. 17 comprises two sub-processes 366 and 368 for fabrication of channels and access ports in the substrate. In some cases, other methods for fabricating equivalent channels and ports such as chemical or plasma etching, milling with laser, ultrasonic or mechanical means, drilling with laser, ultrasonic, or mechanical means can be substituted to obtain the equivalent result of step 364 some combinations of which may preferably combine or reverse the order of steps 366 and 368.

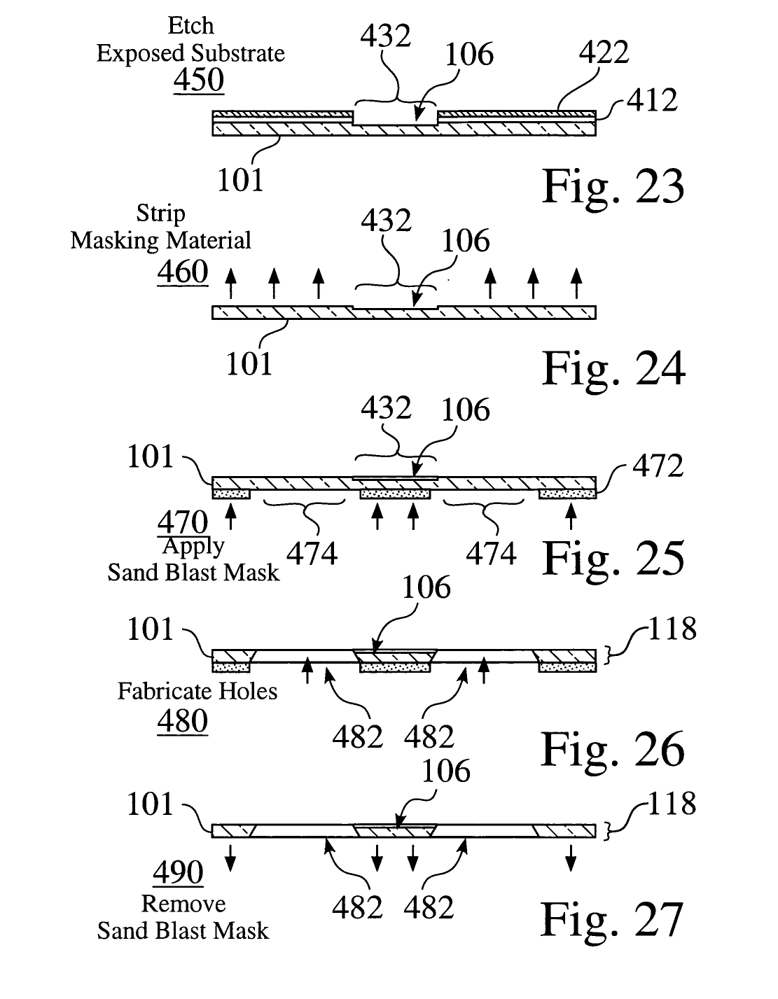

An exemplary set of steps to implement process 366 of FIG. 17 in which channels are fabricated in a substrate is shown in FIGS. 19-24. FIG. 19 shows a process 410 to apply masking material 412 to a surface, e.g. 103a (FIG. 6) of substrate 101. FIG. 20 shows a step 420 to apply photoresist 422 to masking material 412. FIG. 21 shows a step 430 to expose and develop photoresist 422 leaving areas of developed photoresist 434 and exposed masking material 432. FIG. 22 shows a process step 440 to etch masking material 412 in exposed areas 432 forming an etch mask. FIG. 23 shows a step 450 to etch areas of glass exposed by the formation of patterned etch mask 432 in step 440. FIG. 24 shows a step 460 to strip etch mask material 422 and etch mask 412 from etched substrate 101.

An exemplary set of steps to implement process 368 of FIG. 17 in which the access ports are fabricated in the substrate are shown in FIGS. 25-27. FIG. 25 shows a step 470 to apply a sand blast mask 472 to surface, e.g. 103a (FIG. 6) of substrate 101 opposite area of etched channel 432, e.g. 103b (FIG. 6) leaving exposed substrate areas 474. FIG. 26 shows a process step 480 to fabricate holes by sand blasting areas 482 exposed by sand blast mask 472. FIG. 27 shows a process step 490 to remove sand blast mask 472 leaving substrate 101 including channels 106 and access ports 482 forming substrate assembly 118. Access ports 482 are exemplary and form the basic structures for fluid inlet and outlet ports for use in numerous potential embodiments of the present teachings, e.g. 104a, 112a (FIG. 6).

Referring to FIG. 17, the substrate with channels and ports as fabricated in process 364 is then singulated in process 370. In some cases, other methods for singulating substrates such as dicing, sawing, laser cutting, scribing, and breaking can be substituted to obtain the equivalent result of process 370.

An alternate and potentially preferable process is to reverse the sequence of processes 370 and 372. In the alternate process the substrate is sealably attached to the membrane prior to singulation of the individual chip or chips from the starting substrate. Choice of a membrane attachment and singulation process and sequence will depend on the size of the final chip relative to the size of the starting substrate, the substrate, bonding layer, and membrane materials, and the most cost-effective method to manufacture the final product.

The membrane is then sealably attached to the substrate in process 372 of FIG. 17. In some cases, other methods for sealably attaching adhesive films or bonding layers to substrates such as lamination processes utilizing pressure and heat, pressure and ultrasonic energy, pressure sensitive adhesives, plasma surface treatments such as oxygen or plasma in the presence of other pure gasses or gas mixtures, chemical surface treatments such as silanes, silicones and the like and such processes can be substituted to obtain the equivalent result of process 370. Methods of applying bonding layers include but are not limited to thin or thick film lamination, spin coating, spray coating, dip coating, extrusion, co-extrusion, and chemical or vapor deposition or direct dispensing through an orifice. Methods for patterning bonding materials or bonding layers include but are not limited to photolithography of resist masks, photosensitive bonding materials, direct printing of bonding materials by ink jet, silk screen or etched stencils, or direct stamp transfer methods of bonding materials as well as application of bonding materials to surfaces treated by or assisted using isotopic or anisotropic plasma processes, finally direct dispensing of bonding materials through an orifice under automated computer control.

In some embodiments, a layer of a photosensitive material with photo-cleavable terminating groups would be applied to the surfaces of the chip after fabrication of the channels and/or the access ports. The photosensitive material would then be exposed directly or through a photo-mask to remove the photo-cleavable terminating groups in specifically desired areas. Subsequently the chip would be exposed to an agent that would bond selectively to only the photo-cleaved terminating groups. By repeating this exemplary process, a first agent could be applied only to areas where bonding to the membrane was desired and a second agent could be applied to the inside of the channels or access ports where compatibility with a particular assay or substance to be used in a specific application was desired.

An exemplary set of steps to implement process 372 of FIG. 17 by which the membrane is sealably attached to the substrate is shown in FIGS. 28-30. FIG. 28 shows a cross sectional view 500 of a starting membrane 110. FIG. 29 shows a process step 510 to apply a bonding layer 512 to membrane 110. FIG. 30 shows a process step 520 to bond membrane 110 and bonding layer 512 to fabricated substrate 118 by bringing applied bonding layer 512 into intimate contact with substrate 118 under the appropriate environmental conditions for the appropriate time. Process step 520 results in an assembled chip 542 comprised of substrate assembly 118 and membrane 110.

An alternate exemplary set of steps to implement process 372 of FIG. 17 by which the membrane is sealably attached to the substrate is shown in FIGS. 31-32. FIG. 31 is an alternative process step 530 in which bonding monolayers 532a and 532b are applied to the surfaces of membrane 110 and substrate 101, respectively. FIG. 32 shows a process step 540 to bond membrane 110 to substrate 101 forming an assembled chip 542 having an interfacial bond 544 between monolayers 532a and 532b by bringing applied bonding monolayers 532a and 532b into intimate contact under the appropriate environmental conditions for the appropriate time.

Referring to FIG. 17, the singulated substrate with attached membrane 542 is sealably attached to a well frame in process 374. In some cases, other methods for sealably attaching a singulated substrate to a microplate well frame such as through the use of suitable epoxies, UV curable adhesives, silicones and the like can be substituted to obtain the equivalent result of process 374. Well frames could be fabricated from many materials including metals such as aluminum or stainless steel and plastics such as polystyrene or polypropylene, acrylic, polycarbonate, and Topas in any shape or size, however there are two standardized embodiments of the present teachings. These are embodiments wherein the size of the well frame (i.e., the outer dimensions of length and width and possibly the depth) is chosen to be consistent and therefore compatible with those of standardized microscope slides and micro titer plates or microplates. Exact standard sizes can be obtained using standard reference documents which detail specific standard sizes for microscope slides and microplates as used in specific applications. While some variation in “standard” sizes occurs from application to application, the standard sizes are generally consistent within a given application area.

Methods of bonding the membrane to the substrate include the use of a silane bond. Various techniques can be used to preclude the silanes from depositing in undesired areas. For example, the channels can be etched with a strong base such as sodium hydroxide; the silanes can be patterned so as to avoid channels with Teflon etch mask; or the silane layer can be applied by transfer printing so as to avoid deposition in the channels.

Alternatively, a pressure sensitive adhesive may be bonded to the gas permeable membrane. This can be accomplished, for example, by using a die cut adhesive backed gas permeable membrane that is then applied, for example, with an automatic labeling machine. Alternatively, a stamp transfer adhesive can be used. Shown below are typical platen press conditions used in applying membranes composed of Teflon or Teflon like materials to solid substrates. Typical molding temperatures range from 240° to 275° C. (464° to 527° F.) for Teflon® AF 1600 and 340° to 360° C. (644° to 680° F.) for Teflon® AF 2400.

Typical Platen Press Conditions

| | Interface | | | |
|---|---|---|---|---|
| | Temperature, | Pressure, | Dwell | Substrate Surface |
| Substrate | ° C. (° F.) | psi | Time, min | Preparation and Treatment |
| Aluminum | 282 (540) | 100 | 5 | None, if Type C film is used |
| | 293 (560) | 100 | 5 | Parker Bonderite 700 series* |
| Copper | 282 (540) | 100 | 3-5 | Various treatments |
| Steel | 293-304 | 100-300 | 5 | Sandblast and degrease, |
| | (560-580) | | | phosphatized* |
| Stainless steel | 360 (680) | 300 | 5 | None |
| | 293 (560) | 300 | 5 | Dispersion primer of Teflon ® -- |
| | | | | see paragraph above |
| Teflon ® TFE | 343 (650) | 100 | 3-5 | None |
| Nickel | 282 (540) | 100 | 5 | None, if Type C film is used |
| Nickel Ceramics | 293 (560) | 300 | 5 | Dispersion primer of DuPont FEP |
| Nichrome | | | | |
| Nomex ® nylon | 282 (540) | 100 | 5 | Use Type C film Pre-dry Nomex ® |
| paper | | | | (at 121° C. [250° F.], 30 min) |
| Glass | 296 (565) | 10 | 10 | Silane coupling agent** |
| Kapton ® | 282 (540) | 100 | 5 | None, if Type C film is used |
| polyimide film | | | | |

**Treating and phosphating chemicals are available from Oxy Metal Industries, 322 Main St., Morenca, MI 49056.
**Silane coupling agents are available from Union Carbide Corporation and Dow Corning

IV. Representative Plate Assemblies

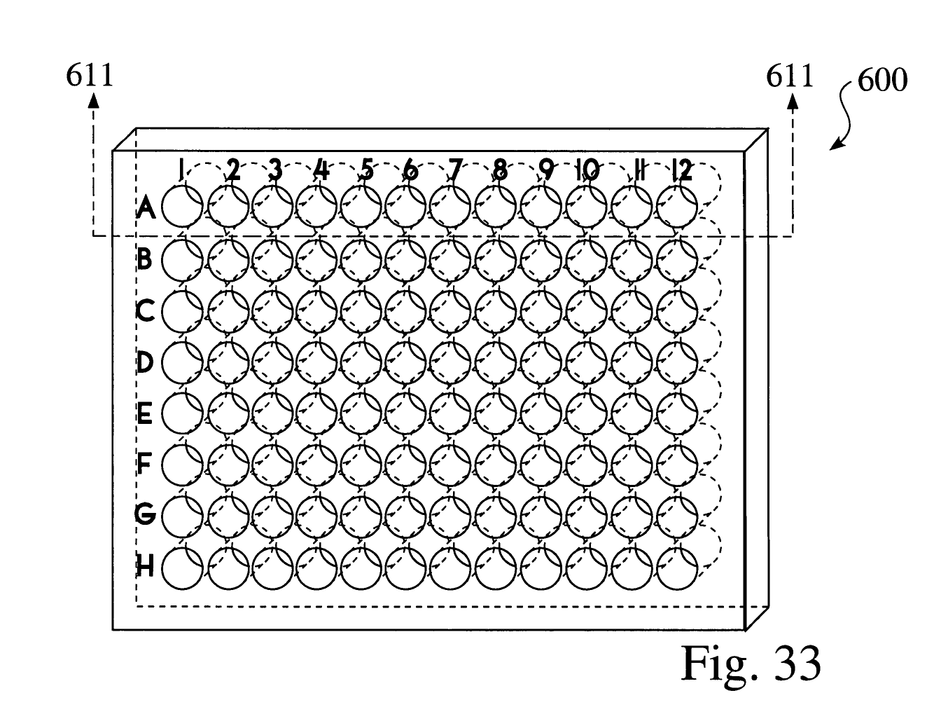

FIG. 33 shows a perspective view 600 of an industry standard 96 well microplate. Industry standard generally refers to relatively standard footprint, height, and well to well pitch. Industry standards for microplates have been created by the Society for Biomedical Screening for various types of microplates including 96, 384, and 1536 well microplates which have standardized well to well pitches of 9 mm, 4.5 mm, and 2.25 mm, respectively. Standards exist for other types of microplates as well. One aspect of the present teachings is to provide compatibility with these standards and allow products fabricated according to the present teachings to be used with industry standard dispensing, detection, laboratory automation, robotics and other processing equipment. FIG. 33 shows the location of cross section 611 which will be referred to in FIG. 34.

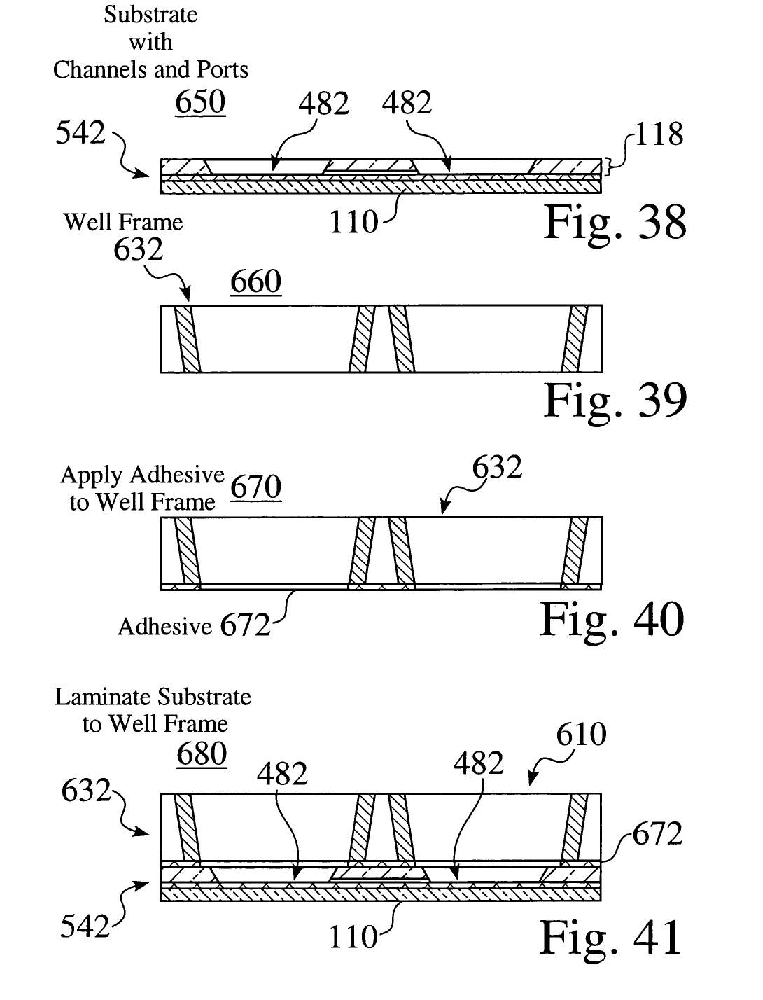

FIG. 34 shows a cross sectional perspective view of microfluidic well plate assembly 610a along section 611 of FIG. 33. This figure illustrates the inherent compatibility of mating an assembled chip 542 according to aspects of the present teachings with an industry standard microplate well frame 612 similar to the one shown in FIG. 33. Surface 103b of assembled substrate 188 is sealably bonded to microplate well frame 612 using a process such as 374 of FIG. 17 and process steps such as described in FIGS. 38-41. The assembled chip is preferably bonded to the microplate frame by an adhesive system which seals the edges of each well to prevent fluid leakage and optionally with the structural elements of the well frame. The outer surface of membrane 110 of assembled chip 542 faces the bottom of the Microplate well frame so as to allow convenient viewing of the chip from below.

FIG. 35 shows a partial cut away perspective view 620 of the microfluidic well plate assembly 610a of FIG. 34. The present teachings can be incorporated into any standard microplate that exists and it is expected that the teachings will be able to be incorporated into future standards as well. Sample wells 614 are preferably positioned over access ports 622, e.g., 104a, 112a (FIG. 6) providing means for fluid connection and flow through channel 106f formed between the surface 108f of fabricated substrate 118f and surface 109f of membrane

FIG. 36 shows a partial cut away top view 630 of an alternate embodiment of a microfluidic well plate assembly 610b similar to microfluidic well plate assembly 610a but preferably having conically shaped wells to accommodate smaller fluid volumes of directing them to and from the access ports 642 and channels 106 on the chip. This embodiment is similarly incorporated into an industry standard microplate format.

FIG. 37 shows a partial cross section 640 of microfluidic well plate assembly 610b. Conical wells preferably efficiently hold and direct small quantities fluids to and from assess ports 643 particularly when the diameter of the conical wells 642 are relatively matched to the diameter of access ports 643. FIG. 37 shows that assembled chip 542 can be optionally sealably bonded to the peripheral structure of microplate well frame 632 as well as to the fluid wells to increase the rigidity and flatness of microfluidic well assembly 610b. Microplate well frame 632 can be fabricated from a molded plastic structure to form wells 643 and outer form and footprint of microplate frame 632. If necessary a relief structure, such as a groove, can be incorporated into interfacial surface of the well frame at interface 646 to allow for expansion of the adhesive during curing.

V. Fabrication of Plate Assemblies

An exemplary set of steps to implement process 374 of FIG. 17 in which the completed substrate is sealably attached to the well frame is shown in FIGS. 38-41. FIG. 38 shows a process 650 providing an assembled chip 542, comprising a fabricated substrate 118 and attached membrane 110. FIG. 39 shows a process 660 providing a well frame 632 to be laminated to assembled chip 542. FIG. 40 shows a process 670 to apply an adhesive 672 to well frame 632. FIG. 41 shows a process step 680 to laminate assembled chip 542 to well frame 632 with applied adhesive layer 672 by bringing adhesive layer 672 and completed substrate 542 into intimate contact under the appropriate environmental conditions for the appropriate time.

The materials used in any step of the fabrication process 360 should preferably be selected and processed so as to be inert with respect to the ultimate intended application of the chip, e.g., for use in chemical, biochemical, and biological assays, performing chemical reactions, or other applications. In other words, the materials must not leach or otherwise contribute toxic substances or other contaminants into the channels, chambers, or access ports or wells in amounts that would affect proper operation of the specific intended product application.

The bonding adhesive is preferably chosen to be compatible with the materials comprising the chip and well frame as well as the assay reagents which might come in contact with the adhesive and should be applied to avoid contamination of access ports 482 or channels 106. This can be accomplished by using any number of commercially available adhesives and processes for applying and curing the adhesive that does not impact the form or function of the device in a significant way. Such adhesives and processes are generally known to those knowledgeable in the art. For example, light curable adhesives, epoxies, silane layers, silicone adhesives and photo patternable adhesives can be used. Adhesives can be applied by silk screening, photolithography, roll coating, ink jet printing, or stamp transfer processes. If necessary a relief structure, such as a groove, can be incorporated into interfacial surface of the plastic well bottom at interface 7 to allow for expansion of the adhesive during curing.

V. Well Frame Assembly

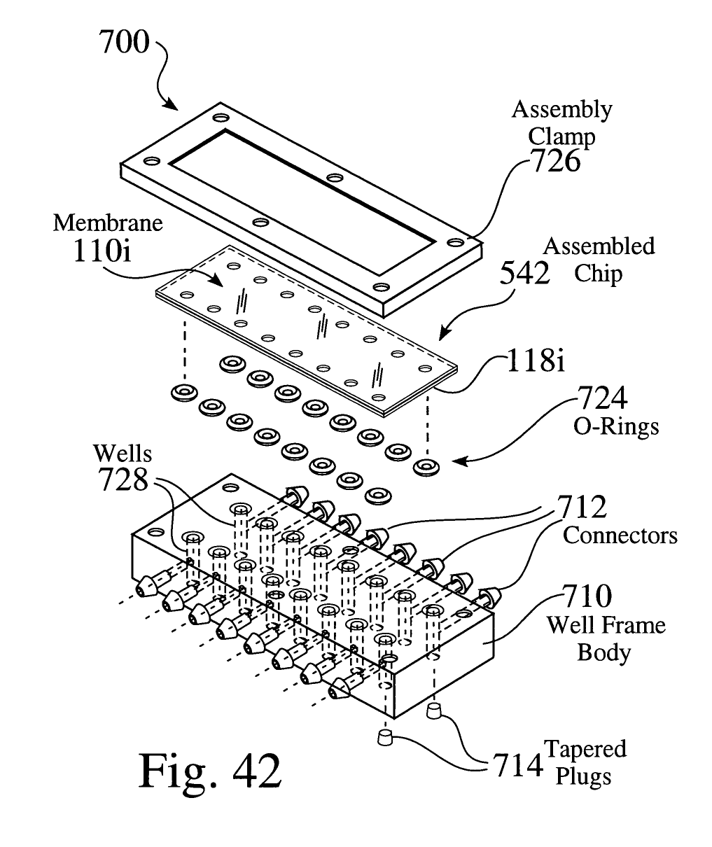

FIG. 42 is a perspective view 700 of a re-usable well frame assembly for sealably mounting, de-mounting and operating an assembled chip 542. Well frame assembly 700 is preferably fabricated with wells located on a standard microplate pitch such as 9 mm for a standard 96 well plate, 4.5 mm for a 384 well plate, 2.25 mm for a 1536 well plate and so on for other present and future standard plates. The assembled chip 542, having access port locations, e.g. 104a, 112a (FIG. 6) preferably matching the well locations of well frame assembly 700 is sealably mounted to well frame body 710 by o'rings 724 and secured by assembly clamp 726. Well frame assembly 700 is designed to be compatible with and viewable by standard laboratory micro scopes while allowing direct access to membrane surface 110i. Additionally well frame assembly 700 provides flexibility and compatibility with existing fluid handling equipment such as fluid dispensers and pipetting systems by providing access to a plurality of wells 728 on the surface of well frame body 710 opposite membrane 110i. Finally, well frame assembly 700 also provides access to and control of each individual well thus providing the flexibility to develop new assays or other applications of assembled chip 542.

A plurality of wells 728 is disposed in well frame body 710 to hold reagents and direct them to and from associated chip access ports and channels within assembled chip 542. A plurality of connectors 712 are disposed within well frame body 710 to direct sources of externally generated and controlled pneumatic or hydraulic pressure to the plurality of wells 728. Tapered plugs 714 or equivalent alternative means is provided to seal the well entrances allowing the externally controlled pressure directed through connectors 712 to wells 728 to build up within the wells and provide a driving force for flow within the channels of assembled chip 542. Alternative designs may be used to implement well frame assemblies with functions equivalent to those of well frame assembly 700; thus, the exemplary design described herein should not be interpreted as a limitation of the present teachings. For example, an alternate embodiment of well frame assembly 700 could comprise plastic molded components or sealing elements and could be designed for one time disposable use or for reusability.

In the absence of an externally generated and controlled source of pneumatic or hydraulic pressure, flow in channels within the chip can be driven by head pressure generated by gravitational forces on the fluid columns in the wells. The height of the fluid in the wells determines the head pressure applied to the wells and this can be determined by the volume of fluid dispensed into the wells. A minimized and uniform meniscus on the fluid surface in the wells is desirable to minimize flow variations caused by well to well meniscus shape variations.

The methods and technologies illustrated for control of flow in the re-usable well frame assembly 700 in FIG. 42 are scalable from the microscope slide to the microplate plate formats shown in FIGS. 34-37.

When not engaged in well frame assembly, flow in the chip is driven by head pressure generated by gravitational and surface tension forces on the fluid columns in the chip access ports. External packaging such as been described previously may be used to increase the height of the fluid column to generate additional head pressure. Additionally, portable pressure reservoirs may be included in either the chip packaging or well frame assembly to accommodate various application requirements. Alternatively, the chip can be oriented vertically (angle of 90 degrees) or at an angle less than 90 degrees to increase the height difference between the input and output wells and hence the flow rate due to gravity driven flow.

VI. System for Operating a Microfluidic Chip

FIG. 43 shows an architectural block diagram for a system 740 for operating a microfluidic chip and associated reagents 746 comprising a chip controller 742 and a chip reader and associated software 744. Chip controller 742 communicates with a microfluidic chip and associated reagents according to aspects of the present teachings 746 through fluidic control interface 748 which may include pneumatic, hydraulic, electronic, mechanical, or optical means or a combination of any of the afore mentioned control modalities. Chip reader and associated software 744 communicates with a microfluidic chip and associated reagents according to aspects of the present teachings 746 through interface 749 which may include pneumatic, hydraulic, electronic, mechanical, or optical means or a combination of any of the afore mentioned control modalities.

Chip controller 742 controls fluid flow in microfluidic chip and its associated reagents 746 by supplying regulated and controlled sources of pressure or flow through interface 748. Either constant pressure or constant flow control is possible by providing a suitable configuration for the desired control embodiment. In a constant pressure control embodiment, the externally controlled source would preferably provide a source of constant pressure to the inlet or outlet wells and thus control flow in the channels. In a constant flow control embodiment, the externally controlled source would preferably provide a source of constant flow to the inlet or outlet wells and thus control flow in the channels. In a hybrid flow control embodiment, the externally controlled source would provide a hybrid of constant pressure and constant flow control to the inlet or outlet wells and thus control flow in the channels. This includes a hybrid controller capable of switching back and forth between constant pressure and constant flow modes. Either constant pressure, constant flow, or hybrid flow controllers can be operated in the “closed loop mode” if equipped with means to measure a signal proportional to the flow to be controlled and use this information as a feedback signal for servo control of the flow of fluid in a channel.

Constant pressure control may be used when the fluidic resistance of the microfluidic device is in a high enough range so that the pressure controller is capable of providing the desired degree of precision and accuracy of pressure regulation at the operating pressure. In cases where the fluidic resistance of the microfluidic device is relatively low, constant flow control may be used to control the flow in the channels. In other cases, a hybrid between constant pressure and constant flow may be used to control flow in the channels.

In some embodiments, chip controller 742 comprises a computerized valve controller such as those commercially available from Automate Scientific Corp., an accurately regulated source of gas, and means for sealably interconnecting the pressurized gas source and the valve controller to chip 746. The regulated source of gas is preferably designed to provide accuracy and precision of better than 0.01 PSI in the range of −10 to +10 PSI so as to provide controlled flow velocities in the range of 0 to 1 meter per second with a precision of better than 0.1 mm/sec and preferably better than 10 micron per second and more preferably better than 1 micron per second.

In some embodiments, chip controller 742 includes a computerized valve controller such as the ValveLink8 available from Automate Scientific, a precisely controlled syringe pump such as is commercially available from Cavro Scientific Corp., and means for sealably interconnecting the syringe pump and the valve controller to chip 746. The syringe pump is preferably designed to provide the desired accuracy and precision of the flow required in an actual operation of the microfluidic chip. Since flow rates in microfluidic devices are usually in the range of picoliters to nanoliters per second, the syringe pump should preferably be configured to provide a flows controlled to precision of 10% or better or preferably 1% or better or even more preferably 0.1% or better in certain applications so as to provide flow velocities in the range of 0 to 1 meter per second with a precision of better than 0.1 mm/sec and preferably better than 10 micron per second and more preferably better than 1 micron per second.

In some embodiments, the system for operating a microfluidic chip and associated reagents 740 described above (see FIG. 43) would be used to perform an assay selected from the group including but not limited to cellular, biochemical, and chemical assays. Assays of these types are preferably quantified by detection of a measurable change in one or more observable property of the assay in response to a specific stimulation or set of stimuli. Detection schemes can involve optical readouts including absorbance, transmission, reflectance, refractive index, luminescence, fluorescence intensity, fluorescence lifetime, fluorescence polarization, fluorescence anisotropy or equivalents, turbidity, color, grayscale, phase contrast, differential phase contrast, or physical readouts including absolute or relative position, velocity, acceleration, morphology, changes in cell function, morphology and the movement of cells across barriers including sieves, membranes and gels or equivalents, or electromagnetic readouts including electrical resistance, charge, conductance, capacitance, inductance, impedance, admittance, electric potential, chemical potential, electric field, magnetic field, or equivalents, or chemical or electrochemical readouts including redox potential, oxygen, carbon dioxide, nitrous oxide, pH, and combinations thereof.

Optically transparent and low fluorescence background materials are preferably used in the construction of the microfluidic chip and formulation of the associated reagents 746 to enable the collection of optical data in modalities including but not limited to fluorescence, luminescence, time resolved fluorescence, fluorescence polarization, absorbance, and the like. Instruments for detection include but are not limited to point reading as well as imaging systems with single or multi wavelength measurements from ultra violet to infrared wavelengths with detectors ranging from photodiodes to avalanche photo diodes, to Photomultiplier tubes, to charge coupled devices (CCDs), enhanced CCDs, and cooled CCDs. Imaging detectors have the advantage of being able to read out the entire sample field of view quickly whereas point readers can have higher resolution and contrast. The choice of observable properties and detection modes should not be considered to be limited by the above description since any suitable observable properties and detection schemes can be observed or used.

In an exemplary embodiment of an assay and detection method, the observed property for the assay would be a change in binding of a ligand to surface receptors of living cells. The detection method would be a change in the fluorescence polarization levels of the signal received from a fluorescently labeled ligand within a channel of a microfluidic chip fabricated according to aspects of the present teachings. The relatively thin depth of a channel within a microfluidic device according to aspects of the present teachings results in relatively low fluorescence background being generated from substances within the channel compared to similar measurements in microplates. This allows fluorescence polarization measurements to be made as a direct readout of molecular binding within the channel. For example in some embodiments, a labeled natural ligand for a cell surface receptor would be displaced by a test compound if the test compound had a similar or higher affinity for the receptor than did the natural ligand. Higher fluorescence polarization in the vicinity of the cells indicates a lower degree of displacement of labeled natural ligand. Conversely, as more and more labeled ligand is displaced, the observed fluorescence polarization decreases. Fluorescence polarization measurements in a relatively thin microfluidic channel potentially enables cell surface receptor and other similar binding assays to be carried out without the use of confocal detection methods which might be necessary in non-microfluidic formats.

In some embodiments, images acquired from the microfluidic chip during an assay by a device such as a microscope and CCD camera would be analyzed using computerized image analysis software. For example, images acquired before, during, and/or after an assay is performed, in a preferable order, could be compared with each other using computer algorithms to quantify the changes in the observed property selected to read out the assay. For example in a first embodiment, simple subtraction of images of the observable property taken before and after an assay could preferably be used to quantitatively read out the assay results. Alternatively, in a second embodiment, autocorrelation algorithms could preferably be used to provide a quantitative indication of the extent of specifically measurable changes in the observable property during the assay.

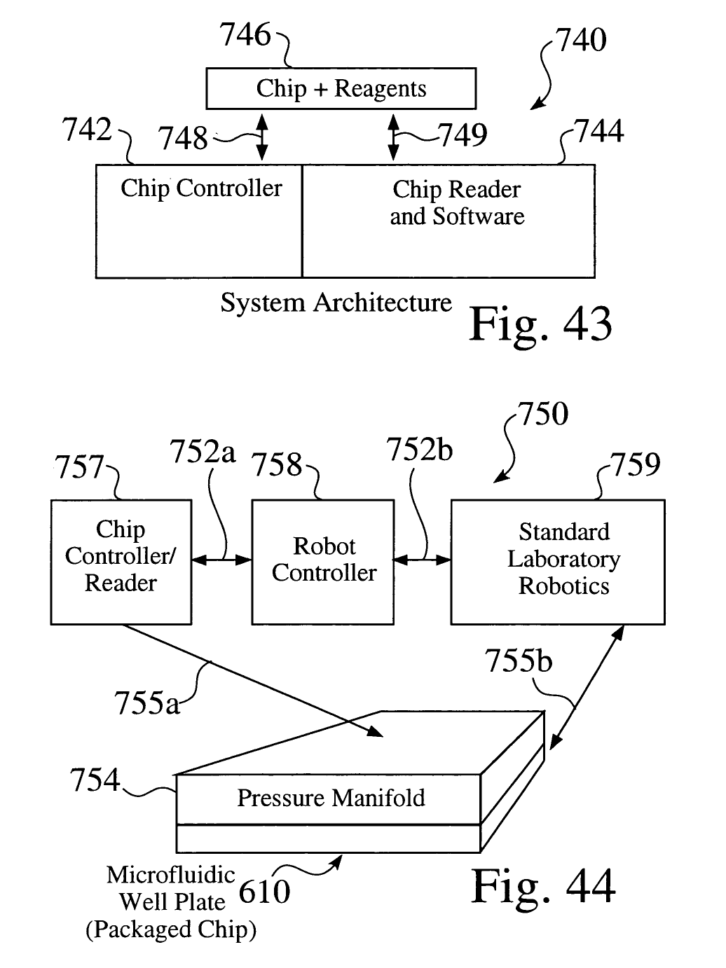

FIG. 44 is an architectural block diagram 750 of a system for operating a chip according to aspects of the present teachings in an automated laboratory environment. Chip controller and reader 757 communicate with robot controller 758 through interface 752a enabling the chip controller and reader to be controllably integrated into an automated laboratory environment. Microfluidic well plate assembly, 610, comprising a microfluidic chip according to aspects of the present teachings packaged in an industry standard microplate format, e.g., (FIGS. 33-37) designed to be compatible with industry standard physical conventions provides an interface 755b to standard laboratory robotics 759. An aspect of the present teachings is to intentionally provide compatibility with laboratory robotic standards enabling products made according to the present teachings to be readily used in conjunction with industry standard fluid dispensing, detection, and other robotics and automated processing equipment.

Communication between chip controller and reader 757 and pressure manifold 754 takes place via interface 755a. Manifold 775 is mechanically aligned and sealably mounted to packaged chip 610 and distributes the pneumatic, hydraulic, electronic, mechanical, or optical signals to and from the chip controller and reader 757 to their intended destinations on packaged chip 610. Manifold 777 configured to be structurally compatible with standard laboratory robotics 759 by conforming to applicable industry standards such as form factor, physical access, and compatibility with laboratory automation systems.

VII. Embodiments Having a Microscope Slide Format

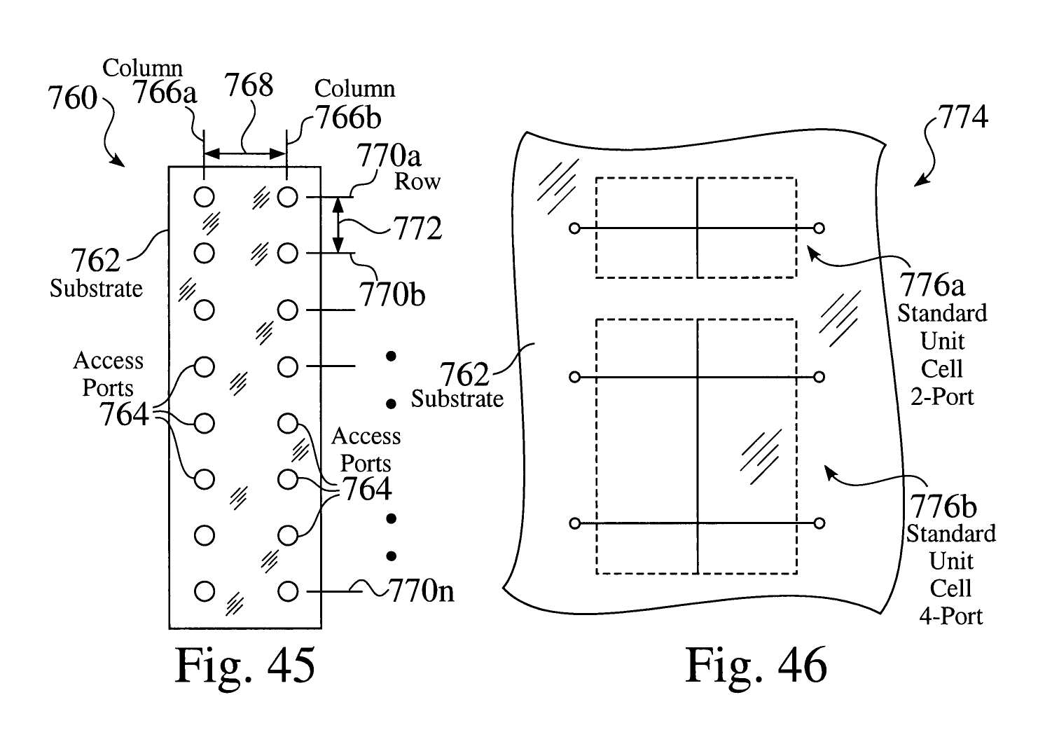

FIG. 45 is a plan view of a microscope slide sized substrate 760 having access ports 764 in standardized locations on substrate 762. Substrate 762 is configured as an exemplary standard nominal 25 mm by 75 mm microscope slide with access ports 770a-770m on a row pitch 772 corresponding to an industry standard microplate well pitch, preferably 9 millimeters for a 96 well plate, 4.5 millimeters for a 384 well plate, etc. Conformance to an industry standard microplate well pitch by row or along the long dimension of substrate 764 enables compatibility with multi-tipped fluid pipetters, pin tools, or automated dispensers or other standardized laboratory fluid handling equipment configured with linear microplate well spacing formats. Access ports 766a and 766b are shown with a column pitch 768. In a first embodiment, column pitch 768 is chosen for convenient use with standard 25 mm by 74 mm microscope slide substrate 762 and compatibility with fluid handling equipment configured with linear microplate well spacing formats. In a second embodiment, column pitch 762 is chosen to correspond to a standard microplate well pitch, e.g., 9 millimeters for a 96 well plate, 4.5 millimeters for a 384 well plate, etc. Conformance to an industry standard microplate well pitch by row and column or along the long and short dimensions of substrate 764 enhances compatibility with multi-tipped fluid pipetters, pin tools, or automated dispensers or other standardized laboratory fluid handling equipment configured in a partial microplate format.

FIG. 46 illustrates a cut-away plan view 774 of exemplary 2 port 776a and 4 port 776b standard unit cells having standardized access ports 764 located on substrate 762 with column spacing 768 and row spacing 772 as shown in FIG. 45. View 774 illustrates the idea of a standard unit cell that can be preferably designed to perform a specific function and then replicated and placed so as to mate with other standardized access port locations on substrate 762. In this example, there are two standard unit cells, 776a with two ports and the 776b with uses four ports illustrating that it is also possible to design microfluidic circuits with multiple standard unit cell types.

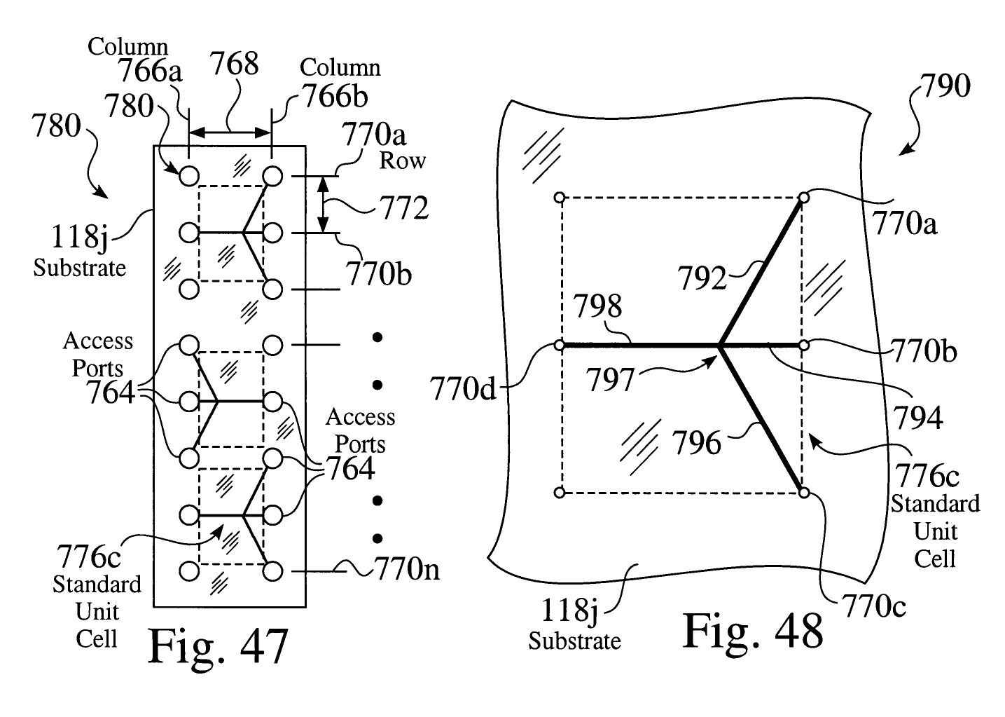

FIG. 47 is a plan view 780 of three replications of an exemplary unit cell 776c having three channels merging into one (a 3-1 combiner structure), which has been placed to optimally utilize the standard access ports locations of substrate 762 shown in FIG. 45. In view 780 of FIG. 47, substrate assembly 118j is fabricated with access ports and channels according to aspects of the present teachings and access ports in the standardized locations of substrate 762 in FIG. 45. One of the standard cells is flipped horizontally to better utilize the access ports. This enables the use of multi-tipped pipetters, pin tools, or other standardized laboratory equipment to deliver fluid to the assess ports.

FIG. 48 is an expanded view 790 of 3-1 combiner standard unit cell layout 776 which utilizes the standard access ports locations of substrate 762 shown in FIG. 45. View 790 shows substrate assembly 118j having standard unit cell 776d with a 3-1 combiner structure connected to standard access port locations from FIG. 45. Three input channels 792, 794, and 796 connected to standardized access ports 770a, 770b, and 770c, respectively, are combined at junction point 797 into one output channel 798 connected to standardized access port 770d. There are numerous uses for this structure in chemical, biochemical, and cellular assays.

VIII. Embodiments Having a Standard Well Plate Format

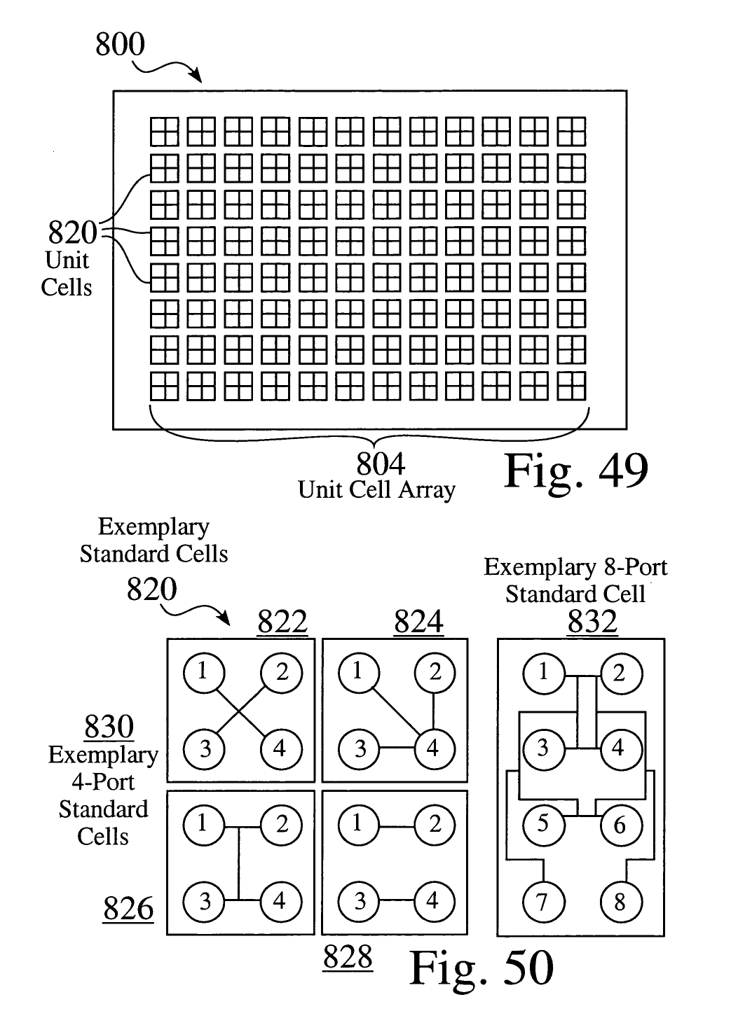

FIG. 49 shows a plan view 800 of an exemplary array 804 of standard unit cells 820 replicated 96 times in an 8 row by 12 column arrangement in an industry standard 384 well format, each unit cell having up to 4 access ports. It is possible to populate standard unit cell arrays for industry microplate formats with standard unit cells having a number of wells that are evenly divisible into the total number of wells in the a given microplate format. For example, the numbers of wells comprising standard unit cells in all microplate formats can include but are not limited to 2 wells, 4 wells, 8, wells, 16 wells, 32 wells, 64 wells, 96, 384 wells, etc.

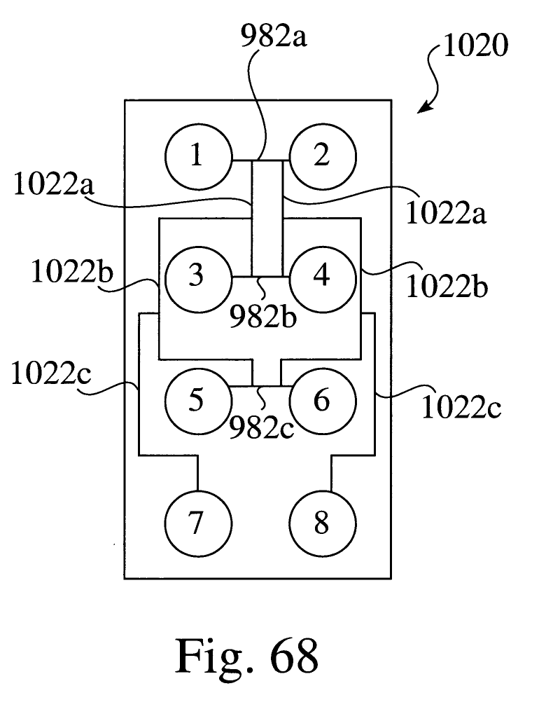

FIG. 50 is a view 820 of exemplary 4 port standard unit cells 830 and 8 port standard unit cell 832 each with alternative channel network configurations, any of which being suitable for placement into a standard unit cell array such as in view 800 shown in FIG. 49. Unit cell 822 has two intersecting channels from ports 1-4 and 2-3. Unit cell 824 has channels from ports 1, 2, and 3 to port 4. Unit cell is an H channel structure with channel connections between ports 1-2 and 3-4 and a bridge between 1-2 and 3-4. Unit cell 828 is comprised of two 2-port sub unit cells with channel connections between 1-2 and 3-4. Unit cell 832 is an 8 port unit cell with three H equivalent structures connected in parallel to allow distribution of a common reagent from wells 7 and 8 to assay regions within a portion of channels 1-2, 3-4, and 5-6. The operation of this structure is discussed in FIG. 68.

The well to well spacing or well pitch of the standard unit cells is designed to match industry standard microplate well pitches including but not limited to 96, 384, and 1536 well formats. External form factors and well pitch are designed to be consistent with industry standard microplate formats and packaging, e.g., 610a, 610b (FIG. 34-36), to enable microfluidic well plates according to aspects of the present teachings to be compatible with standardized fluid handling equipment.

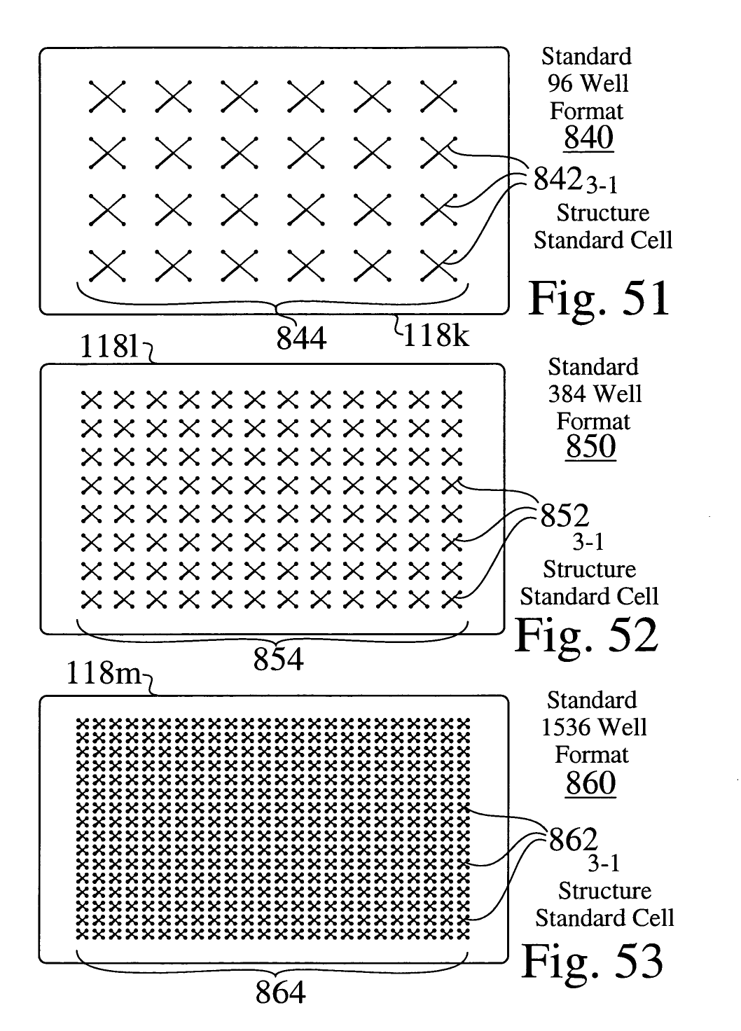

FIG. 51 illustrates a standard unit cell array of 4 port standard cells 844 in an industry standard 96 well format 840, array 844 comprising 24 repetitions in a 4 row by 8 column layout of unit cells comprising a 3-1 combiner structure fabricated in substrate assembly 118k.

FIG. 52 illustrates a standard unit cell array of 4 port standard cells 854 in an industry standard 384 well format 850, array 854 comprising 96 repetitions in an 8 row by 12 column layout of unit cells comprising a 3-1 combiner structure fabricated in substrate assembly 1181.

FIG. 53 illustrates a standard unit cell array of 4 port standard cells 864 in an industry standard 1536 well format 860, array 864 comprising 384 repetitions in a 16 row by 24 column layout of unit cells comprising a 3-1 combiner structure fabricated in substrate assembly 118m.

IX. Routing Embodiments

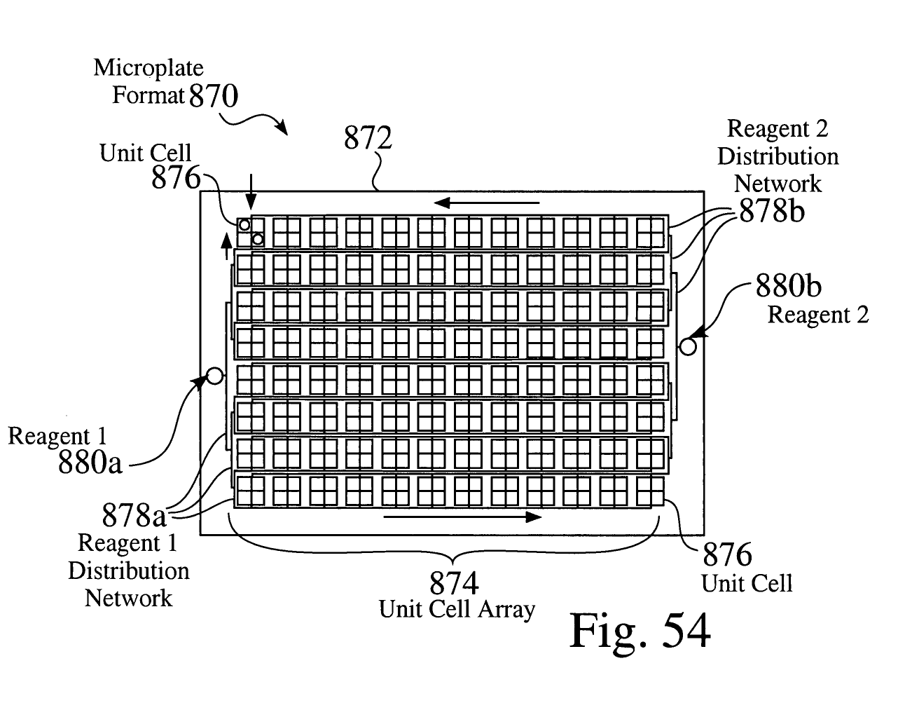

FIG. 54 is a plan view 870 of unit cell array 874 having exemplary routing networks 878a and 878b for distributing two common reagents 880a and 880b, respectively, to each site in exemplary array 874 of 96 standard unit cells 876 874 in an industry standard microplate format similar to the exemplary array 804 of unit cells 820 described in FIG. 49. Reagent 1 is distributed to the unit cells from left to right whereas reagent 2 is distributed from right to left. Offsetting the reagent routing lines allows access to every unit cell.

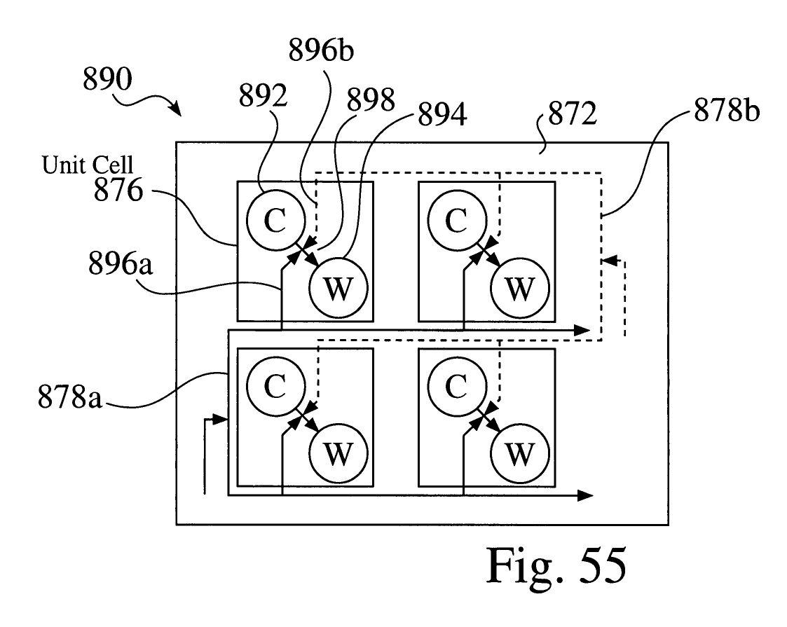

FIG. 55 is a partial expanded view 890 of the exemplary network of channels 878a and 878b shown in FIG. 54 for distributing two common reagents 880a and 880b, respectively, to exemplary standard unit cells 876 within a standard unit cell array (wherein test compound is denoted with “C”, and waste, “W”). Distribution networks 878a and 878b supply reagents 880a and 880b, respectively, to each unit cell in an array of four exemplary unit cells 876 each containing a 3-1 combiner structure. Unit cell 876 contains one well 892 for test compound and one well 894 for waste. Connector channels 896a and 986b couple reagents 880a and 880b into merge point 898 of standard unit cell 3-1 combiner structure 876 from reagent distribution networks 878a and 878b, respectively.

This layout demonstrates that global routing of two reagents can be accomplished by routing one reagent from the left side of the plate and one from the right side. The compound wells can be accessed with standard dispensing equipment since they are located on the standard well pitch and can be designed to hold volumes within the working range of conventional dispensers, i.e., 1-2 microliters. Waste wells are provided at each site to minimize back pressure although extra reagent wells could be include at each unit cell site.

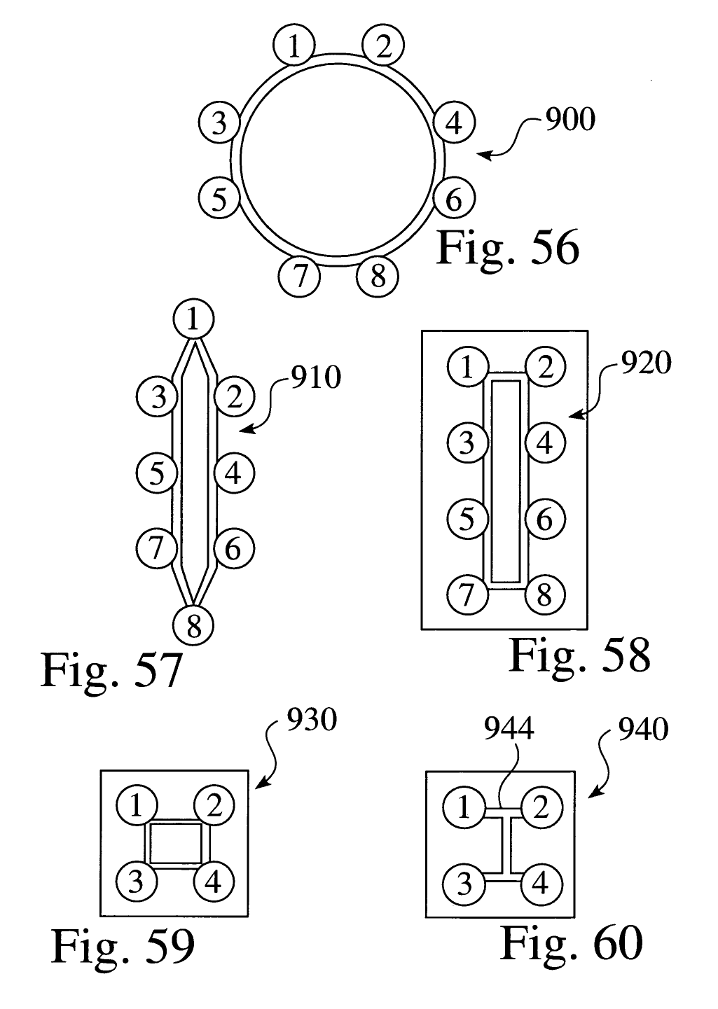

FIG. 56 illustrates an exemplary routing network 900 having a ring configuration for distribution of a common reagent within an 8 port standard unit cell. Using exemplary network 900, reagents such as biological cells, beads, particles and other substances used in chemical, biochemical, or biological assays can be distributed from a common source well to multiple destination wells by increasing the pressure in the source well relative to that of the destination wells.

FIG. 57 shows an exemplary linear channel network 910 within an 8 port standard unit cell that is functionally equivalent to the ring channel network of FIG. 56. Linear configuration 910 affords a perspective from which one can visualize how the amount of reagent distributed to each well of the unit cell from the source well can be controlled by controlling the pressure applied to each well by an external source. The fluid path from well 1 to well 8 is comprised of two parallel paths, one through wells 1-2-4-6-8 and the other through wells 1-3-5-7-8. All other parameters being equal such as channel fluid resistance as a function of channel length, a pressure applied to well 3 would be distributed equally along both parallel flow paths if an external pressure applied to each of the corresponding well pairs, 2-3, 4-5, and 6-7 were adjusted to a pressure at which the flow into the wells from the channels was zero. In this case flow in the channel would proceed from well 1 to well 8 with no flow into wells 2-7. Transport of substances from the channels to the wells would occur by diffusion only. Transport by diffusion could be utilized in numerous assays such as cell migration assays where it was desired to inject a very small and controllable amount of reagent thereby inducing a concentration gradient. By adjustment of the external pressure applied to each well, flow could be set to a range of desired levels including zero. Zero flow can be also accomplished by equalizing the fluid levels in all wells with no externally applied pressure. Utilizing controlled pressure at the destination wells, controlled distribution of reagents such as cells, beads, or particles from a common source well to a designated destination well could be accomplished.

FIG. 58 illustrates an 8 port standard unit cell 920 in a microplate format with a ring channel network. Configuration 920 is fluidically equivalent to configuration 910 of FIG. 57 and configuration 900 of FIG. 56 with the exception that the path length between all of the wells is not equal as drawn. However, the distances between wells can be equalized simply adding extra path length, for example, between channels 1-2 and 7-8 by inserting a serpentine cannel structure of the appropriate length. Configuration 920 with equal channel lengths is capable of providing the function of configuration 910 of FIG. 57 or configuration 900 of FIG. 56 and is also compatible when configured as an 8 port standard unit cell in industry standard microplate formats.

FIG. 59 shows a 4 port standard unit cell 930 in a microplate format with a ring channel network. Configuration 930 has the unique advantage that the all of the path lengths between adjacent wells are equal as drawn in FIG. 59 it is usable as a standard unit cell in an industry standard microplate format. In some embodiments of a cell migration assay, a common reagent such as a chemoattractant is dispensed into well 1. Cells are dispensed into wells 2 and 3 and allowed to attach to the surface. Test compounds 1 and 2 designed to target the biological target to be tested are then dispensed into wells 2 and 3 respectively. Pressure P1 is applied to well 1 and pressure P1/2 is applied to wells 2 and 3 insuring that no flow occurs between the channels and wells. Cell migration can then occur in the concentration gradient formed at the junction of the channels and wells 2 and 3. In configuration 930, the common reagent is used by two wells saving common reagent. If the same assay were carried out in configuration 910 in FIG. 57, one common reagent would be used by 6 wells providing even more savings. In some cases, cells and reagents may be initially dispensed into a single well and then distributed to the other test wells within each unit cell. Larger unit cells may provide higher utilization and larger savings in common reagents.

FIG. 60 shows a 4 port unit cell with an H channel network configuration 944 in a microplate format 940. Table 2 provides an exemplary protocol for loading cells into an assay region of the channel bridging channels 1-2 and 3-4 of H structure 940 and running a cell migration assay. The advantage of this cell migration assay configuration is that the gradient in the assay region of the bridging channel would remain constant during the assay. The protocol assumes the use of a multi-well pipetter compatible with industry standard microplate formats and therefore carries out each operation on all wells simultaneously. The exemplary protocol shown in table 2 below can be extended to accommodate other assays including but not limited to chemical, biochemical, and cellular assays with cells, beads, and other reagents.

TABLE 2
Cell migration assay protocol for use with the H structure 940 of FIG. 60.

| # | Step | Well 1 | Well 2 | Well 3 | Well 4 | Flow |
|---|---|---|---|---|---|---|
| 1 | Dispense media | (+) media | (+) media | (+) media | No-op | No |
| 2 | Prime, de-bubble | P(prime) | P(prime) | P(prime) | 0 | Yes |
| 3 | Remove media | (−) media | (−) media | (−) media | (−) media | No |
| 4 | Dispense cells | (+) cells | (+) media | (+) media | (+) media | No |
| 5 | Load cells | P1(load) | P2(load) | P3(load) | 0 | Yes |
| 6 | Remove cells | (−) cells | (−) media | (−) media | (−) media | No |
| 7 | Add media | (+) media | (+) media | (+) media | (+) media | No |
| 8 | Stop flow | P(stop) | P(stop) | P(stop) | P(stop) | No |
| 9 | Incubate | P(stop) | P(stop) | P(stop) | P(stop) | No |
| 10 | Remove media | (−) media | (−) media | (−) media | (−) media | No |
| 11 | Add compound | (+) cpd | (+) media | (+) media | (+) media | No |
| 12 | Load compound | P1(load) | P2(load) | P3(load) | (+) media | Yes |
| 13 | Incubate | P(stop) | P(stop) | P(stop) | P(stop) | No |
| 14 | Remove media | (−) media | (−) media | (−) media | (−) media | No |
| 15 | Add chemoattractant | (+) chemo + cpd | (+) media | (+) cpd | (+) media | No |
| 16 | Run assay | P(assay) | No-op | P(assay) | No-op | Yes |

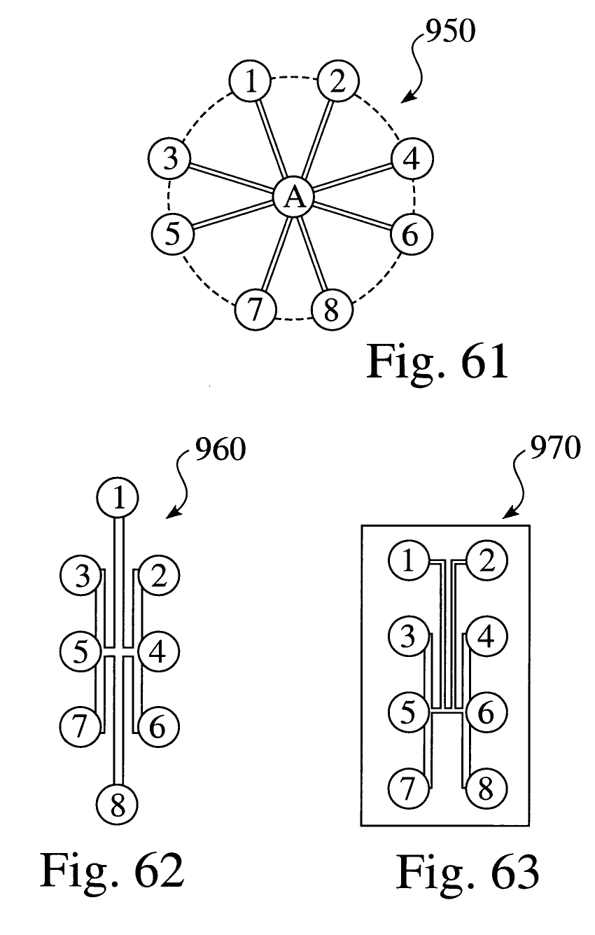

FIG. 61 shows a star channel network 950 for distribution of a common reagent from source well A to destination wells 1-8 within a multiple port standard unit cell. In star configuration 950, a common reagent such as cells, beads, or particles is dispensed to well A and pressure is applied causing fluid to flow from source well A to destination wells 1-8. An advantage of this configuration is that it is not necessary to apply external pressures to wells 1-6 to distribute reagents equally to all destination wells.

FIG. 62 illustrates a linear channel network 960 within an 8 multiple port standard unit cell with function equivalent to the star channel network 950 of FIG. 61. The fluidic resistance between wells 3-6 and the center point between well 1 and 8 can be designed to be equal by varying channel lengths, widths, and depths accordingly. The pressure at the mid position between well 1 and 8 can be controlled by controlling the pressures (positive or negative) applied to well 1 and well 8.

FIG. 63 shows a multiple port standard unit cell 970 in a microplate format with a star channel equivalent network. Configuration 970 is fluidically equivalent to configuration 960 and it is therefore compatible with use as an 8 port standard unit cell in microplate compatible formats.

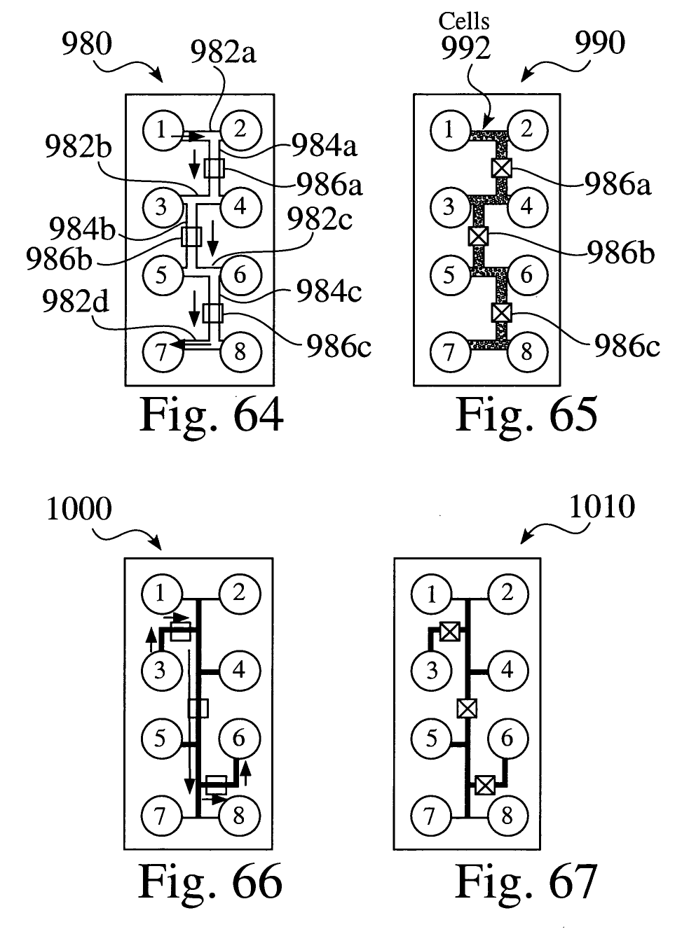

FIG. 64 illustrates an exemplary serial channel network 980 for distributing a common reagent to a plurality of single channel standard unit cells 982a-982d within an 8 port standard unit cell in an industry standard microplate format. Isolation valves 986a-986c shown in the open position allow a common reagent, including but not limited to cells, beads, or particles, to be dispensed into a common source well, in this case well 1. Flow, driven by a pressure applied to the source well through the network, and thereby distributes the common reagent to an assay region of each standard unit cell channel 982a-982d.

FIG. 65 shows exemplary standard unit cell 980 of FIG. 64 with the isolation valves 986a-986c in the closed position 990 and the common reagent, in this example cells, beads, or particles 992, distributed to and trapped within the assay region of each unit cell in the plurality of unit cells 982a-982d.

Table 3 provides an exemplary protocol for loading and distributing cells to an assay region of each standard unit cell channel 982a-982d of exemplary unit cell 980 and running a cell migration assay. The protocol assumes the use of a multi-well pipetter compatible with industry standard microplate formats and therefore carries out each operation on all wells simultaneously. The exemplary protocol shown in table 3 can be extended to accommodate other assays including but not limited to chemical, biochemical, and cellular assays with cells, beads, and other reagents.

TABLE 3
Cell migration assay protocol for serially linked structure 980 of FIG. 64.

| # | Step | Well 1 | Well 2 | Well 3 | Well 4 | Flow | Well 7 | Valve |
|---|---|---|---|---|---|---|---|---|
| 1 | Dispense media | (+) media | (+) media | (+) media | No-op | No | No-op | Open |
| 2 | Prime, de-bubble | P(prime) | P(prime) | P(prime) | 0 | Yes | 0 | Open |
| 3 | Remove media | (−) media | (−) media | (−) media | (−) media | No | (−) media | Open |
| 4 | Dispense cells | (+) cells | (+) media | (+) media | (+) media | No | (+) media | Open |
| 5 | Load cells | P1(load) | P2(load) | P3(load) | P4(load) | Yes | 0 | Open |
| 6 | Remove cells | (−) cells | (−) media | (−) media | (−) media | No | (−) media | Open |
| 7 | Add media | (+) media | (+) media | (+) media | (+) media | No | (+) media | Open |
| 8 | Stop flow | P(stop) | P(stop) | P(stop) | P(stop) | No | P(stop) | Close |
| 9 | Incubate | P(stop) | P(stop) | P(stop) | P(stop) | No | P(stop) | Close |
| 10 | Remove media | (−) media | (−) media | (−) media | (−) media | No | (−) media | Close |
| 11 | Add compound | (+) cpd | (+) media | (+) cpd | (+) media | No | (+) cpd | Close |
| 12 | Load compound | P1(load) | 0 | P3(load) | 0 | Yes | P7(load) | Close |
| 13 | Incubate | P(stop) | P(stop) | P(stop) | P(stop) | No | P(stop) | Close |
| 14 | Remove media | (−) media | (−) media | (−) media | (−) media | No | (−) media | Close |
| 15 | Add | (+) chemo + cpd | (+) cpd | (+) chemo + cpd | (+) cpd | No | (+) chemo + cpd | Close |
| | chemoattractant | | | | | | | |
| 16 | Run assay | P(assay) | No-op | P(assay) | No-op | Yes | P(assay) | Close |

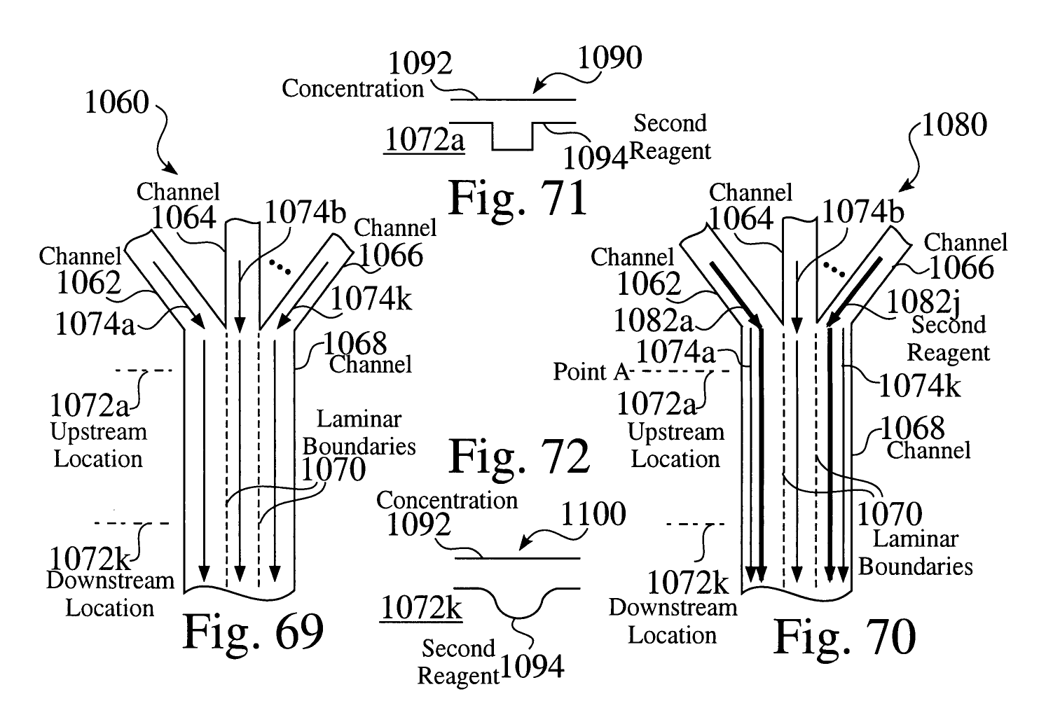

FIG. 66 illustrates an exemplary serial channel network 1000 for distributing a common reagent to multiple 2-1 channel unit cells within an 8 port standard unit cell in a microplate format. Isolation valves similar to valves 986a-896c of FIG. 64 are shown in the open position. The method of operation and assay protocol is similar to that of exemplary unit cells 980 and 990 of FIGS. 64 and 65 with the difference that the 2-1 unit cell configuration allows the formation of a gradient down the axis of the assay regions of the channels bridging wells 2-3 and 5-7, e.g., (FIG. 69-78).

FIG. 67 shows a plan view 1010 of the standard unit cell of FIG. 66, with the isolation valves in the closed position and a common reagent distributed to and trapped within the assay region of each 2-1 channel unit cell within an industry standard microplate format.

FIG. 68 illustrates an exemplary embodiment 1020 of a standard unit cell comprised of H equivalent structures with an integrated parallel network for distribution of a common reagent to the assay region of each of three unit cells within an 8 port standard unit cell in a microplate format. Common reagents are loaded into wells 7 or 8 and injected into assay region 982a-982c by the application of pressure between wells 7 and 8. The fluid resistance of devices 1-2, 3-4, and 5-6 and interconnect channels 1022a-1022c are designed so as to cause the fluid flowing in 1022c to split equally between devices 1-2, 3-4, and 5-6.

Table 4 provides an exemplary protocol for loading and distributing cells to an assay region of each standard unit cell channel 982a-982d of exemplary unit cell 1020 and running a cell migration assay. The protocol assumes the use of a multi-well pipetter compatible with industry standard microplate formats and therefore carries out each operation on all wells simultaneously. The exemplary protocol shown in table 4 can be extended to accommodate other assays including but not limited to chemical, biochemical, and cellular assays with cells, beads, and other reagents.

TABLE 4
Cell migration assay protocol for the H equivalent structure 1020 of FIG. 68.

| # | Step | Well 7 | Well 1 | Well 2 | Well 8 | Flow |
|---|---|---|---|---|---|---|
| 1 | Dispense media | (+) media | (+) media | (+) media | No-op | No |
| 2 | Prime, de-bubble | P7(prime) | P1(prime) | P2(prime) | 0 | Yes |
| 3 | Remove media | (−) media | (−) media | (−) media | (−) media | No |
| 4 | Dispense cells | (+) cells | (+) media | (+) media | (+) media | No |
| 5 | Load cells | P7(load) | P1(load) | P2(load) | 0 | Yes |
| 6 | Remove cells | (−) cells | (−) media | (−) media | (−) media | No |
| 7 | Add media | (+) media | (+) media | (+) media | (+) media | No |
| 8 | Stop flow | P(stop) | P(stop) | P(stop) | P(stop) | No |
| 9 | Incubate | P(stop) | P(stop) | P(stop) | P(stop) | No |
| 10 | Remove media | (−) media | (−) media | (−) media | (−) media | No |
| 11 | Add compound | (+) media | (+) cpd | (+) media | (+) media | No |
| 12 | Load compound | P7(load) | P1(load) | 0 | P8(load) | Yes |
| 13 | Incubate | P(stop) | P(stop) | P(stop) | P(stop) | No |
| 14 | Remove media | (−) media | (−) cpd | (−) media | (−) media | No |
| 15 | Add chemoattractant | No-op | (+) cpd | (+) chemo + cpd | No-op | No |
| 16 | Run assay | 0 | P(assay) | P(assay) | 0 | Yes |

TThe exemplary protocol shown in table 4 can be extended to accommodate other assays including but not limited to chemical, biochemical, and cellular assays with cells, beads, and other reagents.

Unit cells such as those depicted and explained in FIGS. 45-68 can be arranged, re-configured, and modified to implement a large variety of proffered embodiments to support many types of chemical, biochemical, and biological assays in industry standard microplate and microscope formats as well as in non-industry standard formats. The illustrative discussions provided herein should be construed not as limitations to the application of the present teachings but as means to convey an understanding of the potential utility and many other potential applications possible of the present teachings.

X. Applications

Embodiments of the present teachings can be applied in numerous fields including basic biological science, life science research, drug discovery and development, chemical and biological warfare agent detection, environmental monitoring, medical diagnostics, and personalized medicine as well as miniaturized chemical reactions such as DNA synthesis, protein synthesis, combinatorial chemistry, and general chemical synthesis.

There are several key needs in pharmaceutical drug discovery and development that drive the development of more efficient and powerful methods and tools for drug screening and testing. Methods and tools that provide highly relevant biological data are needed as early as possible in the discovery and development process to both eliminate drug candidates with inferior properties while identifying drug candidates with superior properties. Development and successful deployment of such methods and tools could ultimately provide lower failure rates of drug candidates in clinical trials, reduce the number of post market release drug withdrawals, and reduce the cost of adverse side effects of drugs on the market. The net result would be to reduce the cost and time to develop higher quality drugs for use in therapies and as cures for diseases.

Cellular assays are becoming increasingly used because cells can provide more comprehensive and relevant data compared to some biochemical assays. Assays on primary cells from animal or human tissue are desirable since responses obtained from actual healthy and diseased tissue provide the ultimate target for testing drug candidates. However, primary cells are in limited supply since cells from both living sources and cadavers are precious, scarce, and costly to obtain and maintain. The net result is that assays using primary cells are relatively expensive compared to cultured or clonal cell lines and yet there is a need to large numbers of assays with primary cells. In order for more primary cell assays to be done within constrained budgets there is a need to reduce the cost per primary cell assay. The present teachings may reduce the cost per primary cell assay by providing methods and tools for extracting more information from fewer cells compared to other assays known in the prior art.

Cellular assays (i.e., live cell assays) are assays in which living cells play an integral role in the detection of bio-molecular interactions between the cells under investigation and the surrounding extra cellular environment or a specific biomolecule, chemical, or toxin in the extra cellular environment. Bio-molecular interactions can be of numerous types including but not limited to ligand-receptor interactions, cell membrane interactions, protein-protein interactions, enzymatic interactions, nucleic acid interactions or nuclear receptor interactions. Live cell assays can involve the interactions between cells as readout devices with specific biomolecules as well as with other cells. In live cell assays, changes in cell observable properties can be detected in response to external stimuli or test drug additions. Chemicals in the extra cellular environment can interact with cells in many possible ways. Assays to detect the effects of chemicals in the extra cellular environment are generally designed to detect changes in cellular viability, vitality, structure, function, and responses. The present teachings may improve the quality of data and reduce the cost per cellular assay by providing methods and tools for extracting more information from fewer cells compared to other assays known in the prior art. The present teachings can be applied to cellular assays for the effects of chemicals or biomolecules in the extra cellular environment including but not limited to apoptosis, toxicity, metabolism, viability, vitality, function, motility, migration, proliferation, chemotaxis, cell-to-cell communication, cell signaling, ion channel flux, receptor activation or inhibition, gene expression, protein expression, receptor binding, transcriptional and translational binding, enzyme activity, protein-protein interaction, nucleic acid interaction, or combinations thereof. In addition, the present teachings can be applied to specialized “sensor” cell lines engineered to have specific readout mechanisms designed to detect the presence or effects of specific chemicals or classes of chemicals. In addition, many different observable properties can be detected using a variety of conventional detection schemes. The present teachings can accommodate detection schemes incorporating optical readouts including absorbance, transmission, reflectance, refractive index, luminescence, fluorescence intensity, fluorescence lifetime, fluorescence polarization, fluorescence anisotropy or equivalents, turbidity, color, grayscale, phase contrast, differential phase contrast, or physical readouts including absolute or relative position, velocity, acceleration, morphology, changes in cell function, morphology and the movement of cells across barriers including sieves, membranes and gels or equivalents, or electromagnetic readouts including electrical resistance, charge, conductance, capacitance, inductance, impedance, admittance, electric potential, chemical potential, electric field, magnetic field, or equivalents, or chemical or electrochemical readouts including redox potential, oxygen, carbon dioxide, nitrous oxide, pH, and combinations thereof. In addition, the present teachings as described above can be applied to non-cellular assays including chemical, biochemical, biophysical, and physical assays.

In biological and drug discovery research many different types of cell based assays are performed. However, cell based assays generally require that the cells are seeded into a test environment e.g., a microplate well and then are given time to adjust to their new environment. For example, adherent Chinese hamster ovary CHO cells require a re-adjustment time during which they attach to the surface of the wells and then form a confluent monolayer. This generally takes about 12-24 hours. Non-adherent cells can also be used in cell based assays and these types of cells also require time to adjust to a new environment. To produce high quality and reliable data, the types of cell based assays generally require that the cells used in the assay are healthy and function more or less as they would in their native environment throughout the assay. Assay times can range from a few hours to a few days. Therefore, cell based assays can require preparative and assay residence times of between a few hours and a few days.

The present teachings relate to cell based assays performed on cells confined to a microfluidic environment in contrast to cells in a micro plate well which are considered to be in a macro-fluidic environment. In a microfluidic environment, the dimensions of confinement are generally less than about 500-1,000 microns wherein micro plate environments (or macrofluidic environments) the dimensions of confinement are usually >than about 500-1,000 microns. For example, the linear dimensions of a 1536 well microplate are about 1.5 mm or 1,500 microns.

The present teachings may solve several problems encountered in cell based assays in macrofluidic environments and enables new types of assays to be performed. The present teachings may provide solutions to one or more of the following problems that are difficult to solve in macrofluidic environments.

Small population of cells (e.g., about 1-1000 cells) can be sequestered and independently assayed in a microfluidic assay region as compared to 10's of thousands of cells in macrofluidic environments.

Fluids can be delivered precisely to the cells to be assayed. Thus assay components and test compounds can be delivered at accurate concentrations and over precise time intervals.

Cells can be observed in-situ in a microfluidic device and changes in cell position or morphology can be easily determined relative to an initial starting condition, e.g., images can be taken before and after stimulation. In micro plates, for example, it is difficult to keep precise track of the location of individual cells for repeated observation whereas this is possible when cells are confined to a very specific area in a microfluidic chip.

By employing the physical properties of laminar flow and mixing by diffusion, standing concentration gradients of assay reagents can be established within an assay region of a microfluidic device according to aspects of the present teachings allowing either the direct observation of biological phenomena that respond to concentration gradients or the response of a chemical biological system to the range of concentrations covered by the concentration gradient within the assay region.

In some gradient assay embodiments, the fluid velocity in the assay region can be controlled in a “closed loop” mode by providing images of the gradient, e.g., via a fluorescent tracer as feedback to the flow controller to use to adjust the fluid velocity to obtain a desired spatial characteristic of the gradient, e.g., the profile along the length and or the cross section of the assay region.

The gas permeable membrane of aspects of the present teachings can provide an on-chip degasser/debubbler. The gas permeable membrane can allow bubbles to escape from the device both during priming and operation and it allows the gas level within the channels to be in diffusive communication and equilibrium with an external environment such as an incubation chamber or a gas manifold designed to supply test gasses to an assay region in the device. By enabling diffusive communication and rapid gas exchange between the contents of the channels, such as fluids and cells, rapid transport and equilibration of gas concentrations can be accomplished insuring adequate cellular respiration.

While impermeability to gas may not present a problem in some biochemical and cellular assays, certain other cellular assays can be enabled when gas exchange between the interior and exterior of the chip is enhanced by the use of a gas permeable material. Gas permeability ideally allows a path for gas to either enter or escape from fluids inside of microfluidics structures on the chip. The table below illustrates that a regime of operation exists for low or no flow conciliations in which the use of gas permeable materials to provide sufficient gas exchange will enhance or enable cellular assays wherein the cells are deriving the bulk of their energy from aerobic metabolism. Requirements for gas exchange to sustain optimal cellular function in a microfluidic environment depend on the flow rate of cell culture media which supports chemical nutrients and gas exchange and whether the cells are in a state of aerobic of glycolytic metabolism. The gas permeable membrane also enables CO₂ exchange between the cell culture media and the environment which is important to allow regulation of the pH of the cell culture media in a controlled CO₂ environment.

| Cell | | |
|---|---|---|
| metabolism | Low or no flow | High flow |
| Aerobic | On-chip gas exchange is | On-chip gas exchange not |
| (Oxidative) | required to keep cells | be required if fluid is |
| | alive | externally oxygenated |
| Non-Aerobic | On-chip gas exchange may | On-chip gas exchange not |
| (Glycolytic) | not be required | be required if fluid is |
| | | externally oxygenated |

Most cells in vivo obtain their metabolic energy primarily by respiration, a process that involves the consumption of oxygen. In standard cell-culture conditions, glycolytic (non-oxygen-consuming) activity is typically increased compared to the in-vivo state, perhaps due to the somewhat hypoxic conditions that usually hold in culture [Mandel, L. (1986) “Energy metabolism of cellular activation, growth, and transformation”, Curr. Topics Membr. Transport 27:261-291]. Nevertheless, aerobic metabolism continues to be vital in culture [Kemp, P., et al. (1990) “Carbohydrate and amino acid metabolism in the A10 vascular smooth muscle cell line”, Biochem. Soc. Trans. 18:661; Zielke, H., et al. (1984) “Glutamine: a major energy source for cultured mammalian cells”, Fed. Proc. 43:121-125].

A typical rate of oxygen consumption for a mammalian cell such as a fibroblast in culture is on the order of 10⁻¹⁶ moles O₂/s/cell [Huetter, E., et al. (2002) “Biphasic oxygen kinetics of cellular respiration and linear oxygen dependence of antimycin A inhibited oxygen consumption”, Mol. Biol. Resp. 29:83-87]. If there are about 10⁵ cells/cm² of culture surface at confluence, the oxygen consumption rate in culture is about 10⁻¹¹ moles/s/cm². A microfluidic channel that is 10 μm deep and contains fluid with 200 μM dissolved oxygen contains about 2·10⁻¹⁰ moles O₂/cm², enough to supply the needs of the cells for only about 200 s. A deep (100 μm) microfluidic channel could sustain the cells' oxidative needs for 2000 s. Both of these times are short relative to the typical times involved in culture for live-cell assays.

The presence of an oxygen-permeable membrane on the top of the microfluidic channel supplies the oxygen needs of such cells. For example, a membrane of grade 2400 Teflon AF™, oxygen permeability 990 Barrer units, 50 μm thick and subjected to an atmospheric partial-pressure difference of oxygen, passes about 1.4·10⁻⁹ moles O₂/s/cm², more than a hundred times the rate required by the cells.

In an alternative embodiment, a membrane with oxygen permeability of 1 Barrer unit, 50 μm thick and subjected to an atmospheric partial-pressure difference of oxygen, passes about 10⁻¹¹ moles O₂/s/cm2, which is about the rate required by the cells. The membranes typically employed have oxygen permeabilities >2 Barrer units and are thus adequate to supply the needs of a confluent cell layer. Calculations have shown that glucose levels in standard media are adequate to sustain cells during the stopped flow period. Once the flow is switched on, fresh media is continually flowed past the cells.

Embodiments of the present teachings can incorporate chips designed for cellular assays including apoptosis, toxicity, metabolism, viability, vitality, function, motility, migration, proliferation, chemotaxis, cell-to-cell communication, cell signaling, ion channel flux, receptor activation or inhibition, gene expression, protein expression, receptor binding, transcriptional and translational binding, enzyme activity, protein-protein interaction, nucleic acid interaction assays as well as any other assay that detects changes in cellular morphology or position in a microfluidic structure or combinations thereof. The use of a gas permeable membrane and biocompatible materials allows cells to be kept alive and in certain cases to grow for extended time periods ranging from hours to weeks or months. There are certain requirements to keep cells alive and in optimal culture conditions. These include: proper temperature, proper pH, oxygen, and carbon dioxide levels, proper nutrient levels and other media factors such as growth factors, electrolytes, etc. and removal of waste products such as lactic acid and carbon dioxide. As mentioned above, if the temperature and external gas levels are kept at proper levels, such as the case in an incubator, then a chip constructed with an integrated gas permeable membrane according to the present teachings will allow cells to thrive within the chip even in the case of low or no media flow as long as the need for nutrients and removal of waste is satisfied, for example during cell attachment or incubation. Furthermore, a chip constructed with an integrated gas permeable membrane according to the present teachings will allow cells to survive within the chip even in the case of no media flow at room temperature and ambient conditions for short time periods (i.e., the time required for dispensing cells or reagents, changing media, assay read out, etc.).

As mentioned previously, an additional function of the gas permeable membrane in a microfluidic device according to the present teachings is its ability to function as an integrated degasser/debubbler. Some examples are provided which illustrate the degassing and debubbling function of the gas permeable membrane according to the present teachings. Under certain conditions, gas can be present within a microfabricated structure at a supersaturated concentration. Given the proper conditions and enough time, bubbles will form. If the concentration gradient is favorable, and the permeability of the diffusive layer is high, gas evolving from a supersaturated solution will be dissipated into the extra-chip environment rather than forming bubbles within the microstructures. Solutions can become supersaturated by any of several ways. For example, reagents stored at cool temperatures will eventually equilibrate at relatively high gas concentrations compared to the saturation level within a chip at say, 37° C. After entering the chip and reaching 37 C, bubbles will quickly form unless the gas is removed prior to the fluid entering the chip. Another example would be gas evolving from solution as a result of a chemical or electrical chemical reaction within the chip. An example of the de-bubbling function is the ability to remove bubbles introduced into a flow channel during loading or unloading fluids or when the chip is attached or removed from a fluid control fixture. Bubbles introduced into the fluid wells or flow stream will be forced out of the chip as soon as external pressure is applied.

In some embodiment, the cell cultures are frozen in a format that is ready for testing upon thawing of the cells. See, e.g., U.S. Pat. Nos. 6,472,206 and 6,461,645, each of which is incorporated by reference in its entirety for all purposes. For example, the cells may be frozen on coverslips placed within vials (i.e., shell vials). In these embodiments, the cells are frozen on a glass substrate without the need for pre-starvation or any special handling of the cells prior to freezing. In addition, the cells do not require any special handling during thawing or use. In another embodiment, gametes from genetically engineered cells are used.

In alternate or additional embodiments, the cells may not be frozen but held at a lower temperature that would cause the cells to enter into a state of stasis. Chips containing frozen cells or cells in stasis can be suitably packaged so as to be archived at the factory or transported to their final users and where they can be stored and eventually thawed and used for assays without the need to load cells into the chip. Frozen chips can be used for sample archival and ultimately for screening, life science research, personalized medicine including therapy optimization, genotyping, and gene expression, and other medical diagnostics applications.

Devices of the teachings are readily applicable for assays related to chemotaxis, cell proliferation, apoptosis, fluorescence polarization (ligand binding), and high content imaging. For such applications, the channel depth should be such as to accommodate transport of cells in suspension and should be deep enough to supply adequate numbers of cells for attachment and to provide space for the formation of stable gradients in the case of gradient assays. For example, channels of about 10 microns or deeper can be used for neutrophils; about 25 microns or deeper for mammalian cells; whereas for fungi and bacterial are generally smaller in size and thus may be usable with channels less then 10 microns.

In some cellular assay embodiments, the channel depth and width are preferably optimized for the cell type to be assayed including such parameters as cell diameter when in suspension and cell height when attached in a channel as well as the density of suspended cells loaded into the channels.

In some gradient assay embodiments, the concentration range and rate of change in concentration per unit length of the gradient is preferably selected to provide a optimal conditions for a particular assay, e.g., a specified attached cell diameter and height for a given cell type and to provide a dynamic range, i.e., minimum and maximum concentrations, and rate of change of concentration with respect to distance compatible with the distribution of cells within the assay region.

In some gradient assay embodiments, wherein a reagent having a high diffusion coefficient is used to generate a gradient, it is preferable to use a relatively higher fluid velocity to provide an assay region with a size compatible with imaging on a CCD camera.

In some gradient assay embodiments, wherein a reagent having a low diffusion coefficient is used to generate a gradient, it is preferable to use a relatively lower fluid velocity to provide an assay region with a size compatible with imaging on a CCD camera.

FIG. 69 shows an exemplary 3-1 combiner structure 1060 wherein each of the three feeder channels 1062, 1064, and 1066 carries a first common reagent 1074a, 1074b, and 1074k, respectively. The structure is not limited to three feeder channels. The three feeder channels 1062, 1064, and 1066 then merge into a single main channel 1068. Dotted lines 1070 indicate the boundaries between the laminar flow streams after the merger which do not mix other than by diffusion. The concentration of common reagent 1074 is constant across the channel and is independent of position in the channel. For typical flow velocities and channel dimensions (in the range of 1 microns to 1000 microns in width and depth), Reynolds numbers are low and flow patterns are laminar. In laminar flow, by definition, there is no turbulence and mixing is governed by diffusion which occurs during the transit time in the channel. The rate of diffusion is determined by the diffusion coefficient of the diffusing species in the solute, typically water in most biological applications. The diffusion coefficient is linearly dependent on the radius of the diffusing species (i.e., the size of the molecule or particle) and the inversely dependent on the viscosity of the solute.

FIG. 70 shows the structure 1080 of FIG. 69, wherein each of three channels 1062, 1064, and 1066 carries a common first reagent 1074. The three feeder channels 1062, 1064, and 1066 then merge into a single main channel 1068. Dotted lines 1070 indicate the boundaries between the laminar flow streams after the merger which do not mix other than by diffusion. A second reagent 1082 is added to the outer channels causing a standing concentration gradient to form in the main channel 1068 as second reagent 1082 diffuses across flow boundary lines 1070 towards the center of the channel.

FIG. 71 shows a plot 1090 of the concentrations of first reagent 1062 and second reagent 1082 as a function of distance across the channel in structure 1080 of FIG. 70 at an upstream location in the main channel 1072a relative to the merge point of channels 1062, 1064, and 1066.

FIG. 72 shows a plot 1100 of the concentration of first reagent 1062 and second reagent 1084 in structure 1080 of FIG. 70 at a downstream location in the main channel 1072k relative to the merge point of channels 1062, 1064, and 1066. Since mixing occurs only by diffusion across flow boundaries 1070, concentration profile 1094 of second reagent 1082 exhibits a steep gradient at upstream location 1072a whereas at location 1072k second reagent 1082 has diffused across flow boundaries 1070 and into the central region of channel 1068 exhibiting a shallower concentration gradient 1094. The extent to which second reagent 1082 diffuses into the central region depends on a balance between the flow rate, the channel width, and the diffusion coefficient of the second reagent. For example, if the second reagent is a large protein, it will diffuse slowly and the gradient will remain steep until many seconds of transit have passed (i.e., a long channel and or low flow velocity will be required to provide the time required for significant diffusion to take place). It is useful to note that diffusion rate depends linearly on the molecule size and the flow rate but has a square law dependence on the channel width. Diffusion coefficients range from 10⁻⁵ cm²/second for small molecules to 10⁻⁷ cm²/second for large bio-molecules to 10⁻¹⁰ cm²/second for cells. Computer simulations of diffusion under representative operating conditions and geometries have been carried out and have been found to correlate well with results obtained with actual gradients observed using fluorescein as a fluorescent tracer in a fabricated device. Images of the gradients in channels were recorded with a CCD camera through a fluorescence microscope and were found to correlate well with the simulation results.

FIG. 73 shows a plan view 1110 of a 3-1 combiner structure similar to that of FIG. 69 wherein each of the three channels 1062, 1064, and 1066 carries a common reagent 1074 and cells 1112 have been loaded into assay region 1114 in main channel 1068. In this embodiment, cells 1112 (e.g., neutrophils) are introduced into main channel 1068 and allowed to attach to the channel walls. Drawing on the principles illustrated in the previous figure, after the introduction of second reagent, e.g., a chemo-attractant, into outer channels 1074a and 1074k, a gradient in concentration the chemo-attractant will form between the outer regions 1118a and the central region 1116 of channel 1068 downstream from the junction of channels 1074a, 1074b, and 1074k, and along the channel between locations 1072a and 1072k as illustrated in FIGS. 71 and 72. The gradient from the center 1116 to the edge 1118a of the channel decreases in slope as the downstream distance from the junction increases. The precise shape of the concentration gradient and location of along the channel of point depends on the diffusion coefficient of the chemo-attractant and the flow rate, and the channel width.

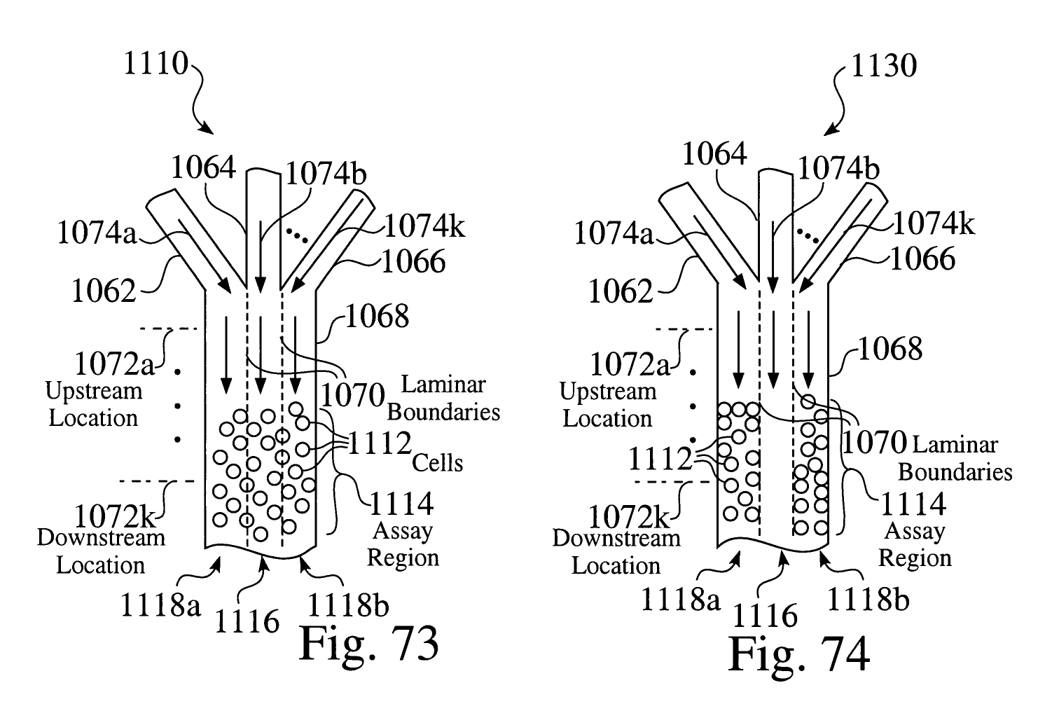

FIG. 74 shows a plan view 1130 of the 3-1 combiner structure of FIG. 73 wherein a second reagent, i.e., a chemoattractant, has been added to the outer channels causing the cells to migrate in response to the concentration gradient of the second reagent from outer regions 1118a to center region 1116 formed along main channel 1068. Cells 1112 that respond to chemo-tactic agents such as neutrophils migrate in the direction of the increasing chemo-attractant concentration. Images of the relative cell positions taken at intervals after stimulation with the chemo-attractant can provide a kinetic readout of cell migration which is difficult to obtain with the methods of the prior art. Images can be compared with one an other using computer algorithms to quantitative the changes in physical position. For example, autocorrelation algorithms can be used to provide a quantitative indication of the extent to which cells have moved from the initial positions even if the movement is small. Also, since the concentration gradient decreases in steepness with increasing distance from the 3-1 junction, this assay provides quantitative information on the relationship of cell migration characteristics to the magnitude of the concentration gradient. Since in assay region 1112 of channel 1068 cells can be individually imaged and observed, in some embodiments, the responses of cells could be quantified and graded to provide additional information on the behavior of individuals within a population of cells. Specific reagents, such as stains, protein and nucleic acid binding probes, and the like could be added to detect certain properties of cells such as expression (or lack thereof) of specific proteins or signaling molecules to sub-type a population of cells subjected to a particular reagent protocol For example, CHO (Chinese Hamster Ovary cells) were loaded into in a chip fabricated according to aspects of the present teachings comprising a 3-1 combiner similar to structure 1110 of FIG. 73. A chip containing the cells was incubated for 24 hours at 37° C. and then removed from the incubator and subjected to a Trypan Blue uptake assay. The cells in the 3-1 combiner were deemed to have passed the Trypan Blue uptake assay, i.e., (negligible update of Trypan Blue).

In a gradient assay embodiment, a uniform “lawn” or monolayer of cells 1112 is attached within channel 1068 and a uniform, unperturbed gradient is formed over the uniform lawn of cells within assay region 1114.

In an alternate gradient assay embodiment, the cells are deposited and attached within channel 1068 either in a sparse monolayer or in small clumps within assay region 1114 and preferably, the attached height of the cells or small clumps of cells is less than about one half of the channel depth so as to provide enough overhead space within the channel for a standing gradient to be minimally perturbed by the presence of the cells.

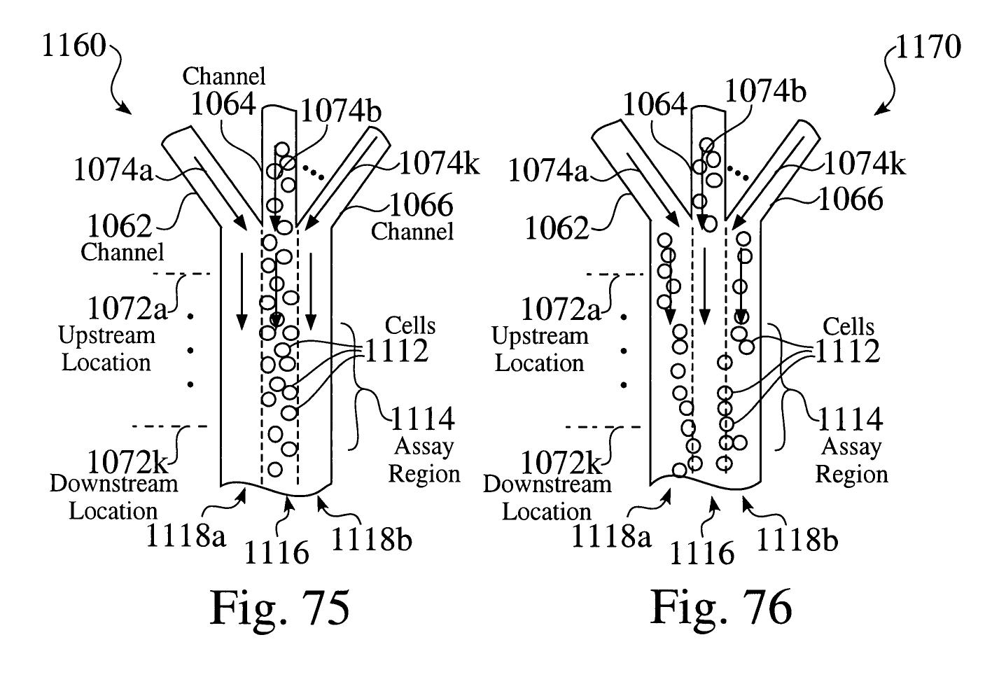

FIG. 75 illustrates an exemplary method for loading cells 1112 into main channel 1066 from the center channel 1064 of the 3-1 combiner structure 1160. In this embodiment, cells (e.g., neutrophils) are introduced from center channel 1064. It is assumed that all channels terminate at access ports to which appropriate pressures are applied to cause the desired flows to occur. Because the diffusion coefficient of cells is very small compared to the diffusion coefficient of most anticipated chemo-attractant molecules, the cells will be expected to remain in their flow stream for extended time periods regardless of whether or not the cells are flowing in the stream or stopped. If the flow is stopped, gravity will cause the cells settle to the bottom of the channel where they will attach to the channel floor. The unassisted settling time should be only a few seconds if the cells are denser than the medium as is common in practice.

FIG. 76 shows a plan view 1170 of the 3-1 combiner structure of FIG. 75 wherein a second reagent has been added to the outer channels 1062 and 1066. In analogous fashion to the embodiment in FIG. 74, after the chemo-attractant is introduced to channel 1066 in structure 1170, a concentration gradient of the chemo-attractant will form between the outer regions 1118b and the central region 1116 of the channel downstream of the 3-1 junction at locations 1072a through 1072k along the channel. The gradient from the center region 1116 to outer regions 1188 decreases in slope as the distance from the 3-1 junction increases. The precise shape of the concentration gradient will depend on the diffusion coefficient of the chemo-attractant and the flow rate, and the channel width. Cells that respond to chemo-tactic agents such as neutrophils will then migrate in the direction of the increasing chemo-attractant concentration. Images of the relative cell positions taken at intervals after stimulation with the chemo-attractant will provide a kinetic read out of the migration of the cells. Images can be compared with one an other using computer algorithms to quantitative the changes in physical position. For example, autocorrelation algorithms can be used to provide a quantitative indication of the extent to which cells have moved from the initial positions even if the movement is small. Also, since the concentration gradient will decrease in steepness with increasing distance from the 3-1 junction this assay will also provide quantitative information on the relationship of the rate of cell migration to the magnitude of the concentration gradient.

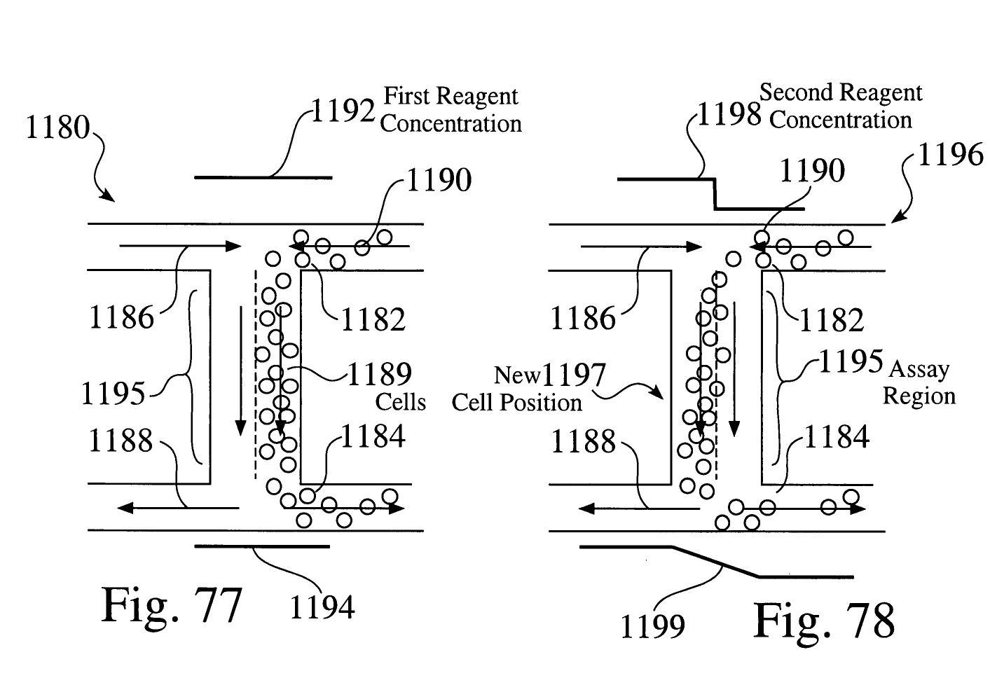

FIG. 77 illustrates an exemplary method for loading cells 1189 into the assay region of H structure 1180 from one of the side branch channels 1182. In this embodiment, cells 1190 (e.g., neutrophils) are introduced into channel 1182. A first reagent e.g., culture media is introduced into both channel 1182 and 1186 and therefore the concentration of the first reagent is flat across the channel in the assay region 1195. It is assumed that all channels terminate at access ports to which appropriate pressures are applied to cause the desired flows to occur.

Because the diffusion coefficient of cells is very small compared to the diffusion coefficient of most anticipated chemo-attractant molecules, the cells will remain in their flow stream for many hours regardless of whether or not the cells are flowing in the stream or stopped. If the flow is stopped, gravity will cause the cells settle to the bottom of the channel where they will attach to the channel floor within about a few minutes to about a few hours.

FIG. 78 shows the 3-1 combiner structure 1196 of FIG. 77 wherein a second reagent has been added to channel 1186. After introduction of a second reagent, e.g., chemo-attractant, a steeply sloped chemical gradient of the chemo-attractant 1198 will form in the central region of the channel slightly downstream from the “T” junction formed by the intersection of channels 1186 and 1182. The gradient decreases in slope as the distance away from the T junction increases to resemble the shallow profile 1199 near the downstream T junction. The precise shape of the concentration gradient in assay region 1195 along the central bridging channel depends on the diffusion coefficient of the chemo-attractant, the fluid flow rate, the channel width and depth. Cells 1190 responding to a concentration gradient of a chemoattractant migrate within assay region 1195 from starting position 1189 to a new position 1197 in the direction of the increasing chemo-attractant concentration after the passage of time. Images of the relative cell positions taken at intervals after stimulation with the chemo-attractant will provide a kinetic read out of the migration of the cells. Images can be compared with one an other using computer algorithms to quantitative the changes in physical position. For example, autocorrelation algorithms can be used to provide a quantitative indication of the extent to which cells have moved from the initial positions even if the movement is small. Also, since the concentration gradient will decrease in steepness with increasing distance from the 3-1 junction this assay will also provide quantitative information on the relationship of the rate of cell migration to the magnitude of the concentration gradient.

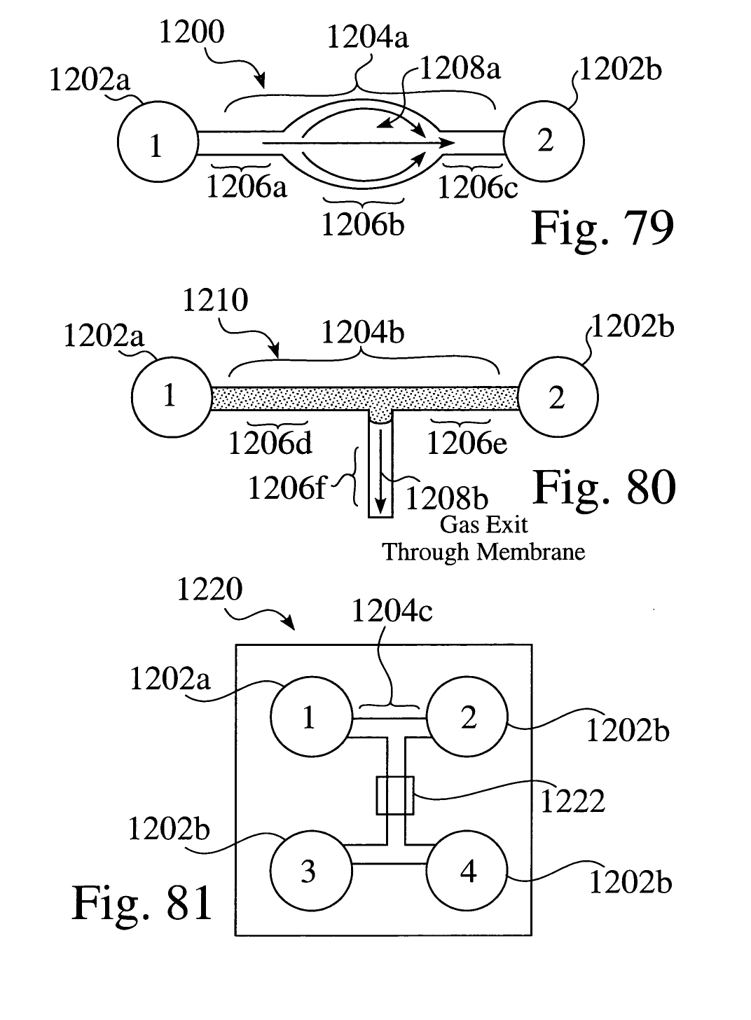

FIG. 79 shows a plan view 1200 of an exemplary embodiment of a perfusion chamber 1206b with a shape designed to efficiently perfuse and/or purge assay region 1208a in a microfluidic perfusion chamber 1204a comprised of inlet port 1202a, channel section 1206a, perfusion chamber 1206b, channel section 1206c, and outlet port 1202b. A key feature of perfusion chamber section 1206b is that the walls of the chamber are shaped to be parallel to equipotential lines in the fluid flow field thus minimizing the fluidic resistance of the chamber and the time to purge the chamber when switching from one reagent to another.

In an alternative embodiment, mechanically activated valves would be positioned over the mid points of channel sections 1206a and 1206b of perfusion structure 1200 by suitable mounting and positioning of external mechanical actuators similar to actuator 234 of FIGS. 9-11. With the valves in the open position, fluid is flowed through the perfusion chamber carrying with it a chosen reagent such as cells, beads, particles, bio-molecules, chemicals and the like until the chamber if purged and filled with fluid. Both valves are then closed and the fluid trapped between the valves the chamber 1208a is allowed to evaporate through the membrane taking advantage of the fact that gas permeable membranes such as those used preferably to build chips according to aspects of the present teachings are also permeable to water vapor and other volatile dissolved components but not permeable to large molecules, cells, beads, and the like. As the fluid evaporates through the membranes with the channel sections 1206a and 1206b, the membrane collapses trapping the contents of the channel between the membrane and the channel surface.

There are numerous potential uses for the embodiment evaporative trapping device described above including but not limited to the archival of cells and bio-molecules as well as the creation of handling and storage devices and systems for nano-particles, sensor molecules, fluorescent and absorbent dyes and the like. Further by combining the inherent accuracy and precision of the processes used to fabricate the channels with the ability to trap small sized substances therein, it is possible to create specific shaped chambers for trapping arrays of beads, cells or other substances within the chamber for use as physical, spectroscopic, and chemical, and biochemical reference and calibration standards. If the concentration of the substance to be trapped is known, then the number of trapped items in the chamber can be calculated by multiplying the volume of the chamber by the concentration of the items to be trapped giving the number of items to be trapped. If the concentration is precisely known as is the case with standards such as beads or cells that have been counted, it is possible to predict the number of particles that will be trapped within the chamber.

FIG. 80 shows a plan view 1210 of an exemplary dead-end channel 1206f between channel sections 1206d and 1206e along main channel 1204b extending between access port 1202a and 1202b. Dead-end channel 1206f is inefficiently purged by the flow in the main channel and therefore gas is trapped within dead-end channel 1206f as shown in FIG. 80 unless pressure is applied to both access ports 1202a and 1202b and the gas in dead-end channel 1206f is forced to exit through a gas permeable membrane above dead-end channel 1206f, e.g., (FIG. 6).

An embodiment of structure 1210 provides a method for loading cells or other reagents into one of the access ports and trapping the cells or other reagent in dead-end channel section 1206f. In one method, cells are first flowed through channel 1204b from access port 1202a to 1202b thus filling channel section 1204b with cells. Next, pressure in the range of 2-10 psi is applied to both access ports 1202a and 1202b causing dead-end channel section 1206f to fill with fluid containing cells and/or other reagents. When normal flow is reestablished in channel 1204b, by applying pressure between access ports 1202a and 1202b, dead-end channel 1206f is inefficiently purged, or bypassed by flow through channel section 1204b allowing the trapped cells or other reagents to reside in dead end channel 1206f. The relatively low purging efficiency of dead-end channel 1206f having a long and thin shape can be understood intuitively by comparison to the high relative purging efficiency of perfusion chamber 1200 having a streamlined oval shape.

In an alternate embodiment, a small hole or potentially a plurality of holes are fabricated near the end of channel section 1206f opposite main channel section 1204b to allow gas to escape at a higher rate than would occur by gas permeation through the membrane alone. In some assays, with cells for example, it may be desirable to fill the dead-end quickly relatively to the settling rate of the cells. Thus, the technique may involve using of holes with a diameter small enough to allow gas but not fluid to escape. The diameter chosen for the hole should be large enough to allow sufficient gas to escape to achieve the desired filling rate and small enough to prevent fluid flow by maintaining the surface tension barrier provided by a small hole in the hydrophilic membrane. Holes in the range of a few microns in diameter up to tens of microns in diameter can be economically fabricated with laser or photolithography based tools. Holes of tens of microns and larger can be fabricated my mechanical tooling methods.

This method can be used to trap cells for use in assays including but not limited to cell migration assays wherein, after the cells are trapped and attach to the surface of channel 1206f, a concentration gradient of a chemoattractant is established near the intersection of dead-end channel 1206f and channel section 1204b in the presence of cells trapped in the dead-end channel. Chemoattractant is preferably dispensed into one of the access ports and flowed through channel section 1204b by the application of a pressure differential between the two access ports. This method of trapping cells in a dead-end channel can also be sued to other substances including but not limited to non-adherent cells, beads, particles, fluorescent dyes, biomolecules of all kinds for use in various applications and assays in a manner distinctly different from the use of size filters or sieve methods used in the prior art.

FIG. 81 shows a plan view 1220 of an exemplary standard unit cell with an H structure configuration having a valve 1222 located at the center region of the H bridge channel. With valve 1222 in the closed position, the structure is equivalent to two of the structures shown in FIG. 80 since 1204c can be seen to have a first dead-end channel intersecting a main channel extending between ports 1 and 2 and a second dead-end channel intersecting a main channel extending between ports 3 and 4. This structure can be used to perform assays in ways similar to the embodiments of FIGS. 64 through 67 where cells, beads, or other particles are first flowed through the H structure and then valve 1222 is closed creating two dead-end channels which entrap the contents of the fluid. It is useful to point out that the diffusion coefficient of cells and large molecules and beads is very small forcing these particles to remain virtually suspended in position affected primarily by gravitational forces and shear forces of fluid flowing in the main channel.

FIG. 82 shows a plan view 1230 of an exemplary method of loading cells 1231 into an H structure from a side branch 1232, the H structure having a valve 1235 in a central region to trap the cells. Beads, particles, nano-particles, or other substances could readily be substituted for the cells used in this example. Cells 1231 are flowed through feeder channel 1232 with the flow being split equally between channels 1234 and the bridge of the H structure past valve 1235 the flow then splitting again between exit channels 1236 and 1238. It is assumed that all channels terminate at access ports to which appropriate pressures are applied to cause the desired flows to occur.

FIG. 83 shows a plan view 1240 of the H structure of FIG. 82 with valve 1235 closed and the cells 1231 trapped within assay regions 1240a and 1240b of the two dead-end channels created by the closed valve.

FIG. 84 shows a plan view 1250 of the structure of FIG. 83 after continued flow has washed away the not trapped in the assay regions 1242b of the dead-end channels.

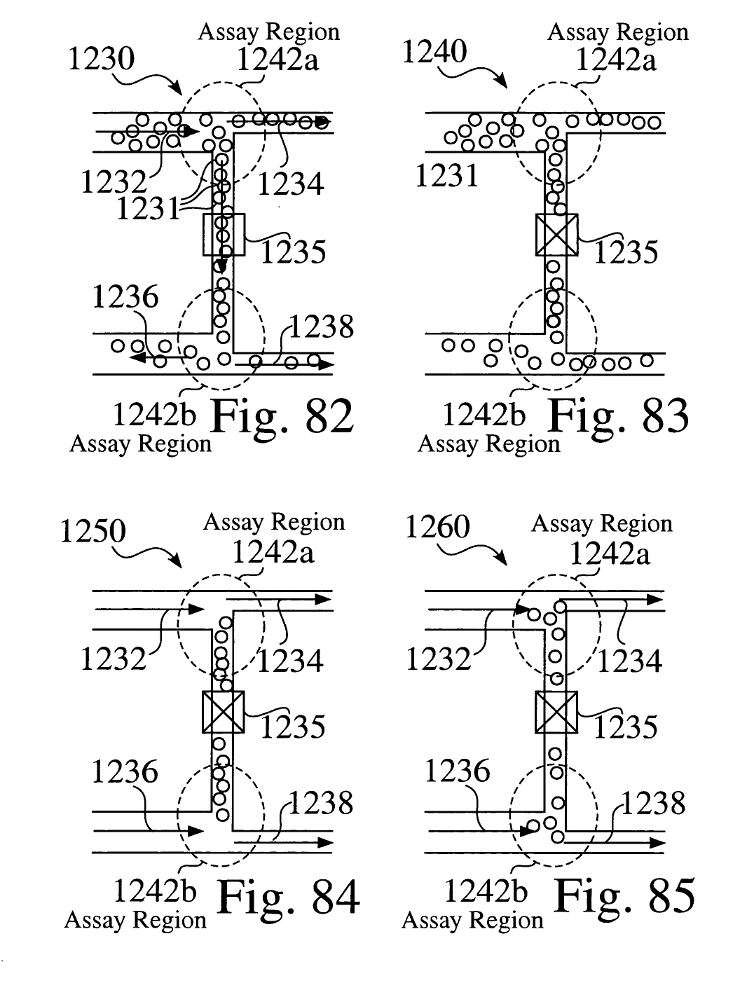

FIG. 85 shows a plan view 1260 of structure of FIG. 84 after performing an assay, wherein a second reagent is added, e.g., a chemoattractant which causes the trapped cells to migrate from their initial positions within assay regions 1242a and 1242b into new positions extending further into the main channel by following the chemoattractant concentration gradient extending between the dead-end channel and the main channel. In a first example of an alternate embodiment, after re-opening valve 1235, the cells could be replenished and the assay repeated. In second alternate embodiment, a sequence of reagents could be flowed over the cells after they became adhered within the dead-end channel. In a third alternate embodiment, using non-adherent cells and a dead end channel designed with the proper shape aspect ratio to accommodate the desired cell type, it is possible to dose the non-adherent cells trapped in the dead-end channel with test reagents by flowing test reagents in the main channel past the junction of the dead-end channel. This structure could be used to implement many other functions which could be used in various types of chemical, biochemical, and cellular assays.

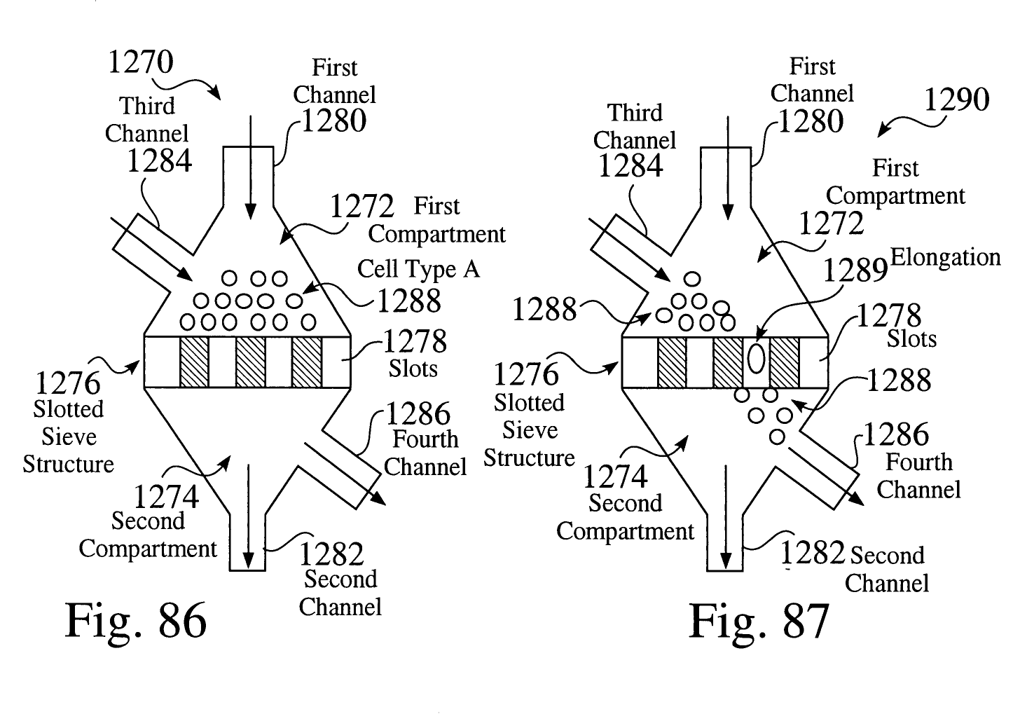

FIG. 86 shows an exemplary embodiment 1270 of a two compartment device wherein cell type A 1288 are loaded into a first compartment 1272 through a first channel 1280. A slotted sieve structure 1276 separates a first compartment 1272 and a second compartment 1274. It is assumed that all channels terminate at access ports to which appropriate pressures are applied to cause the desired flows to occur. A first cell type A 1288 is introduced into compartment 1272 by way of flow through first channel 1280 and third channel 1284. The sieve is fabricated by etching slots 1278 into the top of the wall between first compartments 1272 and second compartment 1274. The depth of the slots is chosen to be slightly smaller than the nominal diameter of cell type A.

FIG. 87 shows a plan view 1290 of the two compartment device of FIG. 86 after the introduction of a reagent that induces cell migration from the first compartment 1272 into the second compartment 1278. Once the cells are trapped, and stabilized in first compartment 1272, chemo-attractant is introduced by flow through first channel 1284 and fourth channel 1286. The introduction of the chemo-attractant through channel 1284 (or alternately channel 1280) causes a concentration gradient between regions of first compartment 1272 and second compartment 1274 and initiates the migration of cells under the influence of the concentration gradient between the two chambers. Note that the cells assume an elongated shape 1289 as they squeeze through the physical restriction in the sieve. This is similar to their actual environment wherein they elongate and pass through tissue on their way to their final destination. Concentration gradients can be controlled by the magnitude of the flow rates in channels 1280, 1282, 1284, and 1286. As in the previous embodiment, images of the relative cell positions observed at intervals after stimulation with the chemo-attractant will provide a kinetic read out of the migration of the cells. Images can be compared with one an other using computer algorithms to quantitative the changes in physical position. For example, autocorrelation algorithms can be used to provide a quantitative indication of the extent to which cells have moved from the initial positions even if the movement is small.

In an exemplary alternate embodiment, a second cell type B is introduced into second compartment 1274 by way of channels 1282 and 1286. Once the cells are trapped, and stabilized, a chemical stimulant is then introduced by flow through channel 1284 and channel 1286. The introduction of the stimulant causes a concentration gradient between first compartment 1272 and second compartment 1274 whereas introduction of stimulant through channels 1284 and 1280 in first compartment 1272 and/or channels 1282 and 1286 in second compartment 1274 allow the possibility of stimulating the cells in first compartment 1272, second compartment 1274 or both compartments. Concentration gradients can be controlled by the magnitude of the flow rates in channels 1280, 1282, 1284, and 1286. In this embodiment, it is possible to study the interactions of more than one cell type and the effects of more than one substance on the two cell types individually or in combination. As in the previous embodiment, images of the relative cell positions or morphologies taken at intervals after stimulation with the chemo-attractant will provide a kinetic read out of the migration or morphological changes of the cells. Fluorescence images can also be obtained when it is desired to read out a fluorescent signal. Other types of detection and imaging strategies can be envisioned to work with this cell to cell communication chamber. Images can be compared with one an other using computer algorithms to quantitative the changes in morphology, physical position, or fluorescence. For example, autocorrelation algorithms can be used to provide a quantitative indication of the extent to which cells have changed shape or moved from the initial positions even if the movement or shape change is small. Similarly changes in fluorescence intensity, fluorescence resonance energy transfer, fluorescence lifetime, fluorescence polarization, or fluctuation correlation spectroscopy can also be used to detect changes in the cells due to stimulant addition or other assay protocols.

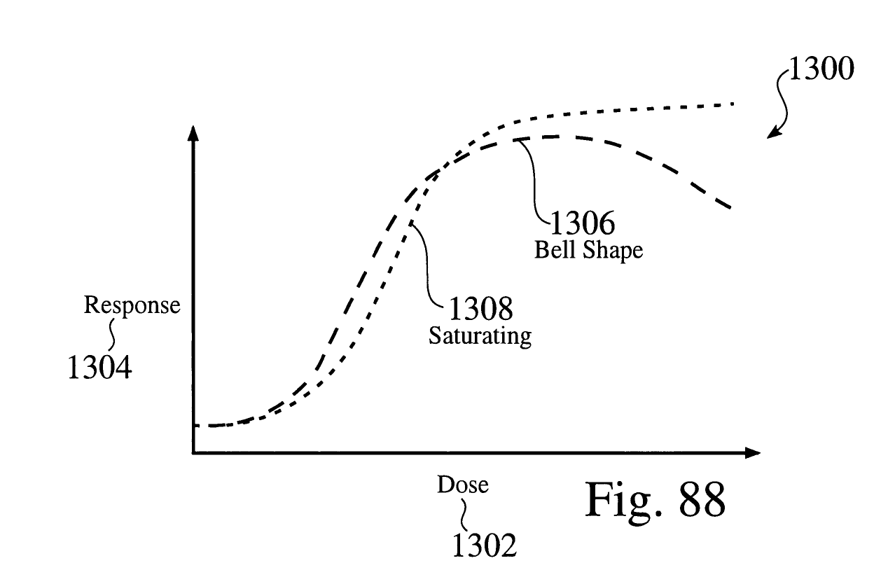

FIG. 88 provides an illustrative example 1300 of bell shaped 1306 and saturating 1308 dose-response curves. Dose-response curves provide a fundamental read out for many important biological functions such as response to a chemoattractant is in curve 1306 or a receptor-ligand binding curve as in curve 1308. Using the methods taught by aspects of the present teachings wherein standing concentration gradients are induced within microfluidic channels or chambers, it is possible to construct assays that provide dose-response information as a way of reading out assay information.

Dose-response assays within a microfluidic environment using standing concentration gradients inherently eliminates pipetting errors and well to well variations since errors in pipetting cause offsets which can be calibrated and removed by techniques like ratiometric correction. Dose-response information obtained from a localized population of cells, for example, has the potential to reduce or eliminate errors caused by curve fitting and averaging of multiple data points as has been done in the prior art. Additionally, obtaining assay responses in terms of smooth data curves allows the observation of subtle fluctuations and inflection points which potentially may reveal the mechanisms of action of the underlying biological systems. This information could be quite valuable in pharmacology for determining the mechanisms of action of both therapeutic drugs as well as toxic substances. In current practice, dose-response curves are used to validate assays and for pharmacology studies. Typically, 10-100 individual measurements are required so that each point on a dose-response curve consists of the average of multiple individual measurements. Many times, the inflection point of the dose response curve contains the most valuable information and the accuracy with which the inflection point can be determined is limited by the number of different concentration points assayed, by pipetting errors and other well to well errors associated with microplates and readers thereof.

The present teachings provide microfluidic perfusion chambers into which relatively small numbers of cells can be loaded and subjected to stable, continuous concentration gradients. Specific structures can be constructed to break up large concentration ranges required for certain dose-response curves into several smaller ones designed to cover regions of specific such as inflection points and regions such as saturation or desensitization such as in the dose-response curves 1306 and 1308 shown in FIG. 88.

An additional benefit of dose-response or variable gradient assays according to aspects of the present teachings is the ability to accommodate primary cells from different individuals and expected the expected day to day variations in their responses. For example, bell shaped dose-response curve 1306 is typical of the response of a motile cell to a chemoattractant. To meaningfully assay these cells, it is often necessary to carry out the assay at the peak response point. In a gradient assay according to aspects of the present teachings, a continuum of data points are collected over a range will dramatically increases the probability the peak response will be captured. A continuous dose-response assay in a microfluidic environment can provide many benefits and much information that is difficult or impossible to collect using methods in the prior art and is not limited to the few illustrative examples used herein to illustrate the potential uses of this powerful technique.

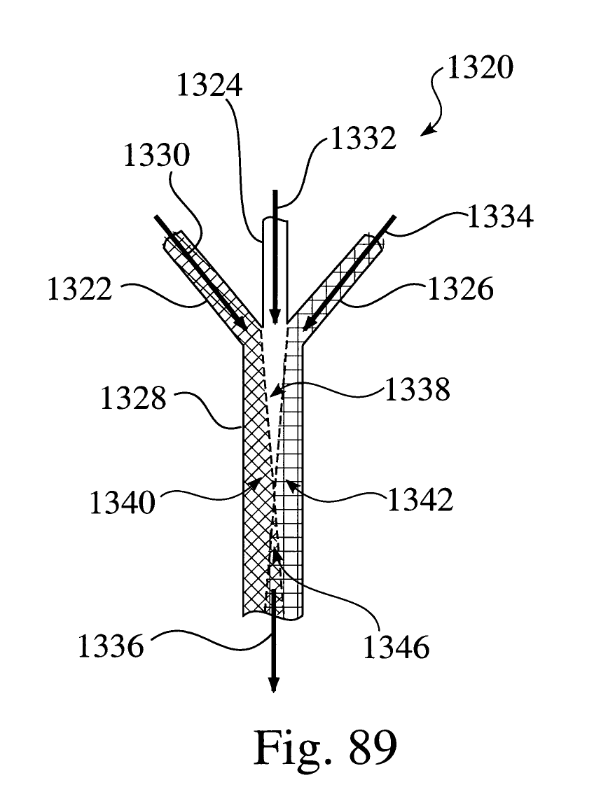

FIG. 89 shows a top view of 3-1 combiner structure 1320. A first reagent 1330 flowing in channel 1322 and a second reagent 1334 flowing in channel 1326 combine with a third fluid 1332 flowing in center channel 1324 after entering main channel 1328 and exit the main channel at 1336. Overlapping standing concentration gradients 1340 and 1342 form as first reagent 1330 and second reagent 1334 mix by diffusively crossing fluid stream 1338 which is present due to the injection of fluid 1332 from channel 1324 into main channel 1328.

Computer simulations of diffusion under representative operating conditions and geometries have been carried out and have been found to correlate well with results obtained with actual gradients observed using fluorescein as a fluorescent tracer in a fabricated device. Images of the gradients in channels were recorded with a CCD camera through a fluorescence microscope and were found to correlate well with the simulation results. In some embodiments, overlapping standing gradients can be used to study the effects of many different experimental conditions at once.

With a two dimensional array of sensing elements covering the floor of channel 1328, it is possible to measure the change in a property of a sensing element at various positions within the main channel 1328 of 3-1 combiner 1320 and thus simultaneously perform a number of experiments limited by the number of discrete sensing elements and the smallest resolvable change in reagent concentrations. In some embodiments with cells as the sensing element and the first and second reagents were two drugs known to stimulate the cells in a measurable way, the effects of the two drugs in various combinations could be studied.

In an alternative embodiment, a third reagent 1332 could be added through channel 1324 such that three overlapping concentration gradients would be present within channel 1328. Region 1346 represents a region where all three regents would be present. The number of channels in such a combiner structure could be increased or decreased and the design otherwise changed to suit the needs of a particular experiment of product. Using methods to trap and attach cells as taught by aspects of the present teachings combiner 1320 can be used to implement dose-response assays wherein each individual cell can be thought of as an individual sensing element. Alternatively, a lawn of cells, beads, sensor molecules, nano-particles, or other self assembling structures placed within channel 1328 in the presence of single or multiple overlapping gradients could perform a two dimensional or multi-parameter readout function enabling many physical, chemical, biophysical, or biological experiments to be carried out simultaneously.

There are other ways to make use of this method for performing gradient assays and experiments where the effects of two or more test substances are simultaneously evaluated.

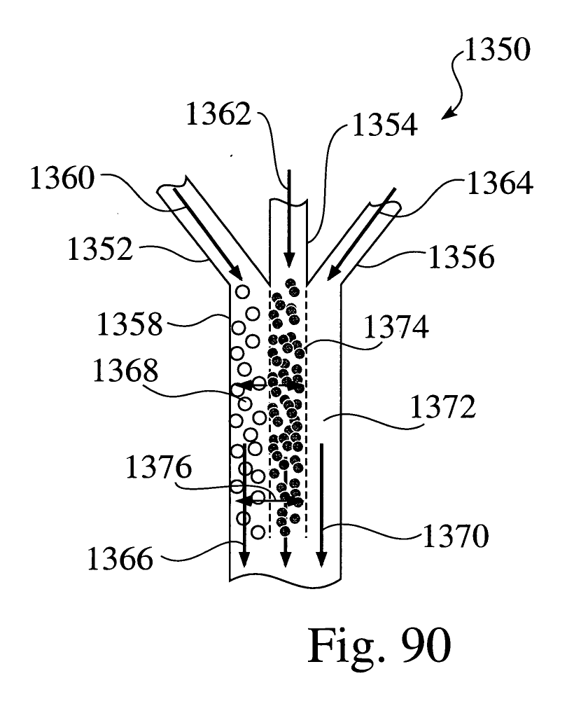

FIG. 90 illustrates an exemplary method wherein multiple cell types, bead types, or other sensor element types are loaded into the main channel 1358 of a 3-1 combiner structure 1350 so as to carry out various types of multi-parameter assays. The 3-1 combiner 1350 is operated in a manner similar to that of FIG. 89 and similar standing concentration gradients are established in main channel 1376 by the injection of various combinations of reagents 1360, 1362, and 1364 into channels 1152, 1354, and 1356, respectively. For the exemplary multi-cell assay shown, a first cell type 1374 is injected into the center region of the main channel 1358 from the center channel 1354. Flow is stopped and the cells are allowed to attach to the channel wall. A second cell type 1368 is injected into the left section of the main channel from left channel 1352. Flow is stopped and the cells are allowed to attach to the channel wall. After the first and second cell types have stabilized, a first reagent 1364 can be introduced from the right channel 1356 whereupon after entering main channel 1358 reagent 1364 diffuses into the center portion of the channel containing first cell type 1374. A standing gradient of the concentration of first reagent will be set up along the channel over the first and second cell types as the first reagent diffuses toward the edge of the channel as flow proceeds down the channel indicated by arrow 1376. Cells 1374 under stimulation by the first reagent may be induced to secrete a compound that could act as a second reagent either a stimulant or potentially a toxin to second cell type 1368 on the left side of the main channel 1358. Assays of this type could preferably be used to study the interactions of primary and cultured cell types for organ system and tissue interface models. The compounds secreted by first cell type in response to first reagent could be the target compound to be studied or it could be desired to study the effects of a drug in which the target compound would be the first reagent, for example a drug candidate.

In an alternative embodiment, cells, arrays of cells, or arrays of different types of cells (e.g., hepatocytes, fibroblasts, lymphocytes, neurons, engineered biosensor cells, etc.) housed within a microfluidic device having an integrated gas permeable membrane could function as living biosensors capable of detection of a broad range of substances dissolved in a liquid to which the cells are exposed. The response of cells in the device could be monitored or otherwise observed upon exposure to test substances including but not limited to environmental water samples, human, animal, reptile, plant, or fungi derived samples, drug candidates, cellular agonists stimulators or antagonists or suppressors, toxins, therapeutic agents, etc.

In an alternative embodiment, engineered, primary, or immortalized cells functioning as biosensors could be designed to detect the presence of toxic substances in the water samples prior to human consumption. On-site, rapidly responding cellular assays provide an attractive option compared conventional chemical analysis (at remotely located laboratories) carried out for each individual potential contaminant. This is due to the inherent ability of cellular assays (or arrays of cellular assays) to detect a wide range of potential toxic contaminants. FIG. 42 illustrates an exemplary embodiment of a cell maintenance cartridge (CMC) 700 capable of maintaining cells under optimal conditions during transport from a cell culture facility to a temporary storage facility, and during transport to the point of use for on-site monitoring of chemical and/or biological contamination in drinking water. Exemplary CMC 700 is includes a microscope sized chip 118i and a well frame assembly 710. An exemplary fluid channel embodiment for Chip 118i is the 2-port (one channel) unit cell 776a shown in FIG. 46 into which living cells can be loaded via access ports 764 as shown in FIG. 45.

A gas permeable membrane or other gas permeable sealing system which covers wells 728 can be substituted for tapered plugs 714 shown in FIG. 42. The gas permeable sealing system functions as a vent to allow gas to enter or exit from the well. A hydrophobic vent can be formed by choosing a hydrophobic material for the sealing system (e.g., by using silicone, Teflon, expanded Teflon, or other pours hydrophobic materials designed to perform this function such as Porex (www.porex.com). Alternatively, a hydrophobic vent can be formed by fabricating small holes in a hydrophobic membrane or other structure which are large enough to let gas escape but small enough to let fluid escape due to the surface energy interaction with the hydrophobic material.

Hydrophobic vents enable the wells to be filled with fluid without exposing the interior of the well to the outside environment. This is beneficial both in maintaining sterility and allowing a path for gas to exit the wells. Elimination of gas from the wells is important when it is desired to drive flow in the channel with an external fluid delivery system. Providing hydrophobic well vents can simplify the filling and emptying process and provide the ability for more accurate control of flow in the channels while maintaining sterility. Last, a hydrophobic venting membrane could also be used as a septum. Fluid could be injected into the well through the membrane as long as the membrane integrity is not lost by the injection. For example, silicone membranes, which are commonly used as septa may also be used as a hydrophobic vent due to the high gas permeability of silicone. An alternative embodiment with higher gas permeability and mechanical integrity than a silicone membrane alone would be a well sealing system constructed using the combination of a structurally rigid gas permeable material like Porex and a soft membrane like silicone to provide a septum for injection and removal of fluid from the wells while maintaining sterile conditions.

FIG. 6 shows an exemplary cross section illustrating the fluid path for cell loading via inlet access port 104a. After the cells are loaded and the flow is stopped, the cells attach to membrane surface 109a of channel 106a also shown in FIG. 6. Flow can be stopped by any of several methods including capillary forces which prevent flow into empty access port 112a at the opposite end of the channel 106a, balanced forces due to equal fluid levels in the reservoirs associated with the inlet and outlet ports or equal and canceling flows originating from externally applied driving forces including hydrostatic, electroosmotic, electrophoretic, etc. flow generating mechanisms. In an alternative embodiment, a layer of oil or other fluid with equivalent or superior mechanical properties can optionally be added to the cell loading well to cover the cell suspension and reduce evaporation during incubation. The oil layer would either be later removed or fresh media would be pipetted beneath the oil layer

After cell attachment, external flow controller 742 (shown in FIG. 43) maintains a relatively constant flow of cell culture medium through the channels of exemplary 2-port (i.e., one fluid channel) unit cell 776a providing a fresh supply of cellular nutrients while washing away cellular waste products.

In an alternate embodiment, flow can be driven by gravity, without the use of an external flow controller, if the microfluidic device is configured either with differing fluid levels in the inlet and outlet reservoirs or oriented with differing heights between the inlet and outlet reservoirs. The flow rate will be driven by the pressure generated by the net fluid column height acting against the flow resistance of the fluid channel network interconnecting the inlet and outlet reservoirs. For example, in the case of a vertically oriented single channel microfluidic device, the flow rate is primarily a function of the fluid channel depth and secondarily of the fluid channel width and independent of the channel length. This is because the linear increase in channel flow resistance associated with an increased channel length is effectively offset by the increased pressure difference due to the increased length, i.e., the height difference between the inlet and outlet access ports of a vertical channel. At angles other than vertical, this cancellation effect does not occur and the flow rate is dependent on the channel length. For example, increasing the channel length while fixing the channel width and depth and the height difference between the inlet and outlet access ports will result in reduced flow rates.

In an alternative embodiment, after cell loading and attachment the device is operated at the horizontal or shallow orientation angle during incubation or maintenance conditions and then the orientation is changed from horizontal to vertical to generate an increased flow rate, for example to introduce a new fluid (e.g., reagent(s), or sample(s)) as a part of an assay protocol or to generate an increased flow velocity suitable for a gradient assay such as those shown in FIG. 69 through FIG. 77.

In an alternate embodiment of gravity driven flow, a relatively constant and controlled flow rate can be generated by injection and/or or removal of a continuous series of very small fluid droplets (e.g., between about 0.1 picoliter and about 10 microliter per droplet) into or out of the inlet and output access ports, respectively. The fluid droplets can be injected using contact or non-contact means, the arrival or departure of each droplet causing a small difference in pressure between the inlet and the outlet access ports. A series of relatively small volume droplets, compared to the flow rate injected or removed at a relatively rapid rate results in a relatively constant flow. In some embodiments, the fluid levels in the inlet and outlet reservoirs are initially equal and the flow rate in the interconnecting channel network is consequently zero. The rapid and serial injection or removal of droplets of small size, compared to the flow rate results in an average flow rate equal to the number of droplets injected or removed per second times the volume of the droplets injected or removed. This assumes that the flow resistance of the interconnecting channel network is low enough to allow the levels in the inlet and outlet wells to equilibrate under the action of gravity in between droplet injection or removal and that the effects of surface tension can be neglected. There are many possible ways to inject or remove small droplets using contact technologies such as pipettes, pin tools, and syringe pumps as well as non-contact technologies such as inkjet and ultrasonic dispensing systems. Ultrasonic dispensing systems are capable of injecting or ejecting droplets from a fluid reservoir without making physical contact to the liquid in the wells.

Alternate unit cell embodiments comprising more than one or more inlet and/or one or more outlet port are optional and configurable for CMCs with specific applications. Multiple unit cells can be fabricated on each chip substrate to provide multiple assay sites, or alternatively an array of assay sites. Singlicates or replicate populations of a single cell type or multiple cell types can be loaded into each unit cell. Each inlet and outlet port may be in fluidic communication with independent wells 728 as shown in FIG. 42 providing flexibility on a well by well basis to use different cell culture media formulations, different samples, and isolated waste wells. The chip substrate could be any size or shape, however, microscope slide format and microplate format substrates could be used when it is desired to conform to industry standard formats. The pas permeable membrane provides gas exchange between the cells in the channels and the outside environment thereby enabling optimal respiration.

The cell maintenance cartridge (CMC) described above and/or the exemplary microscope slide format devices shown in FIGS. 45-48 or the exemplary microplate format standard devices shown in FIGS. 33-37 illustrate standardized platforms utilizing microfluidic devices with an integrated gas permeable membrane to enable the development and of cellular assays with broad based detection capabilities. These standardized platforms can be deployed into many potential applications areas. For example, engineered cell lines and new assays for existing cell lines can be developed and optimized for standardized platforms by biologists, biochemists, molecular biologists and others with specialized skills in assay development or cell biology. Standardized platforms provide a low cost and standardized method to enable cellular assays in microfluidic deices integrated gas permeable membranes to be used by non-biologists in specific applications such as water toxicity monitoring assays, high throughput screening assays, drug toxicity and side-effect monitoring assays, drug analog development, drug potency optimization, drug specificity optimization, determining the optimum dose of a therapeutic drug using cells taken from a patient, determining the optimum dose of a chemo-therapeutic or anti organ rejection drug using cells taken from a patient, determining drug interactions using cells taken from a patient by exposing cells to a standing and continuously varying concentration gradient of at least one compound over a range of concentrations, determining side effects of drugs using cells taken from a patient by exposing cells of specific cell types to a standing and continuously varying concentration gradients of at least one compound over a range of concentrations, subjecting cells to a continuously varying concentrations of a compound over a concentration range and subsequently analyzing said cells to determine levels of gene expression (e.g, DNA, mRNA, or protein levels), determining antibiotic sensitivity of bacteria growing within the CMC by exposing the bacteria to a standing and continuously varying concentration gradient of at least one compound over a range of concentrations, diagnosing disease by performing assays on cells taken from a patient.

In other embodiments, one or more electrical connections can be provided on the exterior of a microfluidic device having an integrated gas permeable membrane to enable electrical connection to the interior of the device (e.g., inlet/outlet fluid reservoirs, inlet/outlet access ports, inlet/outlet wells, or the channels or assay chambers). Electrical connections can be established between the exterior and the interior of the device either by microfabrication of integrated electrical structures such as conductive lines pads, etc. on or within the microfluidic device using any suitable methodologies or by providing means for inserting and sealably attaching pre-fabricated electrodes so as to be in contact with fluids at a specifically desired location within the device. One or more electrical connections can enable many electrical measurements and functions, and hence different kinds of assays and other functions, to be performed at one or more locations within the device. Exemplary electrical measurements include but are not limited to AC and DC potential and potential pulses, AC and DC current and current pulses, AC and DC impedance, AC and DC admittance or conductance, charge, charge pulses, AC or DC capacitance, integrated and differentiated current, voltage, and charge waveforms, frequency sweep measurements of any of the afore mentioned measurements, two or four point implementations of any of the afore mentioned measurements, and combinations of any of the afore mentioned measurements. In addition, electrical connections can enable certain functions including but not limited to heading, cooling, electrolysis, electrophoresis, electroosmosis, electrically programmable fusing, or optically or electrically readable bar codes, and electrically activated valves, check valves, and pumps. Electrical connections can also enable integrated sensors within the device including but not limited to temperature, redox potential, oxygen, carbon dioxide, pH, pressure, flow, osmolarity, acceleration, inclination, and position.

An exemplary sensor embodiment is an electrical method for on-chip detection of cell swelling/shrinking caused by osmolarity differences between the fluid in the channel and the interior of cells within the channels. In a channel with a fixed cross section, and microfluidic scale dimensions, changes in cell morphology will affect the path of an electrical signal passing through the extra-cellular fluid in the channel with the result that the electrical impedance or conductivity of the channel will decrease or increase as cells swell or shrink, respectively. Impedance is known to correlate to changes in cell shape due to corresponding changes in the flow of charge around the cells.

In an alternate embodiment, assuming that the cell morphology remains constant, the electrical impedance or conductivity of the extra-cellular fluid in the channel will be affected by substances absorbed or excreted by the cells in the channel. For example, cells routinely absorb or excrete ionic species such as sodium, calcium, potassium, glucose, etc. Cells may also absorb or excrete non-ionic species such as proteins, peptides, or gases including but not limited to O₂, CO₂ and NO. Many, if not all of these species can effect the electrical characteristics of the extra-cellular media and be detected using electrical signals from the exterior of the chip or in conjunction with electrochemical sensors with high specificity for a target species. The cells within the chip can be used as biosensors to detect a change in an external parameter, such as a the presence of a compound in the cell culture medium or they may also provide a means for observing internal cellular processes such as metabolism, DNA synthesis, protein expression, cell division, differentiation, apoptosis, cytoskeletal activity, or chemotaxis.

In an alternate embodiment, cell lines may be engineered to absorb or excrete specific substances designed to produce detectable changes in the osmolarity, or the afore mentioned electrical properties or characteristics of the extra-cellular fluid after the cells are exposed to specific trigger substances present in the extra-cellular media. In addition, the cells can be designed to detect the activation or deactivation of specific biochemical signaling pathways by causing detectable changes in osmolarity or conductivity as mentioned above.

In an alternate embodiment, the electrical potential between two regions along a channel is measured. Electrically active cells, such as neurons, are present in the channel between the electrodes. Electrical voltage or current signals measured at the electrodes will be indicative of the electrical activity of the neurons.

In an alternate embodiment, the extra cellular fluid is isolated in a microfluidic region in which cells are not present so that the fluid can be examined while not in the presence of the cells. For example, after passing through a region where cells are present, the fluid can be directed to a microfluidic channel or chamber located where cells are not present but measurement electrodes are located so as to perform measurements of electrical properties of the isolated fluid or to sense specific species within the isolated fluid volumes. Using this embodiment, it is possible to measure the presence or absence of secreted or absorbed substances relative to a control, respectively. It is also possible to measure changes in impedance or conductivity of the fluid caused by the secreted or absorbed compounds and it is possible (e.g., using an osmometer) to measure the osmolarity of the fluid by the measuring the change in the freezing point, boiling point, pressure developed across a membrane, and vapor pressure.

### XI. EXAMPLES

These examples describe selected embodiments of the present teachings, presented as a series of indexed paragraphs.

1. A microfluidic device comprising (A) a fabricated substrate having at least one inlet access port disposed in said substrate; (B) at least one channel disposed in said substrate and connected to said inlet access port; and (C) a gas permeable membrane sealably attached to said substrate to cover said channel.

2. The device of paragraph 1, wherein said substrate comprises a material selected from the group consisting of glass, quartz, plastic, polymer, polyethylene, polypropylene, silicone, silicon, polymethylpentene, polystyrene, Teflon, and combinations thereof.

3. The device of paragraph 1 or 2, wherein the dimensions of said channel in width or depth are between about 1 micron and 1,000 microns.

4. The device of any of the preceding paragraphs, wherein said membrane has sufficient gas permeability to support living cells within said channel.

5. The device of any of the preceding paragraphs, wherein the gas permeability of said membrane to the group of gases consisting of nitrogen, oxygen, carbon dioxide, and combinations thereof is within the range of about 0.1 to about 10 Barrer units.

6. The device of any of the preceding paragraphs, further comprising one or more of the following (A) at least one outlet access port disposed in said substrate and connected to said channel, said channel optionally being less than about 1,000 microns in width or depth; (C) one or more fluid chambers disposed in said substrate and connected to said channel; (D) a delivery mechanism for bringing one or more gases into diffusive communication with the surface of said gas permeable membrane; and (E) a controller for controlling the flow rate or velocity of a fluid in the channel.

7. The device of any of the preceding paragraphs, wherein said substrate has a microscope slide or a microplate format.

8. The device of any of the preceding paragraphs, further comprising a coating or chemical treatment on at least one surface of said channel and/or said membrane.

9. The device of any of the preceding paragraphs, further comprising one or more cells.

10. The device of paragraph 9, where said cells are selected from the group consisting of primary and cultured eukaryotic and prokaryotic cells or combinations thereof.

11. The device of any of the preceding paragraphs, further comprising one or more reagents wherein at least one of said reagents is present in a concentration gradient.

12. The device of any of the preceding paragraphs, wherein a portion of the membrane can be deflected into or away from said channel or said substrate.

13. The device of paragraph 12, wherein said membrane can be deflected by application of a mechanical force, pneumatic pressure, or hydraulic pressure.

14. The device of any of the preceding paragraphs, wherein said substrate comprises an organic material.

15. The device of paragraph 14, wherein said organic material comprises a polymer.

16. The device of paragraph 15, wherein said polymer comprises a material selected from the group consisting of polyolefins, polystrenes, amorphous fluorinated polymers, elastomers, polyethylene, polypropylene, silicone, polymethylpentene, polystyrene, Teflon, and combinations thereof.

17. The device of any of the preceding paragraphs, wherein said substrate comprises an inorganic material.

18. The device of paragraph 17, wherein said inorganic material is amorphous.

19. The device of paragraph 18, wherein said amorphous material is selected from the group consisting of glass, quartz, and combinations thereof.

20. The device of paragraph 19, wherein said inorganic material is crystalline.

21. The device of paragraph 20, wherein said crystalline material is silicon.

22. The device of any of the preceding paragraphs, further comprising one or more beads or particles.

23. The device of any of the preceding paragraphs, wherein said membrane comprises an organic material.

24. The device of paragraph 23, wherein said organic material comprises a polymer.

25. The device of paragraph 24, wherein said polymer is selected from the group consisting of polyolefins, polystrenes, amorphous fluorinated polymers, elastomers, polyethylene, polypropylene, silicone rubber, polydimethylsiloxane, polymethylpentene, polystyrene, Teflon, CYTOP, and combinations thereof 26. An array comprising one or more positionally distinguishable devices of any of paragraphs 1-25, each of the devices being independently the same as, or different than, any of the other devices.

27. The array of paragraph 26, comprising a plurality of devices of any of paragraphs 1-25 and further comprising a network of channels interconnecting said devices.

28. A method of performing an assay to evaluate a property of a compound comprising the steps of (A) providing a device of any of paragraphs 1-25 and/or an array of paragraphs 26 or 27; (B) introducing said compound into said device and/or array; and (C) evaluating said property of said compound.

29. The method of paragraph 28, wherein said property is said compound's effect on at least one measurement selected from the group consisting of absorbance, transmission, reflectance, refractive index, luminescence, fluorescence intensity, fluorescence lifetime, fluorescence polarization, fluorescence anisotropy, turbidity, color, grayscale, phase contrast, differential phase contrast, function, absolute or relative position, velocity, acceleration, morphology, electrical resistance, charge, conductance, capacitance, inductance, impedance, admittance, electric potential, chemical potential, redox potential, oxygen, carbon dioxide, nitrous oxide, pH, electrical field, magnetic field, and combinations thereof 30. The method of paragraph 28 or 29, wherein said assay is selected from the group consisting of apoptosis, toxicity, metabolism, viability, vitality, function, motility, migration, proliferation, chemotaxis, cell-to-cell communication, cell signaling, ion channel flux, receptor activation or inhibition, gene expression, protein expression, receptor binding, transcriptional and translational binding, enzyme activity, protein-protein interaction, nucleic acid interaction, and combinations thereof.

31. The method of any of paragraphs 28-30, wherein said property is said compound's effect on at least one image collected by an optical imaging device.

32. The method of paragraph 31, wherein said optical imaging device is a microscope.

33. The method of any of paragraphs 28-32, wherein either before or after said compound is introduced into said device or array, said method further comprises providing introducing one or more reagents into said device or array such that said reagents are disposed in concentration gradients in said device or array.

34. A method for preparing a microfluidic device having an integrated gas permeable membrane comprising the steps of providing a substrate having at least one channel and at least one inlet access port wherein said inlet access port is connected to said channel; and attaching a gas permeable membrane to said substrate to cover said channel.

35. The method for preparing the device of paragraph 34, further comprising (A) providing a package having at least one fluid well corresponding to said at least one inlet access port; and (B) sealably mounting said substrate in said package to form a microfluidic device.

There are many possible uses for the microfluidic structures and devices described herein and many configurations of channels, chambers, valves, and the like are possible to implement various kinds of important functions and chemical, biochemical, and biological assays and protocols for carrying out these assays according to the methods as taught by the present teachings. Many types of chemical, biochemical, and cellular assays including but not limited to cell migration, cell motility, cell-cell communication, cellular viability, cellular toxicity, cellular proliferation, gene and protein expression, receptor, enzyme, nucleic acid and protein binding, receptor, as well as enzyme, nucleic acid, and protein functional, assays can take advantage of the methods taught according to the present teachings. Additionally, the structures and methods taught by the present teachings can be used in the development of organ system and tissue interface models including but not limited to gut, liver, epithelia, endothelia, kidney, and brain. As mentioned previously, the methods and structures taught according to aspects of the present teachings can be applied to many fields including basic biological science, life science research, drug discovery and development, chemical and biological warfare agent detection, environmental monitoring, medical diagnostics, and personalized medicine.

1. A microfluidic device comprising:
a fabricated substrate having at least one inlet access port disposed in said substrate;
at least one channel disposed in said substrate and connected to said inlet access port; and
a gas permeable membrane sealably attached to said substrate to cover said channel.

2. The device of claim 1 wherein said substrate comprises a material selected from the group consisting of glass, quartz, plastic, polymer, polyethylene, polypropylene, silicone, silicon, polymethylpentene, polystyrene, Teflon, and combinations thereof.

3. The device of claim 1 wherein the dimensions of said channel in width or depth are between about 1 micron and 1,000 microns.

4. The device of claim 1 wherein said membrane has sufficient gas permeability to support living cells within said channel.

5. The device of claim 1 wherein the gas permeability of said membrane to the group of gases consisting of nitrogen, oxygen, carbon dioxide, and combinations thereof is within the range of about 0.1 to about 10 Barrer units.

6. The device of claim 1 further comprising one or more of the following:
at least one outlet access port disposed in said substrate and connected to said channel;
one or more fluid chambers disposed in said substrate and connected to said channel;
a delivery mechanism for bringing one or more gases into diffusive communication with the surface of said gas permeable membrane; and
a controller for controlling the flow rate or velocity of a fluid in the channel.

7. The device of claim 1 wherein said substrate has a microscope slide or a microplate format.

8. The device of claim 1, further comprising a coating or chemical treatment on at least one surface of said channel and/or said membrane.

9. The device of claim 1 further comprising one or more cells.

10. The device of claim 1 further comprising one or more reagents wherein at least one of said reagents is present in a concentration gradient.

11. The device of claim 1 wherein a portion of the membrane can be deflected into or away from said channel or said substrate.

12. The device of claim 11, wherein said membrane can be deflected by application of a mechanical force, pneumatic pressure, or hydraulic pressure

13. An array comprising one or more positionally distinguishable devices of claim 1.

14. The array of claim 13 comprising a plurality of devices of claim 1 and further comprising a network of channels interconnecting said devices.

15. A method of performing an assay to evaluate a property of a compound comprising the steps of:
providing a device of claim 1;
introducing said compound into said device; and
evaluating said property of said compound.

16. The method of claim 15, wherein said property is said compound's effect on at least one measurement selected from the group consisting of absorbance, transmission, reflectance, refractive index, luminescence, fluorescence intensity, fluorescence lifetime, fluorescence polarization, fluorescence anisotropy, turbidity, color, grayscale, phase contrast, differential phase contrast, function, absolute or relative position, velocity, acceleration, morphology, electrical resistance, charge, conductance, capacitance, inductance, impedance, admittance, electric potential, chemical potential, redox potential, oxygen, carbon dioxide, nitrous oxide, pH, electrical field, magnetic field, and combinations thereof.

17. The method of claim 15 wherein said assay is selected from the group consisting of apoptosis, toxicity, metabolism, viability, vitality, function, motility, migration, proliferation, chemotaxis, cell-to-cell communication, cell signaling, ion channel flux, receptor activation or inhibition, gene expression, protein expression, receptor binding, transcriptional and translational binding, enzyme activity, protein-protein interaction, nucleic acid interaction, or combinations thereof.

18. The method of claim 15, wherein said property is said compound's effect on at least one image collected by an optical imaging device.

19. The method of claim 15 wherein either before or after said compound is introduced into said device, said method further comprises providing introducing one or more reagents into said device such that said reagents are disposed in concentration gradients in said device.

20. A method for preparing a microfluidic device having an integrated gas permeable membrane comprising the steps of:
providing a substrate having at least one channel and at least one inlet access port wherein said inlet access port is connected to said channel; and
attaching a gas permeable membrane to said substrate to cover said channel.

21. The method for preparing the device of claim 20 further comprising:
providing a package having at least one fluid well corresponding to said at least one inlet access port; and
sealably mounting said substrate in said package to form a microfluidic device.
